(19) United States
(12) Patent Application Publication
(10) Pub. No.: US 2026/0259562 A1
(43) Pub. Date: Sep. 3, 2026

(54) INTERFACE FOR CONTROL OF AUTONOMOUS VEHICLES

(71) Applicant: SARONIC TECHNOLOGIES, Austin, TX (US)

(72) Inventors: Vibhav Altekar, Austin, TX (US); Rehan Mallick, Austin, TX (US); Andrew Pennington, Austin, TX (US); Paul Franklin Barnhardt Leimer, Austin, TX (US); James Gianakopoulos, Austin, TX (US); Isaac Daniel Steadman, Hutto, TX (US)

(21) Appl. No.: 19/552,768

(22) Filed: Feb. 27, 2026

Related U.S. Application Data
(60) Provisional application No. 63/765,270, filed on Feb. 28, 2025.

(51) Int. Cl. G05D 1/226; B63B 79/15; B63B 79/40; G05D 1/224; G05D 1/229; G05D 1/243; G05D 109/30; G08G 3/00; H04L 65/1089

(52) U.S. Cl. CPC G05D 1/226; B63B 79/15; B63B 79/40; G05D 1/2245; G05D 1/2247; G05D 1/229; G05D 1/2435; G08G 3/00; H04L 65/1089; B63B 2201/16; G05D 2109/34

(57) ABSTRACT

A system including a cloud-based server and an autonomous vehicle in communication with the cloud-based server further includes a computer, remote from the cloud-based server and from the autonomous vehicle. The computer receives from the server real-time telemetry and tracking data of the autonomous vehicle. The computer receives the real-time telemetry data and the real-time tracking data and cause a display device of the computer to display, in a first portion of the display, an interactive, three-dimensional depiction of the environment in which the autonomous vehicle is disposed. The computer display also displays, in the first portion of the display, an interactive, representative graphical depiction of the autonomous vehicle and of objects detected by the vehicle in the real-world space. User inputs received at the computer are transmitted to the vehicle to cause the vehicle to navigate autonomously to a selected waypoint or destination.

### FIELD OF THE DISCLOSURE

The present disclosure generally relates to autonomous maritime surface vehicles (AMSVs) and associated systems, components, methods, and techniques related to autonomous maritime surface vehicles.

### BACKGROUND OF THE DISCLOSURE

Maritime vehicles, or vehicles designed for use on or in the water, are commonly used for transportation, recreation, defense, scientific research, and other purposes. Examples of maritime vehicles include boats, watercraft, submarines, and amphibious vehicles. As such, a maritime vehicle can be a surface vehicle which operates while generally floating on or in bodies of water, e.g., so that during its operations a majority of the surface vehicle is generally disposed above the waterline, and a maritime vehicle can be a partially or entirely submersible vehicle which operates while a majority or all of the vehicle is disposed beneath the waterline. Maritime vehicles can be manned (i.e., operated by an onboard human) or unmanned, and unmanned maritime vehicles can be remotely controlled and/or commanded to perform autonomously.

Control of autonomous vehicles, including autonomous marine vehicles, can be difficult, especially in environments that demand real-time decision making to implement strategies for interacting with and countering adversarial vehicles. For instance, a person in command of an autonomous vehicle must be able to see the environment in which the autonomous vehicle is operating in as close to real-time as possible, in order to provide missions and strategies for the autonomous vehicle to execute. When there are a multiplicity of autonomous vehicles operating in the environment, it can be particularly onerous to coordinate and command the multiplicity of autonomous vehicles either because it introduces the need for a corresponding multiplicity of people, who must all act with knowledge of what each other is doing, or merely because it requires serial interaction with the multiplicity of autonomous vehicles, making it more difficult to keep the vehicles coordinated.

### SUMMARY

A system includes a cloud-based server and an autonomous vehicle in communication with the cloud-based server. The autonomous vehicle includes a locomotion system, a passive perception system comprising a stereo camera system and a software routine operative at least to detect and classify objects in an environment of the autonomous vehicle and, for each object, continuously determine real-time tracking data comprising a position, a speed, and a heading, and a plurality of radio frequency interfaces. The radio frequency interfaces are configured to transmit to the cloud-based server, via one or more of the plurality of radio frequency interfaces, real-time telemetry data of the autonomous vehicle and the real-time tracking data, and receive from the cloud-based server, via one or more of the plurality of radio frequency interfaces, a destination to which the autonomous vehicle is to navigate and/or a series of waypoints through which the autonomous vehicle is to navigate. The autonomous vehicle also includes a control module configured to control the locomotion system to navigate to the destination and/or through the waypoints. The system further includes a computer, remote from the cloud-based server and from the autonomous vehicle. The computer receives from the server the real-time telemetry data and the real-time tracking data, and executing a graphical user interface (GUI). The GUI receives the real-time telemetry data and the real-time tracking data and causes a display device of the computer to display, in a first portion of the display, an interactive, three-dimensional depiction of the environment in which the autonomous vehicle is disposed. The GUI also causes the display device to display, in the first portion of the display, an interactive, representative graphical depiction of the autonomous vehicle in the real-world space, and to display, in the first portion of the display, an interactive, representative graphical depiction of each of the objects detected in the real-world space. The GUI continuously update the first portion of the display according to the real-time telemetry data and the real-time tracking data. The GUI is further configured to receive a first user input via the first portion of the display, the first user input comprising selecting the autonomous vehicle, to receive a second user input via the first portion of the display, the second user input comprising selecting a waypoint or destination for the selected autonomous vehicle; and to transmit, to the selected autonomous vehicle, via the cloud-based server, a command to cause the selected autonomous vehicle to navigate autonomously to the selected waypoint or destination.

A tangible, non-transitory storage medium storing machine-readable instructions that, when executed by a processor, cause the processor to receive real-time telemetry data from one or more remote autonomous vehicles and real-time data indicative of one or more objects detected by the one or more remote autonomous vehicles. The instructions also cause the processor to receive, for each of the one or more objects, real-time tracking data including an estimated position, speed, and direction of the object. The instructions further cause a display device coupled to the processor to display, in a first portion of the display, an interactive, three-dimensional depiction of a real-world space, an interactive, representative graphical depiction of each of the one or more remote autonomous vehicles in the real-world space, and an interactive, representative graphical depiction of each of the one or more objects detected in the real-world space by the one or more remote autonomous vehicles. The instructions cause the processor to continuously update the first portion of the display according to the real-time telemetry data and the real-time data indicative of the one or more objects. Still further, the instructions cause the processor to receive a first user input via the first portion of the display, the first user input comprising selecting at least one of the one or more remote autonomous vehicles, receive a second user input via the first portion of the display, the second user input comprising selecting a waypoint or destination for the at least one selected remote autonomous vehicles, and transmit to the at least one selected remote autonomous vehicles a command to cause the at least one selected remote autonomous vehicles to navigate autonomously to the selected waypoint or destination.

### BRIEF DESCRIPTION OF THE DRAWINGS

The features of this invention which are believed to be novel are set forth with particularity in the appended claims. The invention may be best understood by reference to the following description taken in conjunction with the accompanying drawings, in which like reference numerals identify like elements in the several FIGS., in which:

FIG. 1A illustrates a first example scenario in which embodiments of the autonomous maritime surface vehicles (AMSVs), systems, components, methods and/or techniques disclosed herein may be utilized;

FIG. 1B illustrates a second example scenario in which embodiments of the autonomous maritime surface vehicles (AMSVs), systems, components, methods and/or techniques disclosed herein may be utilized;

FIG. 1C illustrates a third example scenario in which embodiments of the autonomous maritime surface vehicles (AMSVs), systems, components, methods and/or techniques disclosed herein may be utilized;

FIG. 2A is a top perspective view of an example of an autonomous maritime surface vehicle (AMSV) in accordance with the teachings of the present disclosure;

FIG. 2B is a front view of the AMSV of FIG. 2A;

FIG. 2C is a rear view of the AMSV of FIG. 2A;

FIG. 2D is a bottom perspective view of the AMSV of FIG. 2A;

FIG. 2E is another bottom perspective view of the AMSV of FIG. 2A;

FIG. 2F is similar to FIG. 2A, but with the cap and various components of the AMSV removed for illustrative purposes;

FIG. 2G is similar to FIG. 2F, but with additional components of the AMSV removed for illustrative purposes;

FIG. 2H is a rear view of the AMSV of FIG. 2F;

FIG. 2I is a first cross-sectional view taken along line I-I in FIG. 2A;

FIG. 2J is a second cross-sectional view taken along line J-J in FIG. 2A;

FIG. 2K is similar to FIG. 2A, but with the latching assembly of the AMSV removed for illustrative purposes;

FIG. 2L is a block diagram of an example autonomous maritime surface vehicle (AMSV) in accordance with the teachings of the present disclosure;

FIG. 3A depicts an example scenario of a group or swarm of AMSVs operating cooperatively to perform a mission;

FIG. 3B depicts an example environment in which a group or swarm of AMSVs may operate to perform a mission;

FIG. 3C is a block diagram depicting a Mobile Control System;

FIG. 4 depicts a block diagram of an example communication architecture 400 supporting communications between components of mission systems in which AMSVs are included;

FIGS. 5A-5D depict various example perception hardware configurations and corresponding fields of view (FOVs), in accordance with various embodiments described herein;

FIGS. 6A-6K depict various example perception software analyses using the hardware configurations of FIGS. 5A-5D, in accordance with various embodiments described herein;

FIGS. 7A-7E depict various flow diagrams representing example computer-implemented methods, in accordance with various embodiments described herein;

FIG. 8A depicts an example graphical user interface (GUI) for controlling autonomous vehicles and implementing a two-dimensional view of a space;

FIG. 8B depicts an example target object interception user interface that includes path plans for multiple autonomous vehicles;

FIGS. 8C and 8D depict examples of a portion of GUI control interface for controlling autonomous vehicles and implementing a three-dimensional view of a space;

FIGS. 8E and 8F depict examples of the GUI control interface implementing the three-dimensional view, illustrating various features of the interface;

FIG. 8G depicts a manner in which camera feeds from an autonomous vehicle may be superimposed on a corresponding field of view indicator in the three-dimensional GUI control interface;

FIGS. 8H-8I depict additional features of the example GUI control interface;

FIGS. 8J-8K depict an automatic routing feature implemented within the example GUI;

FIGS. 8L-8M depict follow and intercept features of the example GUI; and

FIGS. 8N-8Q depict various data flows between elements of a system implementing the example GUI.

FIG. 9A depicts a flow diagram of an example computer-implemented method performed by an AMSV;

FIG. 9B depicts a flow diagram of an example computer-implemented method performed by a group or swarm of AMSVs;

FIG. 9C depicts a flow diagram of an example computer-implemented method for providing coordinated control of a group or swarm of AMSVs; and

FIG. 9D depicts a flow diagram of an example computer-implemented method for optimizing field-of-view (FoV) coverage of a group or swarm of AMSVs.

### DETAILED DESCRIPTION

The present disclosure is directed to systems, components, and methods of autonomous maritime surface vehicles (AMSVs) that are primarily intended for use for military purposes (e.g., for naval defense, patrolling waters and enforcing laws, reconnaissance, naval exploration, monitoring, etc.) but that can also be used for other purposes if desired. An autonomous maritime surface vehicle is small (er), durable, and configured to quickly, efficiently, and stealthily traverse a body of water once dispatched (e.g., from other maritime vehicles, beachheads, or an airdrop). During operations, the autonomous maritime surface vehicle generally floats on the body of water; that is, typically an AMSV does not operate when fully submersed within the body of water. The autonomous maritime surface vehicle may typically be unmanned and can operate autonomously without requiring the use of any real-time human instructions. The autonomous maritime surface vehicle is modular, with components that can be flexibly altered, removed, or added as desired in accordance with the mission of the AMSV. As will be discussed elsewhere herein, the autonomous maritime surface vehicle can operate singly or in collaboration with other similar maritime vehicles and/or military assets when necessary, and the autonomous maritime surface vehicle (and indeed, groups of AMSVs) may preferably be unmanned operate autonomously during the missions.

While being transported to its dispatch or deployment site, the AMSV may be in a standby mode, and the AMSV may not change to operating in an active or operational mode until after it has entered into the water.

The AMSV may be transported to its deployment site by using any of various suitable techniques. For example, people can physically carry or drive the AMSV to the water's edge and dispatch the AMSV from land into the water. In another example, a larger maritime vessel may transport the AMSV or group of AMSVs to a location in the body of water and deploy the AMSV(s) from the vessel into the water. In yet another example, an airplane carrying the AMSV may drop the AMSV into the water. Of course, other transportation methods to transport the AMSV for dispatch and/or deployment into a body of water may be possible.

While in the standby mode, the AMSV may primarily (and in some instances, solely) operate to detect whether or not it has been dispatched into the water, and the AMSV may only otherwise perform only a limited set of other functionalities (if any other functionalities at all) to conserve battery life. For example, the AMSV may not activate or turn on various on-board systems while in the standby mode. However, while in stand-by mode, the AMSV can utilize one or more sensors to detect movements and other external conditions to which the AMSV is being subjected. For example, the sensor(s) may detect free fall movements as the AMSV is being dropped through the air, the presence (or absence) of jostling or wave movements of the body of water, the presence of water at various locations near the bottom of the AMSV, etc. that may inform the AMSV that the AMSV has been dispatched into the water. Upon the sensor(s) detecting that the AMSV is in/on the water, the AMSV can autonomously switch to operating in the active mode.

When operating in the active mode, the AMSV can perform a mission with which it (either singly or in cooperation with other AMSVs) has been charged to perform, such as a military task, a military operation, a military campaign, etc. For example, the mission may include the AMSV performing reconnaissance along a stretch of coastline or within a certain area of the ocean, the mission may include patrolling enemy lines or presences, and/or the mission may include the AMSV travelling to within striking distance of a target (e.g., an enemy vessel or asset) and discharging its payload (e.g., bomb, explosive device, etc.) to engage or hit the target. Missions may involve only the AMSV or may involve a group of AMSVs (e.g., a “swarm” of AMSVs) which cooperatively operate to perform the mission. For example, a swarm of AMSVs may be charged with a mission to find a particular target, surround the target, and engage the target with respective payloads in a pre-defined order over an interval of time. Further, during any mission, the AMSV (whether operating singly or cooperatively with other AMSVs) may autonomously operate to respond to unexpected conditions, such as the loss of another AMSV, a failure of the AMSV to deploy payload, a fault or degradation in performance of one of the AMSVs components, etc.

While the systems, components, and methods of autonomous maritime surface vehicles (AMSVs) will be described in detail below, the following examples illustrate several scenarios implementing in an AMSV, a group of AMSVs, and respective ecosystems the concepts described in this specification and highlight the advantages of such implementations. The examples should not be considered limiting in the functionality available, the personnel performing various tasks, the physical separation or location of various elements, or in any other manner. Instead, these examples are intended to introduce various system elements and aspects of the operation of the system, each of which will be described in greater detail elsewhere in this description.

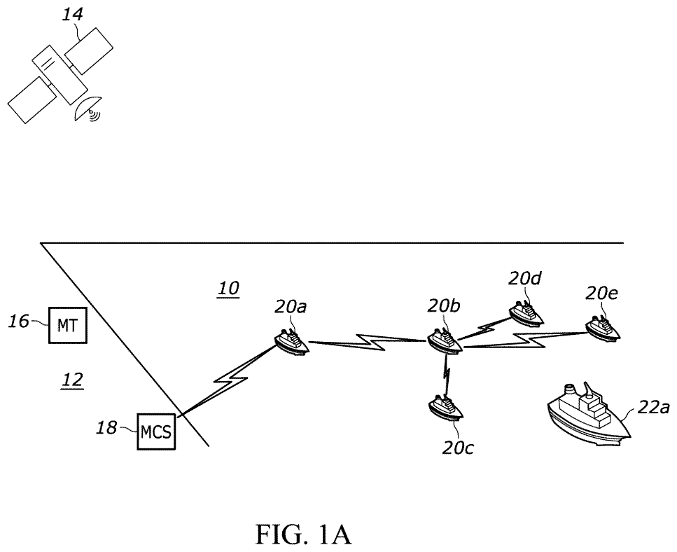

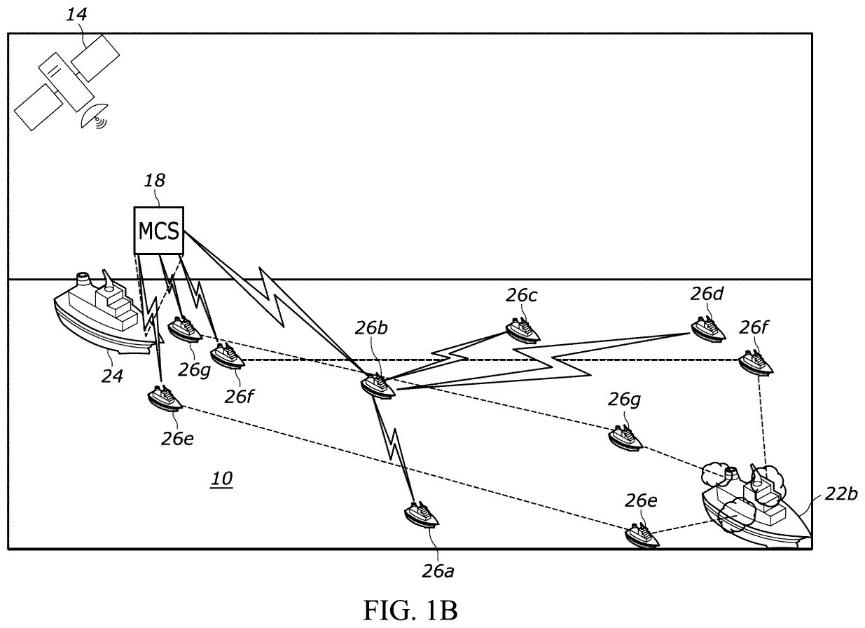

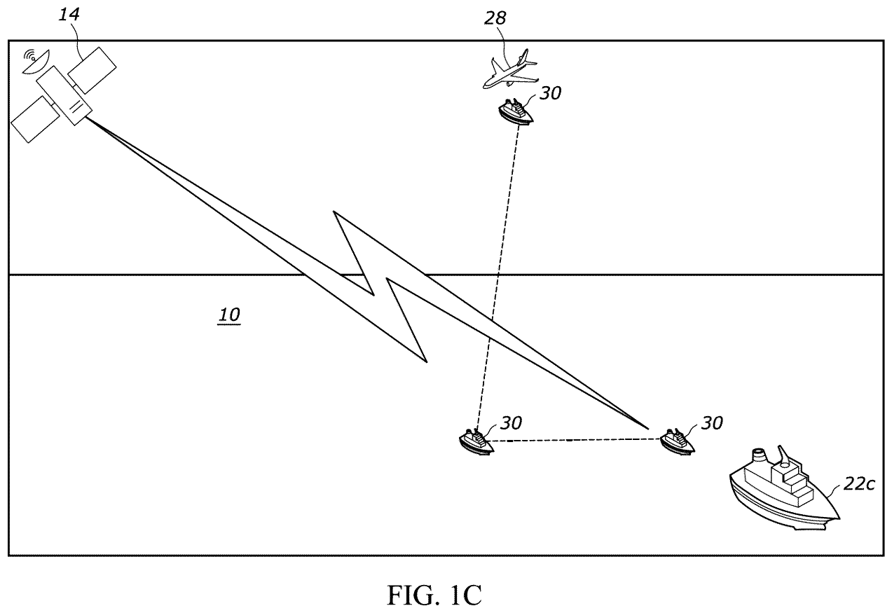

### Example Scenario 1 (FIG. 1A)

As depicted in FIG. 1A, in a first example scenario, a swarm (e.g., a group) of autonomous maritime surface vehicles (AMSVs) 20a-20e deploys from a shoreline 12 to collectively patrol a maritime environment 10. A mobile control system (MCS) 18 on the shoreline 12 executes a Swarm Situational Awareness (SSA) module to control the swarm 20a-20e. As the AMSVs 20a-20e depart the shoreline 12, each of the AMSVs 20a-20e communicates directly, via radio frequency (RF) signals, with the MCS 18 and/or, using mobile communications and/or data signals, with a mobile technology (MT) base station 16 that is coupled to the MCS 18 by an internet connection.

The AMSVs 20a-20e patrol the maritime environment 10 to look for other watercraft. As the AMSVs 20a-20e move into the maritime environment 10 and away from the shoreline 12, the signal strength between the AMSVs 20a-20e and the MCS 18 (or the mobile technology base station 16) becomes unreliable. One of the AMSVs 20a, detecting that the swarm of AMSVs 20a-20e will soon be unable to communicate with the MCS 18, autonomously peels off from the swarm of AMSVs 20a-20e and remains positioned such that it has a reliable RF connection with the MCS 18. The AMSV 20a acts as a gateway node of an ad-hoc mesh network which the AMSVs 20a-20e form and use to communicate with each other, and provides communication connectivity between the remainder of the AMSVs 20b-20e and the MCS 18.

The AMSVs 20b-20e continue into the maritime environment 10, one, and then multiple, of the AMSVs 20b-20e detect a watercraft 22a using respective infrared cameras. Each of the AMSVs 20b-20e employs a local situational awareness (LSA) module to determine, based on its own detections, a track—a heading, velocity, and position—of the craft 22a, i.e., a local track of the craft 22a as perceived by each AMSV 20b-203. Each of the AMSVs 20b-20e transmits its detection data to the MCS 18, using the mesh network formed by the AMSVs 20a-20e. AMSVs 20c-20e transmit their detection data to the AMSV 20b at the rear of the group, and the AMSV 20b transmits all of the data to the AMSV 20a that stayed behind to provide reliable communication to the MSC 18 on the shoreline 12. The SSA module in the MCS 18 fuses the detections together to create a fused track of the craft 22a, and determines that the craft 22a is heading out of the patrolled maritime environment 10.

The MCS 18 communicates the fused track to the AMSVs 20a-20e using the ad hoc mesh network that the AMSVs 20a-20e have formed, and instructs the AMSVs 20a-20e to follow the craft 22a, while discretely remaining a safe distance from the craft 22a, until the craft 22a has departed the patrolled area.

### Example Scenario 2 (FIG. 1B)

FIG. 1B depicts a second example scenario in which a manned military vessel 24 is patrolling a different area of the maritime environment 10 further from shore. Among the assets onboard the vessel 24 are a multiplicity of AMSVs 26a-26g. While onboard the vessel 24, each of the AMSVs 26a-26g is in a standby mode. In the standby mode, almost all systems of the AMSVs 26a-26g are shut down to save onboard power systems. Three of the AMSVs 26e-26g are larger and have a greater range than the others of the AMSVs 26a-26d, which are smaller (i.e., harder to detect), have a shorter range, and operate solely on battery power. A monitoring circuit in each AMSVs 26a-26d determines when the AMSV has been deployed into the water to bring the AMSV systems out of standby, while the AMSV systems of the AMSVs 26e-26g are activated by human intervention upon deployment.

A satellite 14 detects a target vessel 22b. Upon receiving the report that the target vessel 22b has been detected by the satellite 14, the military vessel 24 deploys AMSVs 26a-26d to observe the target vessel 22b, confirm its identity, and determine a track of the target vessel 22b. The AMSVs 26a-26d are deployed into the water from the military vessel 24 and a sensor or monitoring circuit on each AMSV 26a-26d, upon detecting that the AMSV 26a-26d has landed in the water, activates the systems of the AMSVs 26a-26d. An MCS 18 operating on the military vessel 24 sends instructions to the AMSVs 26a-26d to head toward the area where the target vessel 22b was sighted and observe the target vessel 22b.

The AMSVs 26a-26d head toward the last known position of the target vessel 22b. As they travel, the AMSVs 26a-26d use infrared and electro-optical cameras to keep track of each other and their surroundings. Each AMSVs 26a-26d logs detections and, with its LSA module determines the local tracks of the detected objects, while sharing detections with each other of the AMSVs 26a-26d so that each vehicle may, using its LSA, track the objects around it. In order to maintain situational awareness, each of the AMSVs 26a-26d, while generally heading toward the target vessel 24, regularly executes a turn (e.g., an “S” turn) to sweep its cameras outside of its primary line of travel, logging any detections made in so doing. One of the rearward AMSVs 26a-26d occasionally completes a complete 360-degree turn in order to maintain situational awareness of what is behind the swarm, outside the fields of view of the swarm's perception systems.

As the swarm of AMSVs 26a-26d approaches the area identified by the satellite 14, one, then another, and then the remainder of the AMSVs 26a-26d detect the target vessel 22b. Each of the AMSVs 26a-26d logs its detections and uses its respective LSA module to determine a track of the target vessel 22b based on its own detections, while communicating its detections back to the MCS 18 on-board the military vessel 24. Because of the forward positions of the AMSVs 26a, 26c, and 26d, each of these AMSVs communicates its detections to the MCS 18 using an ad hoc mesh network and, in particular, communicates its detections to the MCS 18 using the AMSV 26b as an intermediary communication node. The detections include images and video streams and, at times, the local tracks respectively generated by the AMSVs 26a-26d.

The AMSVs 26a-26d confirm that the vessel they have detected is the target vessel 22b, as do the software and personnel associated with the MCS 18 on-board the military vessel 24. The SSA on the MCS 18, integrating the detections received from each of the AMSVs 26a-26d, determines a fused track of the target vessel 22b, and send the fused track along with instructions to the AMSVs 26a-26d to continue tracking the target vessel 22b while maintaining their distance from the target vessel 22b such that the RF emissions of the AMSVs 26a-26d are virtually undetectable and the low profiles of the AMSVs 26a-26d are similarly difficult to detect from the target vessel 22b. The AMSVs 26a-26d continue to send updated local detections to the MCS 18 and, based on the updates, the MCS 18 updates the fused track of the target vessel 22b over time and provides the updated fused track of the target vessel 22b to the AMSVs 26a-26d.

Having confirmed the identity, position, and track of the target vessel 22b, personnel onboard the military vessel 24 deploy three additional AMSVs 26e-26g, each of which, being larger and propelled by a diesel motor, can carry a bigger payload over a larger range. The MCS 18 provides the AMSVs 26e-26g with the most recently updated fused track of the target vessel 22b, and sends commands or instructions to the AMSVs 26e-26g to turn off all RF transmitters and operate in receive only mode while heading for an interception with the target vessel 22b. The MCS 18 also indicates to each of the AMSVs 26e-26g its intended interception point on the target vessel 22b (e.g., the target vessel's 22b stern, bow, power systems, steering assemblies, broadside, etc.), and the order and timing in which the interceptions of the AMSVs 26e-26g are to happen. As eventually the AMSVs 26e-26g lose their direct RF connection with the MCS 18, the AMSV 26b relays data to them from the MCS 18, including the updated position and fused track of the target vessel 22b which, of course, is still being monitored by the AMSVs 26a-26d.

Finally, the AMSVs 26e-26g detect the target vessel 22b. Each of the AMSVs 26e-26g turns off all RF transceivers and goes “radio silent.” Each AMSV 26e-26g uses its detection algorithms to accurately determine its distance from the target vessel 22b, in addition to the current heading, speed, and orientation of the target vessel 22b, and adjusts its course to meet the intercept parameters it received. The AMSVs 26e-26g intercept the target vessel 22b, each very near the assigned interception point, and respective payloads of the AMSVs 26e-26g detonate upon contact with the target vessel 22b.

### Example Scenario 3 (FIG. 1C)

As depicted in FIG. 1C, in a third example scenario, a satellite observes a vessel of interest 22c located in the middle of an ocean. The vessel of interest 22c cannot be observed in sufficient detail by satellite, and a decision is made to surreptitiously obtain a closer view.

An airplane 28 flies over an area near—but not too near—the vessel 22c. The airplane 28 carries an AMSV 30. While onboard the airplane 28, the AMSV 30 is in a standby mode. In the standby mode, almost all systems of the AMSV 30 are shut down to save onboard power systems. As the airplane 28 flies near the vessel 22c, it drops the AMSV 30 from its cargo bay, delivering the AMSV 30 to the ocean 10 below. Sensors in the AMSV 30 detect the fall and the splashdown and activate the systems of the AMSV 30.

The AMSV 30 announces its activation to a satellite 14, and receives instructions to proceed to an area near the last known position of the vessel 22c. The AMSV 30 proceeds toward the last known position of the vessel 22c, passively (i.e., using IR and electro-optical cameras) scanning for detected objects. The AMSV 30 detects the vessel 22c, and determines, via its LSA module, a track of the vessel 22c. At the same time, the AMSV 30 transmits real-time video data to the satellite 14 so that personnel can monitor the vessel 22c.

### Example Autonomous Maritime Surface Vehicle (AMSV)—Perspective Views

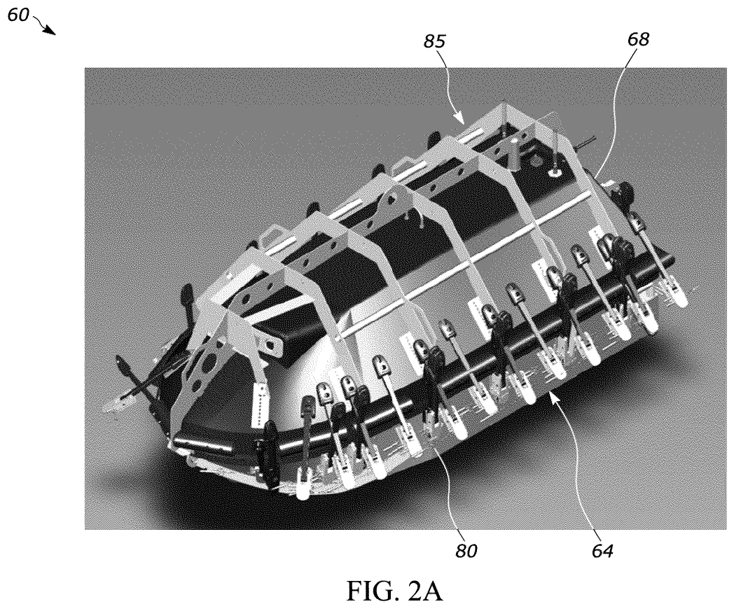

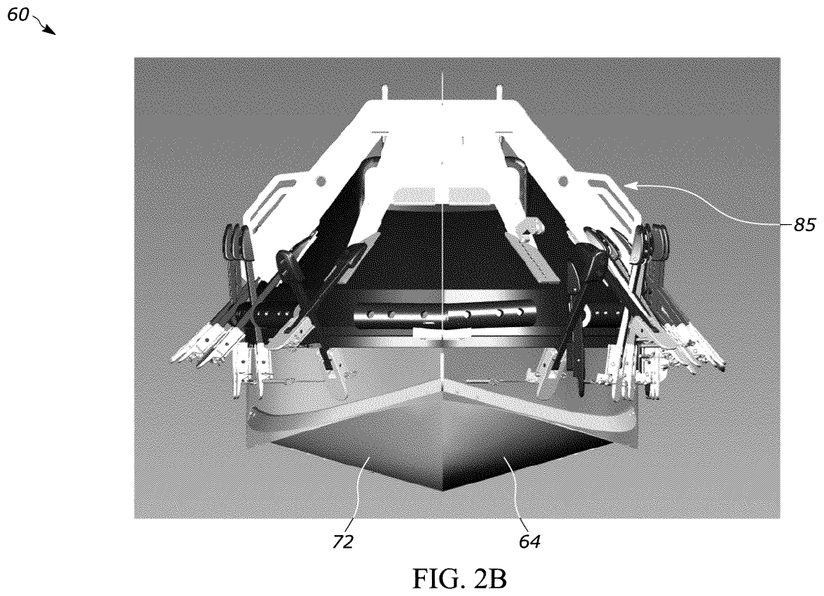

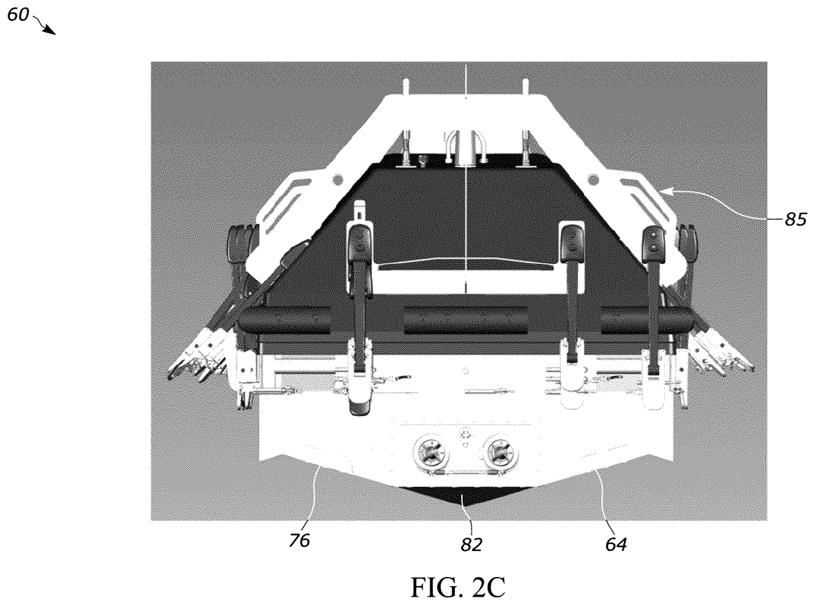

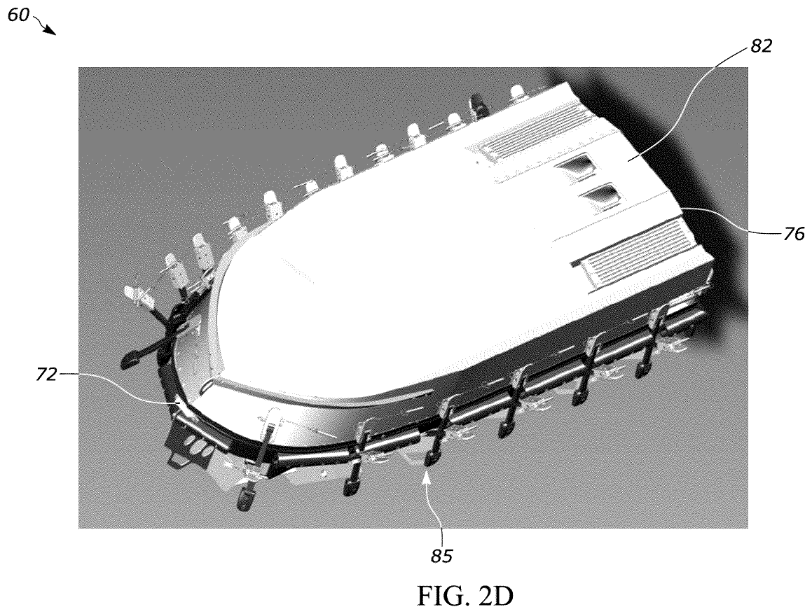

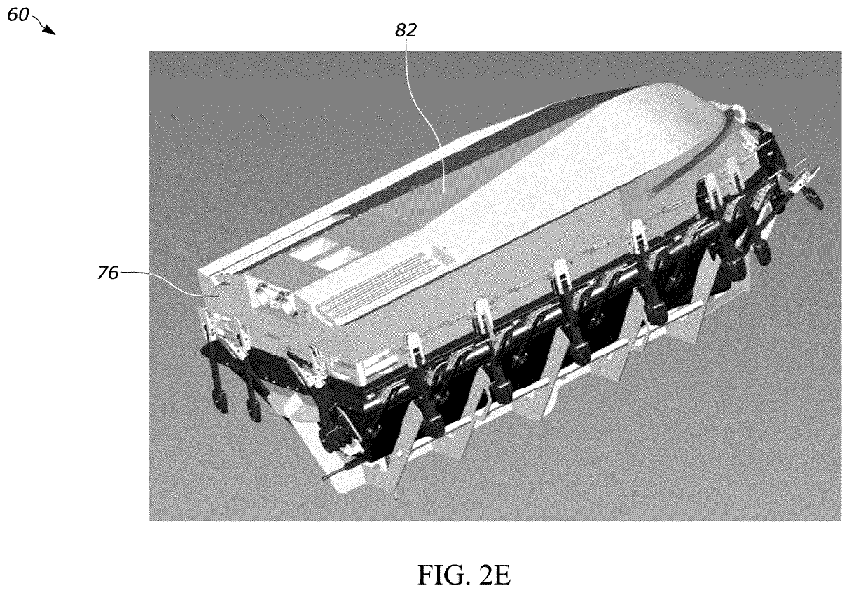

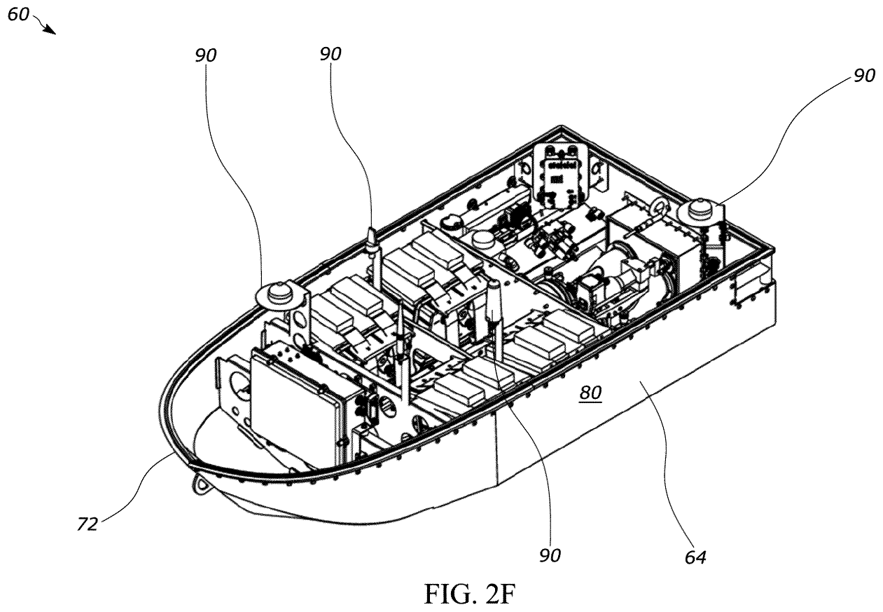

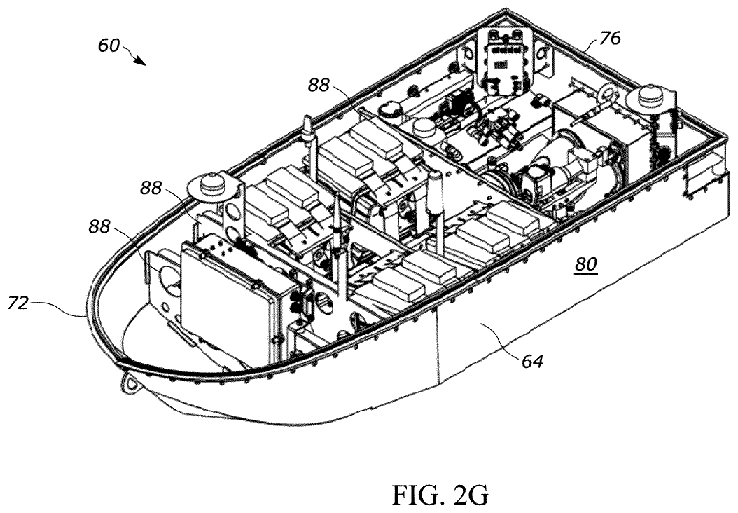

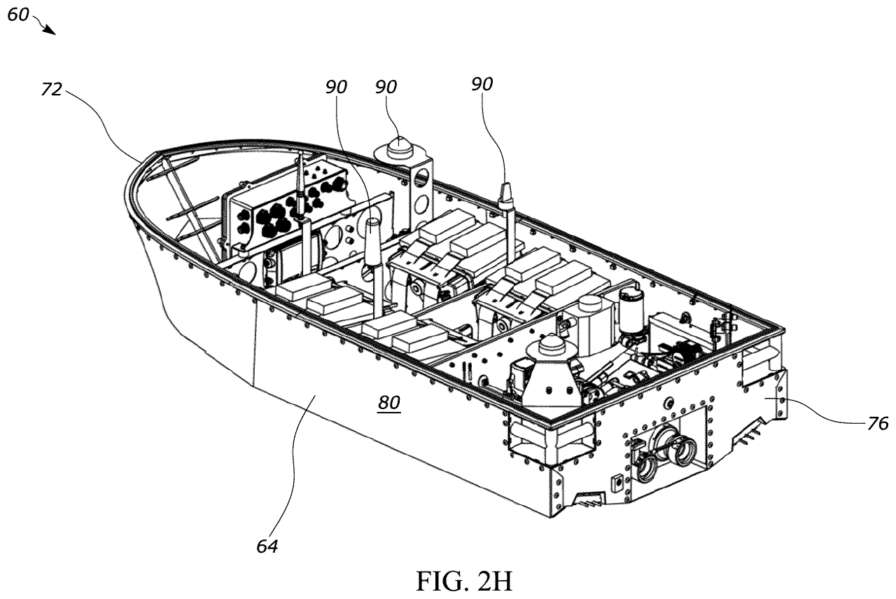

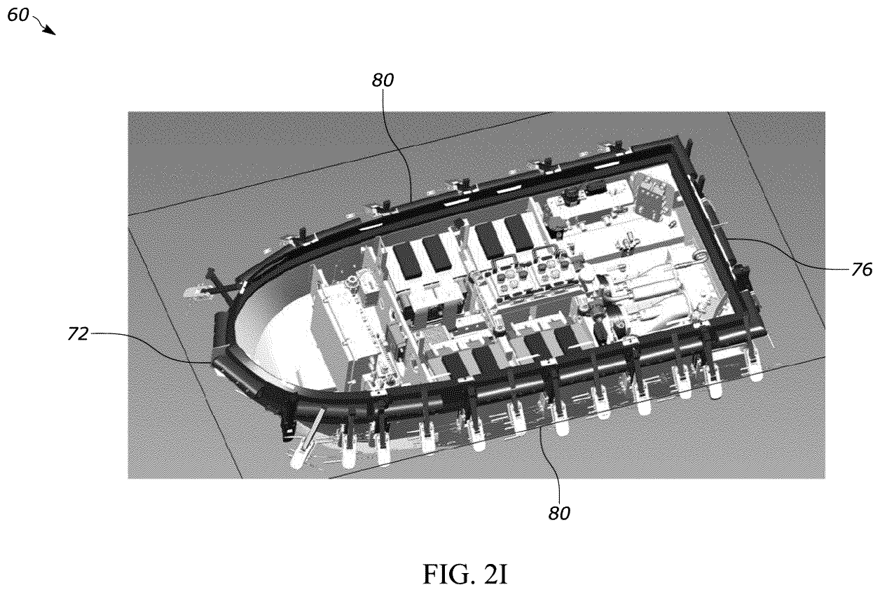

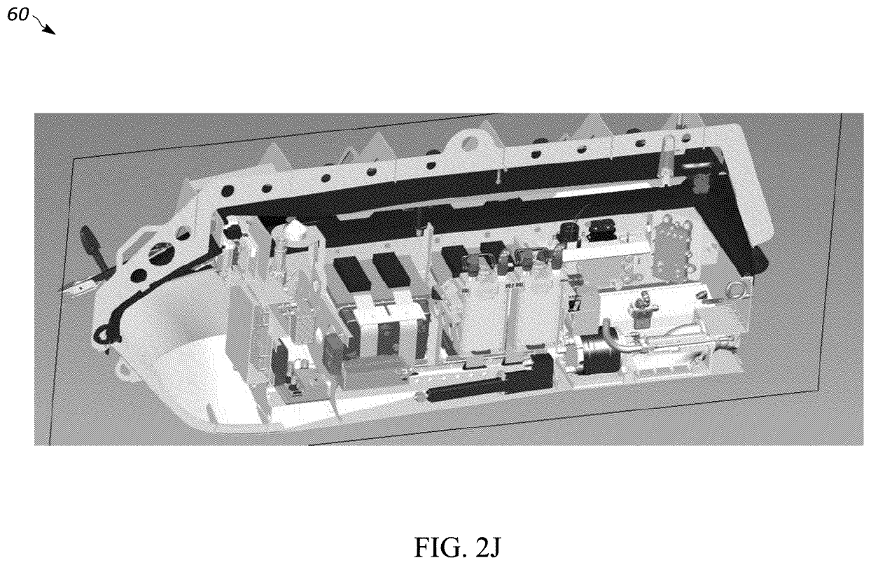

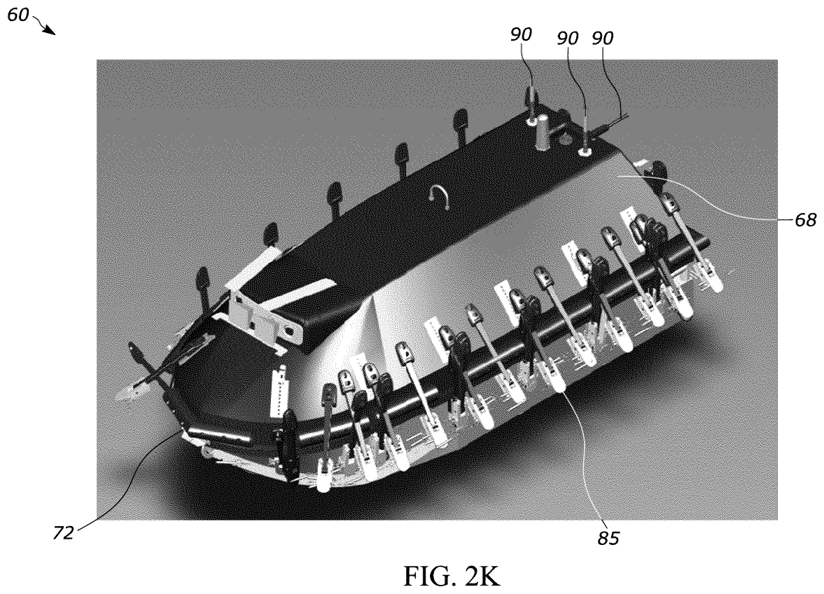

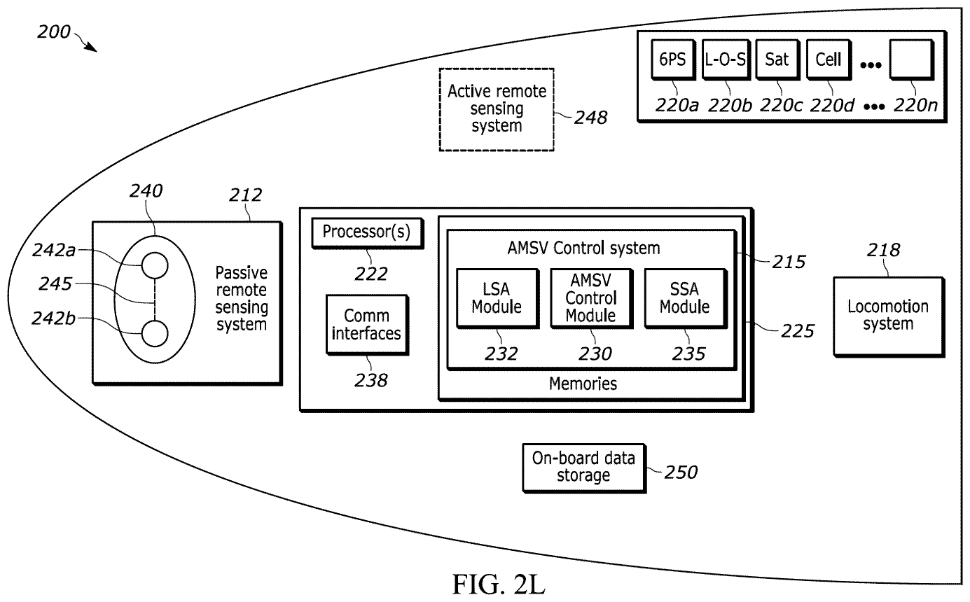

FIGS. 2A-2K illustrate one example of an autonomous maritime surface vehicle (AMSV) 60 in accordance with the teachings of the present disclosure. Generally speaking, the AMSV 60 is an unmanned vehicle configured to autonomously traverse a body of water. The AMSV 60 generally includes a hull 64 and a cap 68 that is coupled to the hull 64 to secure various components within the AMSV 60. The hull 64 may be at least partially disposed in the body of water in which the AMSV 60 is traversing. The hull 64 may be a mono-hull that has a front (or bow) 72, a rear (or stern) 76, two sides 80, and a keel 82 coupled to one another. The front 72, the rear 76, the sides 80, and the keel 82 can be welded together or can be coupled to one another in a different manner. The hull 64 is configured such that the hull provides a continuous planning surface that allows the AMSV 60 to be highly maneuverable and to ride along the top of a body of water at high speeds, even in extreme weather conditions and difficult to navigate bodies of water. Meanwhile, the cap 68 may be coupled to the hull 64 to cover and/or conceal the components of the AMSV 60 disposed in and carried by the hull 64 as the AMSV 60 traverses the body of water.

In this example, the hull 64 and the cap 68 each have a length that is equal to approximately 6 feet. In other examples, however, the length can vary. For example, the length can be equal to approximately 14 feet. The hull 64 is preferably entirely made of aluminum but can be partially or entirely be made of fiberglass and/or one or more other materials. In other examples, the AMSV 60 can include two or more hulls (e.g., two parallel hulls) instead of the mono-hull. In this example, the cap 68 entirely covers the hull 64 (and the components therein). In other examples, however, the AMSV 60 need not include the cap 68 or the cap 68 may only partially cover the hull 64 (and the components disposed therein).

In some examples, the cap 68 can be removably coupled to the hull 64 via a locking system 85. For example, as illustrated in FIGS. 2A-2K, the locking system 85 can take the form of a plurality of latch mechanisms disposed around a perimeter of the AMSV 60. Thus, the cap 68 can be removed to allow access to the interior of the hull 64. In other examples, however, the cap 68 can be permanently coupled to the hull 64.

The autonomous maritime surface vehicle 60 also may include a plurality of bulkheads 88 arranged within the hull 64. Generally speaking, the bulkheads 88 divide the AMSV 60 into a plurality of different compartments for receiving and retaining different components in the AMSV 60.

The autonomous maritime surface vehicle 60 also includes one or more sensor systems that are generally configured to collect data about various components of the AMSV 60 as well as data about the environment surrounding the AMSV 60 (including data about objects disposed in that environment). To this end, the sensor system generally includes a plurality of sensors disposed on an exterior and/or an interior of the AMSV 60. The sensors can include, for example, one or more pressure sensors (e.g., positioned to detect the pressure of the ambient air external to the AMSV 60, the pressure of the water in which the AMSV 60 is disposed, the pressure within the AMSV 60), one or more temperature sensors (e.g., positioned to measure a temperature of a component of the AMSV 60, a temperature of ambient air external to the AMSV 60, a temperature of water in which the AMSV 60 is disposed), one or more acoustic sensors (e.g., sonar sensors), one or more LIDAR sensors, one or more location sensors (e.g., GPS sensors, compass sensors), one or more motion sensors (e.g., accelerometers, gyroscopes), one or more infrared sensors, one or more water level sensors, one or more humidity sensors, one or more power sensors (e.g., configured to detect charging or fueling levels), one or more lighting sensors (e.g., daylight sensors), one or more imaging sensors (e.g., CCD sensors, CMOS sensors), one or more magnetic sensors, or combinations thereof.

Additionally, the AMSV 60 may include a vision system which is generally configured to capture, process, and analyze images obtained by the one or more image sensors and other data (e.g., data obtained by other sensors in the sensor system). The vision system can in turn identify or classify the environment surrounding the AMSV 60 (including objects in that environment). In some embodiments, the vision system is included in the sensor system.

The AMSV 60 also includes a power system that is generally configured to power the AMSV 60 (and the components of the AMSV 60, such as the one or more sensor systems, a communications system, a navigation system, one or more local or on-board controllers, and/or other systems and components on-board the AMSV 60. For example, the power system may include a thrust system and one or more power sources configured to power the thrust system. The thrust system is generally configured to propel the AMSV 60 in/on/along the water in any number of directions (e.g., in a forward direction, in a rearward direction, in a sideways direction, or in a combination of different directions at the same time) and orient the direction of the AMSV 60 while the AMSV 60 is in the water, and may operate responsively based on control signals sent from the navigation system and/or from the one or more on-board controllers, for example. The thrust system can be a propeller-based thrust system or can be a jet pump-based thrust system. The thrust system can include thrusters installed at the bow 72 of the AMSV 60, at the stern 76 of the AMSV 60, at both the bow 72 and the stern 76, and/or elsewhere throughout the AMSV 60. The one or more power sources can include, for example, one or more batteries, fuel (e.g., gasoline, diesel) stored in tanks carried by the AMSV 60, hydrogen stored in hydrogen tanks carried by the AMSV 60, solar panels (e.g., mounted to an exterior of the vehicle 60), or other sources. The AMSV 60 illustrated in FIGS. 2A-2K includes four battery assemblies each including a rechargeable battery. The AMSV 60 generally also includes a cooling system configured to cool the thrust system and/or the one or more power sources, thereby preventing these components from overheating and leading to failure of the AMSV 60.

In operation, the AMSV 60 may be used to deploy and/or retrieve payloads such as, for example, persons, weapons (e.g., drones, missiles, mines, bombs), cargo (e.g., food), scientific instruments, or other equipment. Payloads can be deployed aerially (into the air), underwater, or on the surface of the water. Payloads can also be retrieved from the air, from underwater, or the surface of the water. Payloads to be deployed can be disposed in the hull 64, attached to the exterior surface of the hull 64, or attached to the exterior surface of the cap 68, e.g., prior to deployment. Likewise, retrieved payloads can be stored in the hull 64, attached to and stored on the exterior surface of the hull 64, or attached to and stored on the exterior surface of the cap 68.

The AMSV 60 can also include other systems to help with the operation of the AMSV 60, for example a ballast system, the navigation system, and a payload control system. The ballast system is generally configured to stabilize the AMSV 60 in the water, regardless of whether the AMSV 60 is stationary or on the move. To this end, the AMSV 60 may include one or more ballast tanks or chambers selectively filled with water or air to vary the buoyancy of the AMSV 60. Alternatively or additionally, the ballast system may include and utilize one or more inflatable devices to vary the buoyancy of the AMSV 60. The ballast system may also provide for the selective submerging and re-surfacing of the AMSV 60 in a similar manner. The navigation system, which may for example be an inertial navigation system, may utilize the sensors of the sensor system and/or the vision system to track the position and orientation of the AMSV 60 and to guide or steer the AMSV 60 to its desired location in the body of water (or in a different body of water). Finally, the payload control system is configured to deploy or retrieve payloads.

The autonomous maritime surface vehicle 60 further includes a communications system that is generally configured to facilitate communication (i) between the AMSV 60 and one or more central (remote) controllers, (ii) between the AMSV 60 and and/or one or more other AMSVs 60 and/or other types of maritime vehicles or other military assets (e.g., planes, ships), and (iii) locally (e.g., on-board) between different components of the AMSV 60. The communications system generally includes one or more communications controllers and one or more communication modules (e.g., one or more antennae 90, one or more transceivers (which may be implemented as one or more receivers and one or more transmitters), one or more radios, one or more ethernet switches, etc.) to effectuate wired or wireless communication between the AMSV 60 and the central controller(s), other maritime vehicles, and/or other military assets. For example, the AMSV 60 may include a plurality of antennae 90 disposed on an exterior of the cap 68 as well as a plurality of antennae 90 disposed in the hull 64.

As mentioned above, the AMSV 60 may include one or more local (e.g., on-board) controllers which are generally configured to communicate data and/or information (e.g., data and/or information from the sensor system and other on-board systems, data and/or information received from other AMSVs 60 and/or other types of maritime vehicles or military assets) and to perform automated operations of the AMSV 60 based on that data and/or information (e.g., by generating and sending operational instructions, control signals, etc.). In some examples, the AMSV 60 includes a plurality of different local or on-board controllers. For example, the AMSV 60 can include one or more sensor controllers (for controlling the sensors in the sensor system), one or more vision system controllers (for controlling the vision system), one or more payload controllers (for deploying or retrieving payloads), one or more navigation controllers (for controlling the operations of the navigation system), one or more thrust controllers (for controlling the operations of the thrust system), one or more communications controllers (for communicating data and/or information to off-board entities such as central (remote) controllers and/or other maritime assets), and one or more ballast controllers (for controlling the ballast system). It will be appreciated that each of the one or more controllers may be implemented as hardware (e.g., processor, die, integrated device), software (e.g., non-transitory processor readable medium), and/or combinations thereof, in one or more devices (e.g., processor, chip, computer, tablet, mobile device).

While not explicitly described or illustrated herein, it will be appreciated that the AMSV 60 includes several additional components. For example, the AMSV 60 includes various sealing elements configured to provide seals between different components of the vehicle 60 (or between the vehicle 60 and the environment surrounding the vehicle 60). As another example, the AMSV 60 also includes various fasteners that help to couple the components of the AMSV 60 together. As yet another example, the AMSV 60 includes cabling and/or wiring that helps to communicatively couple components of the AMSV 60 together. As yet another example, the AMSV 60 includes various electrical components that help to operate the AMSV 60, e.g., one or more relay boards, one or more DC-DC converters, etc.

Generally speaking, the perception techniques/systems of the present disclosure allow an AMSV to accurately, reliably, and passively sense, perceive/detect, and identify targets within a marine, littoral, riparian, or other environment. More specifically, the techniques/systems of the present disclosure sense radiation from an external environment of an AMSV using a passive sensing system (e.g., a stereovision infrared (IR) camera) to detect objects within data representative of the radiation. The techniques/systems of the present disclosure thereby improve over conventional perception techniques/systems at least by accurately and reliably detecting targets in two and three dimensions within an AMSV external environment (e.g., marine environment) without emitting radiation detectable by such targets.

Conventional marine sensing systems and perception techniques/systems frequently rely on active sensing components (i.e., components that actively emit, and subsequently capture, radiation) to detect objects proximate to a marine vessel. These active sensing components are often coupled with passive sensing components (i.e., components that only capture radiation) to, for example, improve overall data capture capabilities, increase data intake at particular wavelengths, and/or estimate depth through travel time (e.g., RADAR). However, such conventional techniques/systems suffer from several notable drawbacks.

As one example, active sensing systems create significant amounts of noise and/or otherwise detectable radiation. Other vessels proximate to a marine vessel utilizing an active sensing system can readily sense this radiation, such that the marine vessel effectively sacrifices its stealth and any attendant benefits from remaining undetected (e.g., safety in combat scenarios). For vessels performing activities/missions requiring a high degree of stealth (e.g., reconnaissance, target tracking, etc.), conventional active sensing systems jeopardize the activities/missions, as well as the vessels themselves and (for manned vehicles) the lives of their crews.

Further, conventional marine sensing systems may utilize stereoscopic vision (also referenced herein as “stereovision”) techniques to determine depth information associated with sensed objects. The accuracy of any depth value resulting from stereoscopic images is directly proportional to the baseline length between the two image sensors comprising the stereoscopic camera system, and many marine vessels have limited space to accommodate a large baseline distance. As a result, conventional stereoscopic imaging techniques in many marine environments may yield insufficiently accurate depth values. This poses a significant challenge, for example, for collision avoidance when in close proximity to a friendly (or non-targeted) object or in circumstances where the position of a target is a mission critical value requiring pinpoint accuracy, such as when a marine vessel is tracking and/or intends to engage the target.

Moreover, conventional marine sensing systems employing stereoscopic vision typically utilize identically sized fields of view (FOVs) with parallel optical axes (also referenced herein as “central” axes). This configuration underutilizes the individual imagers comprising the stereovision camera by orienting the imagers in the same direction and/or creates blind spots near the edges of the vessel (e.g., bow, stern, port side, starboard side, depending on stereoscopic system orientation), and experiences difficulties when the desired combined FOV of the stereovision system is broader or narrower than the identically sized FOVs of the two image sensors. The blind spots create a substantial challenge for effective vessel navigation relative to proximate objects (e.g., within 10 feet), and the identically sized FOVs may lack the breadth to capture the entire vessel environment and/or the resolution to identify objects within a particular region of interest. Further, having multiple imagers oriented in the same direction generally adds size, weight, and/or consumes additional power for minimal/negligible additional benefit.

By contrast, the present disclosure provides AMSV perception techniques/systems that overcome several of these issues experienced by conventional techniques/systems to achieve accurate and reliable target sensing, perception/detection, and identification. Namely, the present techniques/systems generally utilize a completely passive sensing system (e.g., stereovision IR camera system) to detect radiation in an external environment of an AMSV and ultimately detect objects indicated by data representative of the radiation. In doing so, the techniques/systems of the present disclosure overcome the significant noise/detection issues experienced by conventional techniques/systems that rely on active sensing systems to detect proximate objects in a marine environment. The present techniques/systems eliminate the emitted radiation resulting from using active sensing system radiation emissions, and thereby preserve the AMSV's stealth relative to proximate vessels. These advantages are further amplified by utilizing IR sensors that can operate in low-light (e.g., nighttime) environments without sacrificing visibility. Consequently, the present techniques/systems improve over conventional marine sensing systems at least by enabling the AMSV to operate effectively while remaining undetected during activities/missions requiring stealth, such that the activities/missions and the AMSV have a larger probability of success.

In certain examples, the present techniques/systems include sensing radiation from an external environment of an AMSV using a sensing system that includes at least a stereovision IR camera with (i) a first IR image sensor with a first IR FOV having a first optical axis and (ii) a second IR image sensor with a second IR FOV having a second optical axis that is not parallel with the first optical axis.

By utilizing two IR sensors with FOVs having non-parallel optical axes, the techniques/systems of the present disclosure overcome the navigation challenges experienced by conventional techniques/systems. In particular, the two IR sensors create a shared FOV (referenced herein as a “stereoscopic FOV”) that is significantly closer to the edge (e.g., the bow) of the AMSV than was previously accomplished using conventional techniques/systems. This configuration thus enables the AMSV to navigate accurately and efficiently relative to objects within the marine environment at distances significantly closer to the AMSV (e.g., less than 10 feet) than conventional techniques/systems allowed. As a result, the AMSV is able to plan and execute navigation routes with greater accuracy and precision than was previously possible, leading to more efficient/optimal routing, reduced inadvertent/unintentional collisions with proximate objects, and higher mission success rates for a given cost.

Additionally, in some embodiments, the present techniques overcome the issues experienced by conventional techniques by maintaining a target in an offset position relative to the sensing system optical axis. In particular, the present techniques include applying a perception algorithm to data representing sensed radiation to detect one or more objects indicated by the data, determining that at least one object indicated by the data represents a target, and orienting an AMSV to offset the target from the sensing system optical axis. These elements, among others, take a non-intuitive approach that improves over conventional techniques.

Maintaining the target in the offset position intentionally introduces perceived lateral movement (e.g., left/right within the passive sensing system FOV) of the target into subsequent image captures. This lateral movement is “perceived” because at least a portion of the target's lateral movement between subsequent image captures is due to a change in distance/depth between the AMSV and the target between the subsequent image captures. In other words, as the AMSV moves towards/away from the target, the target (or a centroid or other designated portion of the target) appears (i.e., is perceived) to laterally move within the passive sensing system FOV between the subsequent image captures. Generally speaking, this perceived movement has a covariant relationship with the target's depth, such that changes in the target's depth result in a corresponding change in the target's perceived lateral movement. Thus, when combined with the measured depth values, the techniques of the present disclosure can leverage this perceived lateral movement to reduce the uncertainty (i.e., improve accuracy) associated with the depth values.

The techniques of the present disclosure thus also improve the functionality of a computing device (e.g., an AMSV control system) at least by analyzing data in a particular way to enhance the accuracy and efficiency of the computing device. The perception algorithm, executing on the computing device, detects objects within image data using techniques that achieve an accuracy not possible using conventional techniques. That is, the present disclosure describes improvements in the functioning of the computer itself because the computing device more accurately analyzes/utilizes data as a direct result of the perception algorithm. This improves over the prior art at least because existing systems inaccurately analyze image data, are incapable of accurately analyzing data within marine environments, and/or are otherwise unable to analyze data with the accuracy resulting from the disclosed perception algorithm.

Still further, the present disclosure includes specific features other than what is well-understood, routine, conventional activity in the field, or adding unconventional steps that demonstrate, in various embodiments, particular useful applications, e.g., sensing radiation from an external environment of the AMSV using a sensing system that includes at least a stereovision IR camera with (i) a first IR image sensor with a first IR field of view (FOV) having a first optical axis and (ii) a second IR image sensor with a second IR FOV having a second optical axis that is not parallel with the first optical axis; and/or applying, by one or more processors, a perception algorithm to data representing the radiation to detect one or more objects indicated by the data, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. For example, while described herein primarily in the context of IR imagers/cameras, the techniques described herein may be additionally or alternatively applied/implemented for electro-optical (EO) imagers/cameras and/or imagers or sensors of any suitable wavelength. Moreover, while described herein primarily in the maritime context, the techniques described herein may be readily applied in any suitable field for any suitable purpose.

### Example Autonomous Maritime Surface Vehicle (AMSV)—Block Diagram

FIG. 2L depicts a block diagram of an example autonomous maritime surface vehicle (AMSV) 200 in accordance with the teachings of this disclosure. As shown in FIG. 2L, the AMSV 200 includes a passive remote sensing system 212, a control system 215, a locomotion system 218, and a group of n communication interfaces 220a-220n via which the AMSV 200 may communicatively connect to off-board devices and systems (e.g., “off-board” or “external” communication interfaces 220a-220n), where typically, but not necessarily, n is an integer greater than one. The AMSV 200 may be, for example, the AMSV 60 of FIGS. 2A-2K, in an embodiment, or another autonomous maritime surface vehicle. For example, the passive remote sensing system 212 may be implemented by at least a portion of the sensor system and/or the vision system of the AMSV 60, the control system 215 may be included in the one or more local or on-board controllers of the AMSV 60 or vice versa, the locomotion system 218 may include the navigation system and/or the thrust system of the AMSV 60, and the communication interfaces 220 may be included in the communications system of the AMSV 60, for example.

As shown in FIG. 2L, the control system 215 of the AMSV 200 (also interchangeably referred to herein as “the AMSV control system 215” or the “vehicle control system 215”) includes one or more processors 222 and one or more memories 225 storing an AMSV control module 230 (also interchangeably referred to herein as a “vehicle control module” 230), a local situational awareness module (LSA) 232, a swarm situational awareness (SSA) module 235, and optionally one or more other modules (not shown). The one or more memories 225 may also store locally generated detection data generated by the AMSV, remotely generated detection data received from others of the AMSVs in the swarm, mission definition data, tracks generated by the LSA module based on the locally generated detection data and/or the remotely generated detection data, fused tracks received from the active SSA module, and other data as required for navigation, operation, and mission execution. The AMSV control system 215 also includes one or more communication interfaces 238 (e.g., one or more “on-board” or “internal” communication interfaces 238) via which the AMSV control system 215 may communicate with one or more other systems, components, and/or modules on-board the AMSV 200, such as the passive remote sensing system 212, the locomotion system 218, the off-board communication interfaces 220a-220n, an active remote sensing system 248 (if included in the AMSV 200), and other on-board systems, components, and/or modules.

Typically, each of the AMSV control module 230, the LSA module 232, and the SSA module 235 includes a respective set of computer-executable instructions that are executable by the one or more processors 222 to cause the AMSV 200 to perform one or more of the methods and/or techniques described elsewhere herein; however, in some implementations, at least one of the modules 230, 232, 235 may be implemented at least partially using firmware and/or at least partially using hardware. Further, although FIG. 2L depicts the AMSV control module 230, the LSA module 232, and the SSA module 235 as being separate and distinct modules, this only for the purposes of clarity of discussion and is not limiting. For example, at least a portion of the AMSV control module 230 and at least a portion of the SSA module 235 may be implemented as an integral module, at least a portion of the LSA module 232 and the SSA module 235 may be implemented as an integral module, all three modules 230-235 may be implemented as a single integral module, at least a portion of at least one of the modules 230-235 may be implemented integrally with some other module of the control system 215 (not shown), etc.

Generally speaking, and as will be described in more detail below, the passive remote sensing system 212 operates to passively detect or sense the presence of objects (and, in some cases, the absence of the presence of one or more objects or of any object) within its field-of-view (FOV). Objects may include, for example, other AMSVs, other friendly maritime vehicles, enemy maritime vehicles, other types of enemy maritime assets (e.g., floating mines, enemy communication towers, etc.), enemy land-based assets (e.g., disposed on the coastline or shore), and the like. Data indicative of the results of the sensing performed by the passive remote sensing system 212 may be provided to the AMSV control system 215. The control system 215 may operate on the provided passively-sensed data (and optionally operate further based on data provided by at least one of the off-board communication interfaces 220a-220n and/or by other components of the AMSV 200) to generate a control signal, which the control system 215 may provide to the locomotion system 218. Responsive to the control signal, the locomotion system 218 may operate to change (or in some situations, maintain) an orientation of the AMSV 200, a movement of the AMSV 200, or both an orientation and a movement of the AMSV 60 within the body of water. In some situations, the AMSV control system 215 may generate control signals based on the sensing data provided by the passive remote sensing system 212 and information provided by other on-board and/or off-board systems, as will be described in more detail elsewhere herein.

At any rate, and as discussed above, the passive remote sensing system 212 is configured to passively detect or sense the presence and/or absence of an object (and/or of any objects, for that matter) within the FOV of the passive remote sensing system 212. As such, in an embodiment, the passive remote sensing system 212 may include one or more stereovision cameras 240. Each stereovision camera 240 may include a respective group of image sensors 242 which are configured to capture similar electromagnetic radiation across a similar FOV, and which are separated (e.g., fixedly separated) by a baseline distance 245. Typically, the group of image sensors 242 includes a pair of (i.e., two) image sensors 242a, 242b; however, in some implementations, the group of image sensors 242 may include more than two image sensors 242. However, for ease of reading herein and not for limitation purposes, the present disclosure refers to the group of image sensors 242 as including a pair of image sensors 242a, 242b.

The pair of image sensors 242 may utilize the same passive sensing technology. For example, the pair of images sensors 242b, 242b may be a pair of electro-optical (EO) sensors (e.g., a pair of red-blue-green or “RGB” sensors), a pair of infrared radiation (IR) sensors, etc. In FIG. 2L, only a single stereovision camera 240 is depicted. In other embodiments, though (not shown), the AMSV 200 may include multiple stereovision cameras 240. For example, the AMSV 200 may include multiple EO stereovision cameras, multiple IR stereovision cameras, both an EO stereovision camera and an IR stereovision camera, etc. Each stereovision camera of the one or more stereovision cameras 240 may be fixedly disposed at a respective location on the AMSV 200 (e.g., with respect to the body of the AMSV 200), where the respective location of the stereovision camera 240 does not change over time. In some implementations, though, the respective location of a stereovision camera 240 with respect to the body of the AMSV 200 may be dynamically controlled, over time, to change, e.g., may be automatically controlled without any human intervention. For example, a stereovision camera 240 may be automatically raised or lowered with respect to altitude or distance from the deck of the AMSV 200 to accommodate for large waves, to avoid detection, etc. Generally speaking, the passive remote sensing system 212 may operate to obtain sets of data indicative of captured electromagnetic radiation within its FOV at discrete time intervals (e.g., periodically at every x seconds and/or when desired), and/or the passive remote sensing system 212 may operate over time to continuously obtain sets of data indicative of captured electromagnetic radiation within its FOV, e.g., as quickly as the system 212 can technically do so. For example, the passive remote sensing system 212 may livestream sensed data, where the livestream sensed data may include RGB and/or IR imaging livestreams. A more detailed description of the passive remote sensing system 212 and the time-series or continuous snapshots of sensing data generated by the passive remote sensing system 212 is provided elsewhere within this disclosure.

In some embodiments, in addition to the passive remote sensing system 212, the AMSV 200 may also include an active remote sensing system 248, such as a RADAR (Radio Detection and Ranging), LIDAR (Light Detection and Ranging), or some other type of active remote sensing system which generally requires the active remote sensing system 248 to expressly or actively initiate transmissions of signals (e.g., radio signals, light signals, sound signals, etc.) to perform the sensing of remote objects. Data indicative of the results of the active sensing performed by the active remote sensing system 248 may be provided to the control system 215, which may operate on the active sensing data provided by the active remote sensing system 248 in conjunction with the passive sensing data provided by the passive remote sensing system 212 (and optionally the data provided via at least one of the off-board communication interfaces 220a-220n and/or one or more other on-board systems and/or components) to generate control signals that are to be provided to the locomotion system 218. However, an active remote sensing system 248 is not a necessary or required component of the AMSV 200. Indeed, in some embodiments, the AMSV 200 does not include (that is, the AMSV 200 excludes) any type of active remote sensing system 248 at all. In some embodiments, the AMSV 200 includes an active remote sensing system 248 but powers down, deactivates, disables, or turns off the active remote sensing system 248 altogether (e.g., so that that active remote sensing system 248 does not emit any signals and transmissions at all, including not transmitting any heartbeat, scanning, or other administrative types of signals) so that the AMSV 200 is totally “radio-silent” and relies only on passive sensing data provided by the passive remote sensing system 212 to generate control signals for the locomotion system 218.

Turning back to the passive remote sensing system 212, the passive remote sensing system 212 of the AMSV 200 may be communicatively connected to the AMSV control system 215 on-board the AMSV 200, typically in a wired manner via communication interfaces 238, and the passive sensing data generated and/or provided by the passive remote sensing system 212 may be received by the local situational awareness (LSA) module 232 of the control system 215 and/or may be stored locally on-board the AMSV 200. For example, the passive remote sensing system 212 may transmit at least some of the passive sensing data via the communicative connection between the passive remote sensing system 212 and the LSA module 232. Additionally or alternatively, the passive remote sensing system 212 may store passive sensing data in local data storage 250 on-board the AMSV 200 (also interchangeably referred to herein as “on-board” data storage 250) and the LSA module 232 of the AMSV control system 215 may access the passive sensing data stored in local data storage 250. In some situations, the passive sensing data may be indicative of a detection of a presence of a remotely located object within the FOV of the passive remote sensing system 212. Upon or after the initial detection of the presence of the object, the LSA module 232 may utilize one or more image processing techniques (e.g., image segmentation, object detection, etc.) to detect, classify, and/or identify the object within the FOV sensed data (e.g., recreational maritime vehicle, type of enemy vessel, specific enemy vessel, etc.). Additionally, the LSA module 232 may utilize subsequent passive sensing data provided by the passive remove sensing system 212 (e.g., snapshots of sensing data over time) to generate and update a local track of the path of the detected object over time, where the local track may be indicative of the direction(s) in which the detected object has moved between various detections over time. The elapsed time interval between attempted detections of objects (e.g., between snapshots of sets of passively sensed data generated by the passive remote sensing system 212) may be a standard or periodic time interval (e.g., every x seconds), and/or the elapsed time intervals between various attempted detections may vary over time.

For example, the LSA 232 may obtain a plurality of detections of the object over time (e.g., time-series snapshots of sets of passively sensed data) and determine a respective relative position of the object with respect to the AMSV 200 for each detection, e.g., based on global positioning system (GPS) or other types of geospatial positioning data indicative of the AMSV's current physical geospatial location, which may be obtained via off-board communication interface 220a, for example. The LSA 232 may generate and/or update a local track of the object based on the respective relative positions of the detected object over time with respect to the AMSV 200. As such, the local track of an object may be indicative of a path of travel, over time, of the object as perceived by and with respect to the location(s) of the AMSV 200 over time (e.g., a track that is locally determined at the AMSV 200), and as such the local track may include both a geographical location component as well as a temporal component. The LSA module 232 may generate and update a plurality of local tracks of a plurality of remotely-located objects whose respective presences have been detected by the passive remote sensing system 212 of the AMSV 200. Additionally, indications of local tracks of one or more detected objects and updates thereto may be stored in the local data storage 250. As such, the local data storage 250 may store indications of one or more current local tracks respectively corresponding to one or more detected objects. In some situations, the local data storage 250 may store respective local tracks of all objects which have been detected by the passive remote sensing system 212.

It is noted that although FIG. 2L depicts the LSA module 232 as being included in the control system 215, in some embodiments (not shown in FIG. 2L), at least a portion of the LSA module 232 (or, in some implementations, an entirety of the LSA module 232) may be included in the passive remote sensing system 212. For example, in addition to the passive remote sensing system 212 generating time-series data of attempts to detect objects (e.g., time-series snapshots indicative of any objects sensed within the FOV of the passive remote sensing system 212), the passive remote sensing system 212 may utilize its integral LSA module 232 generate local tracks of detected objects based on the generated time-series data.

Further, it is noted that although FIG. 2L depicts the local data storage 250 as being separate and distinct from the passive remote sensing system 212, the AMSV control system 215, and the AMSV locomotion system 218, this is only one of numerous possible embodiments. For example, a respective at least a portion of the local data storage 250 may be included in at least one of the passive remote sensing system 212, the AMSV control system 215, and/or the AMSV locomotion system 218, and the local data storage 250 may be accessed by the passive remote sensing system 212, the AMSV control system 215, and/or the AMSV locomotion system 218. Generally speaking, local data storage 250 may include one or more tangible, non-transitory, computer-readable media or memories such as magnetic disks, laser disks, optical discs, semiconductor memories, biological memories, random access memories (RAMs), flash memories, other memory devices, or other storage media.

A more detailed discussion of the passive remote sensing system 212, its components, and its operations are provided elsewhere herein.

Turning now to the AMSV control module 230 of the AMSV control system 215, the AMSV control module 230 may generate a control signal for the locomotion system 218 based on one or more inputs. The one or more inputs may include for example, one or more local tracks (or indications thereof) generated by the local situational awareness (LSA) module 232, one or more swarm-level tracks (or indications thereof) generated by on-board swarm situational awareness (SSA) module 235 or by another off-board SSA servicing the group or swarm in which the AMSV 200 is included, an indication of a geospatial location of a detected object (e.g., as detected by the passive remote sensing system 212), an indication of a geospatial location of the AMSV 200, (e.g., as indicated via GPS communication interface 220a or similar geospatial coordinate interface), and/or data provided by one or more sensor systems that are generally configured to collect data about various components of the AMSV 200 and data indicative of environmental conditions surrounding the AMSV 200 (e.g., pressure, temperature, water level and/or other water conditions, wind, humidity, speed, direction or orientation, etc.). In some situations, the AMSV control module 230 generates control signals further based on information obtained by the AMSV 200 via the off-board communication interfaces 220a-220n, e.g., information received at the AMSV 200 from GPS systems, other AMSVs, a remotely-located (e.g., off-board) SSA servicing the group or swarm of AMSVs in which the AMSV 200 is included, other maritime vehicles, land-based systems or devices, cloud-based systems, central (remote) controllers, etc. As such, the off-board communication interfaces 220a-220n may include interfaces supporting multiple different wireless technologies, such as a GPS communication interface 220a, one or more satellite communication interfaces 220c, one or more cellular communication interfaces 220d, one or more other types of line-of-sight (LOS) communication interfaces 220b (e.g., optical, Bluetooth, Zigbee, Digimess, WiFi, NearLink, near-field communications (NFC), LPWAN, UWB, IEEE 802.15.4-compatible, etc.), and/or other types of wireless communication interfaces. During operations, the AMSV 200 may power down, deactivate, disable, or turn off any one or more of the off-board communication interfaces 220a-220n as desired. Indeed, during some operations, the AMSV 200 may power down, deactivate, disable, or turn off all of the off-board communication interfaces 220a-220n so that that the AMSV 200 does not emit any wireless signals and transmissions at all, including not transmitting any heartbeat, scanning, or other administrative types of signals) so the AMSV 200 operates in a radio-silent mode. In these situations, the AMSV 200 may rely solely on passive sensing data provided by the on-board passive remote sensing system 212 to generate control signals for the locomotion system 218 and navigate in its environment.

As discussed above, in some situations, at least one of the inputs based on which the AMSV control module 230 generates a control signal includes respective local tracks of one or more detected objects, where the one or more local tracks are generated by the local situational awareness (LSA) module 232. In some situations, the AMSV control module 230 generates a control signal additionally or alternatively based on information and/or instructions received from a swarm situational awareness (SSA) module, where the SSA module may be the local SSA module 235 disposed on-board the AMSV, a remote SSA module disposed on-board another AMSV, a remote SSA module disposed in a mobile control system (MCS) (which may be disposed on another maritime vehicle or on land), or some other remotely-located SSA module corresponding to a group or swarm of AMSVs in which the AMSV 200 is included. Generally speaking, an SSA module servicing a group or swarm of AMSVs in which the AMSV 200 is included may operate to receive a plurality of local tracks of a detected object respectively from a plurality of AMSVs included in the group or swarm of AMSVs, and to generate a fused (e.g., a swarm-level) track of the detected object therefrom. The SSA module of the group or swarm may or may not receive and utilize a local track generated by the AMSV 200 to generate the fused or swarm-level track that is utilized by the AMSV 200 to navigate and move. A more detailed discussion of the SSA module and its use in swarms or groups of AMSVs and coordinating control across the swarm or group of AMSVs is discussed elsewhere herein.

Generally speaking, the SSA modules are operable to receive detection data from each AMSV in a swarm or fleet. Detection data transmitted to the active SSA module are generally transmitted using a guaranteed transmission method that verifies receipt of uncorrupted data. In embodiments, the detections from each AMSV are used to create AMSV-specific tracks of each detected object, and tracks that overlap by a predetermined threshold (e.g., 80% co-detections) are fused into a fused track. Of course, other embodiments of track fusion that could be employed.

Turning now the locomotion system 218, the locomotion system 218 is generally responsive to control signals generated by the AMSV control module 230, and is configured to orient the AMSV 200 in and move the AMSV 200 through the water, e.g., based on the control signals. Accordingly, the AMSV 200 may include a navigation system configured to orient the AMSV 200 (e.g., orient a direction of the AMSV 200), a thrust system configured to propel the AMSV 200 in/on/along the water, and one or more power sources to power the navigation system, the thrust system, and other components of the locomotion system 218 and the AMSV 200 itself. For example, the locomotion system 218 may be included in the AMSV 60 of FIG. 2A and may be implemented, for example, by at least portions of the navigation and thrust systems of the AMSV 60. As the locomotion system 218 is controlled via control signals generated by the AMSV control system 215, the AMSV 200 is able to operate autonomously, e.g., without receiving any real time control signals generated by humans. In some situations, the navigation system and the thrust systems may be independently controlled, and in some situations, the navigation system and the thrust systems may be controlled in a coordinated manner.

In some situations, the AMSV 200 may operate independently of any other AMSV to perform a mission (e.g., a military mission). That is, only one AMSV 200 may autonomously and independently operate to perform one or more tasks (or all tasks) of a mission with which the AMSV 200 has been charged, e.g., without communicating with any other AMSV 200 with respect to the mission tasks and/or at all.

### Example Group or Swarm of Autonomous Maritime Surface Vehicles (AMSVs)

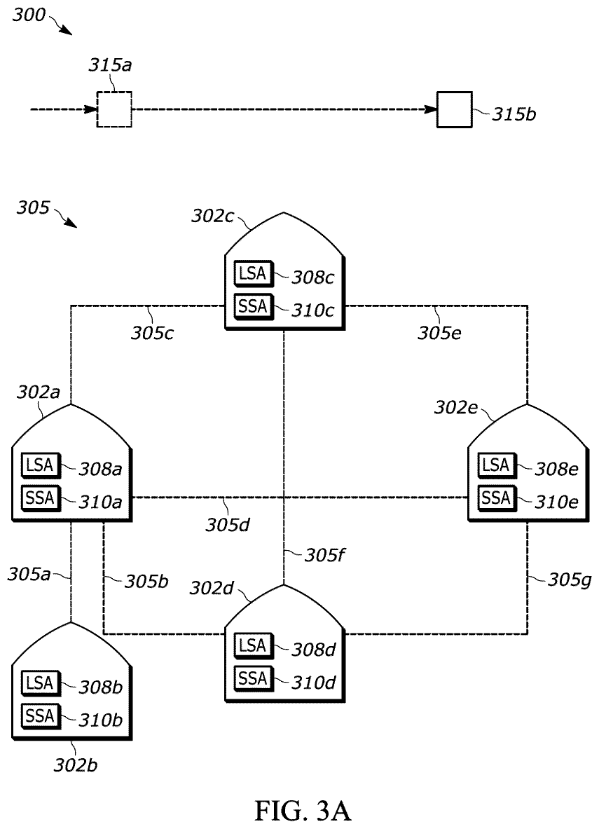

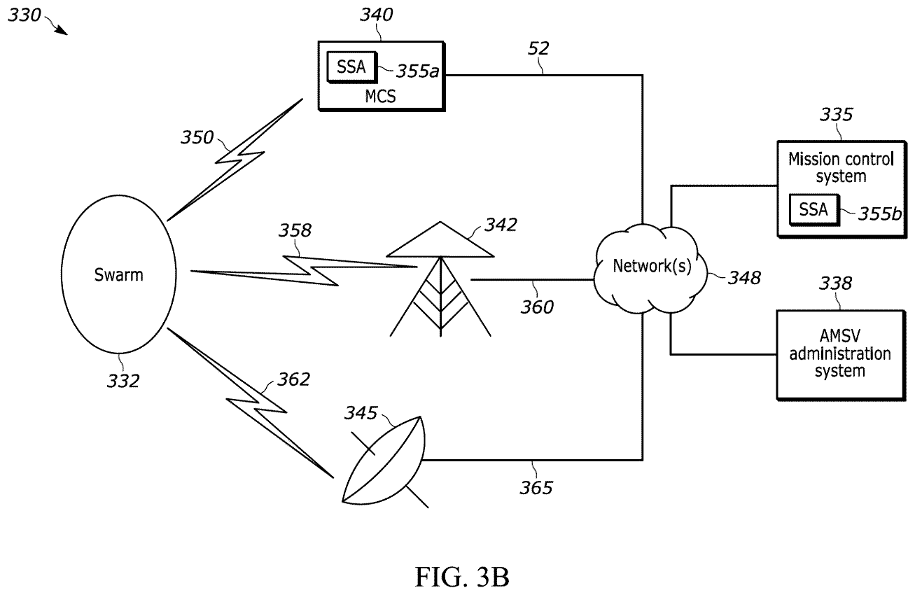

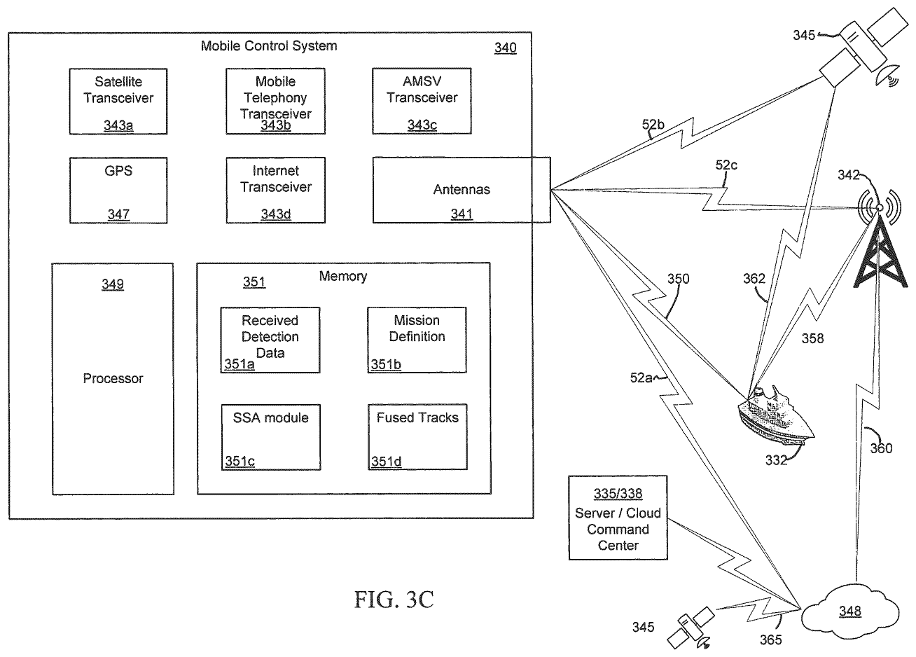

In some situations, though, the AMSV 200 may operate cooperatively with one or more other AMSVs to perform a mission. FIG. 3A depicts an example scenario of a group 300 of AMSVs 302a-302e, at a moment in time, which are cooperatively operating on a body of water to perform a mission. Each AMSV 302a-302e may be a different instance and/or embodiment of the AMSV 60 or of the AMSV 200, for example. As such, for ease of discussion and not for limitation purposes, the description of the scenario of the group 300 may simultaneously refer to the AMSV 60 of FIGS. 2A-2K and/or to the AMSV 200 of FIG. 2L. A group 300 of AMSVs which are charged with operating cooperatively to perform a mission (e.g., a military mission) is generally referred to herein as a “swarm 300” of AMSVs, as the group's movements and actions may be controlled (e.g., both controlled individually and controlled as a swarm or group as a whole) to perform the mission. Notably, in addition to each AMSV 302 of the swarm 300 operating autonomously, the control of the swarm 300 as a whole typically is also autonomous. That is, after obtaining a description of the mission with which the swarm 300 as a whole is charged with performing, and after being deployed and self-activating within the body of water, the swarm 300 controls the movements and behaviors of each AMSV 302 included in the swarm 300 as well as controls the movements and behaviors of the swarm 300 as a coordinated whole in accordance with the mission without utilizing or even requiring any further outside or external instructions from any other remotely located computing system such as mission control (except for, perhaps, an instruction to modify the overall mission itself). As the swarm 300 as a whole can operate autonomously, the electromagnetic energy generated by the swarm 300 is significantly decreased as the vehicles 302 of the swarm 300 no longer need to communicate with an external server or computing system (e.g., remotely located mission control) during the execution of the mission. At least for this reason the detectability of the swarm 300 by enemies is significantly reduced or decreased as compared with maritime vehicles or groups of maritime vehicles which need to actively communicate with external mission control (e.g., operating on a remote server or servers) to receive specific navigational and operation instructions during mission operations.

It is noted that although FIG. 3A depicts the swarm 300 as including five AMSVs 302a-302e, this is for illustrative purposes only and is not limited. Generally speaking, a swarm of AMSVs can include two or more AMSVs, as desired.

Upon each AMSV 302 being deployed into the body of water and self-activating (e.g., self-switching from stand-by mode to active mode), the swarm 300 of ASMVs 302 may communicatively and wirelessly connect with each other, e.g., as exemplarily designated by the dashed lines 305a-305f shown in FIG. 3A. That is, the dashed lines 305a-305g represent an example of the respective AMSV-to-AMSV wireless connections or wireless links among respective pairs of the ASMVs 302a-302e at a snapshot in time. In an embodiment, the wireless links 305a-305g collectively may be or form a wireless mesh network 305 servicing the swarm 300, where each AMSV 302 is a different node of the wireless mesh network 305. Further, since the AMSVs are mobile and moving in the water, the wireless mesh network 305 may be a dynamic wireless mesh network 305, as each AMSV or node 302, as it moves over time, may discover different neighbor nodes and establish respective wireless connections with the discovered nodes, and may terminate various wireless connections with the other ASMVs/nodes with which wireless connections have been lost or sufficiently compromised. Thus, in a sense, the dynamic wireless mesh network 305 communicatively connecting the swarm 300 of AMSVs 302 may be a dynamic self-configuring, and dynamically self-reconfiguring and/or dynamically self-healing wireless mesh network 305.

Each node or AMSV 302 included in the swarm 300 may establish a wireless connection with a neighboring node using any of its available off-board communication interfaces 220a-220n. In some situations, each node 302 may select from among its plurality of off-board communication interfaces 220a-220n to establish the wireless connection with the neighboring node. As the swarm 300 of AMSVs 302 typically operates for military missions and in the dynamically changing environment of a body of water (which may be noisy and may dynamically cause various dispersions, reflections, angle variances, etc.), each AMSV 302 may give preference to those wireless technologies and corresponding off-board communication interfaces 220a-220n which utilize AMSV-to-AMSV line-of-sight (LOS) connections (also referred to herein as “direct line-of-sight”), utilize low or no radio frequency (RF) power, and/or are operative over limited, short-ranges so that RF energy generated by each of the ASMVs 302 to perform intra-swarm transmissions is decreased, thereby rendering each AMSV 302 of the swarm 300 and the swarm 300 itself as a whole less detectable by enemies. Additionally or alternatively, each node 302 may select, from among its plurality of off-board communication interfaces 220a-220n, to establish the wireless connection with the neighboring node based on other criteria, such as hardware and/or bandwidth availability, link quality, and the like. For example, when the use of a preferred line-of-sight off-board communication interface 220b is rendered ineffective (e.g., due to something blocking the transmission of information, interference, failure of a component etc.), the node 302 may transfer off-board communications with other nodes 302 to another off-board communication interface 220c, 220d, etc. That is, the node 302 may “failover” communication link usage from one wireless technology to another. The selection of another off-board communication interface may be based on one or more criteria, such as fidelity or quality of wireless links, availability of bandwidth, amount of RF energy which would be generated, geospatial positions of the sending and receiving nodes, etc. Generally speaking, each node 302 may establish one or more wireless connections of different wireless technologies with another node 302; that is, a pair of nodes may be wirelessly connected via the wireless swarm mesh network 305 by using one or more wireless connections of one or more wireless technologies. Each node 302 may dynamically change the type of wireless technology via which it maintains connectivity to another node, e.g., as wireless connectivity conditions change. Further, not every inter-node wireless link 305a-305f within the mesh network 305 needs to utilize the same type of wireless technology.

In some situations, although the entirety of the nodes 302 of the swarm 300 may be communicatively connected with one another, not every node 302 has a direct wireless connection with every other node 302 of the swarm 300, and delivery of information between such pairs of nodes may utilize hops to and from intermediate nodes. For example, as illustrated in FIG. 3A, AMSV 302b is communicatively connected AMSV 302e via intermediate node 302a (e.g., by way of links 305a and 305d) and via the two intermediate nodes 302a and 302c (e.g., by way of links 305a, 305c, and 305e). As such, each node 302 of the swarm 300 may store, e.g., in local data storage 250, a respective routing table storing information indicative active/available connections to various other nodes 302 of the swarm 300, where the respective routing table at each node 302 is updated based on connection and/or communication statuses provided by the other nodes 302. Generally, each node or vehicle 302 of the swarm multicasts its own current geospatial position (either in an absolute manner or with respect to another reference location, such as another AMSV 302, and/or with respect to a previous geospatial position of the multicasting node) to neighboring nodes 302 with which the each node or vehicle has at least one active wireless communication link, and the neighboring nodes 302 may store (e.g., in respective local storage 250) an indication of the geospatial position of the multicasting node, e.g., in respective routing tables. Additionally or alternatively, the multicasting node may further multicast indications of geospatial positions of neighboring nodes with which it has wireless connectivity. Further, each node or vehicle 302 of the swarm may multicast an indication of its own connection or communication status within the wireless mesh network 305 and/or indications of the respective connection or communication statuses of other nodes of the swarm for which the multicasting node has knowledge (e.g., as stored in its respective local data storage 250 or routing tables). When desired or as needed, the contents of the respective routing tables and/or other data stored at each node 302 can be shared and/or synchronized across the swarm 300.

For security purposes, each node 302 may authenticate and/or authorize a neighboring node prior to establishing a respective wireless connection or link with the neighboring node via which content, information, or data (e.g., payload) is to be transmitted. In some implementations, at least some of the wireless connections 305a-305f may be implemented via respective node-to-node virtual private networks (VPNs). Additionally or alternatively, the entirety of the wireless mesh network 305 supporting the swarm 300 (e.g., the swarm-specific wireless mesh network 305) may be implemented as a swarm-level VPN.

Further, each node 302 may be configured to transmit a signal to one or more other nodes in a point-to-point manner and/or in a point-to-multipoint manner. Each node 302 may select whether to send a signal to one or more other nodes via point-to-point or via point-to-multipoint based on the type of payload of the signal, the protocol utilized for transmitting the signal, the proximity of each receiving node, an identity of each receiving node, the bandwidth and/or other availability and/or performance characteristics of the wireless links, and/or other criteria.

Additionally or alternatively, each node 302 may be configured to transmit some signals to other nodes 302 by using a connection-oriented protocol (which typically requires the verification of the delivery of messages and data, such as Transmission Control Protocol or TCP), and each node 302 may be configured to transmit some signals to other nodes 302 by using a message-oriented protocol (which typically excludes the verification of the delivery of messages and data, such as User Data Protocol or UDP, e.g., multitask UDP for publications and subscriptions). Each node 302 may determine or select whether to transmit a particular payload via a connection-oriented protocol or via a message-oriented protocol based on, for example, the type of data included in the particular payload of a message and optionally other criteria such as available links and/or network bandwidth, the identity of a receiving node, priority of the payload, number of hops, etc. For example, each node 302 may utilize the message-oriented protocol to transmit an indication of its current geospatial location and current heading, its current operational status, its current communication status, its current battery status, and the like (and any such similar information of other nodes for which the each node 302 has knowledge, e.g., as stored in its local data storage 250), and each node 302 may utilize the connection-oriented protocol to transmit command messages, control messages, other types of tasking information, and/or any information which may require the use of at least one external network (such as the Internet, other public networks, and/or other private networks) for the delivery of the information to its recipient(s). Importantly, each node 302 may utilize the message-oriented protocol to transmit indications of its sensed data (e.g., data generated at the node based on the sensing performed by the node's on-board passive remote sensing system, which may include snap shots/timeseries data and/or livestream data), as is described in more detail elsewhere herein, and each node 302 may utilize the connection-oriented protocol to transmit control messages related to coordinated swarm movements and actions. Advantageously, the use of both connection-oriented and message-oriented protocols within the wireless mesh network 305 may aid in managing the overall transmissions of the swarm 300 so that bandwidth usage of the network 305 and individual power consumption at each node 302 is minimized while the fidelity and/or accuracy of different types of payload and/or content delivered over the network 305 is maximized.

As shown in FIG. 3A, each AMSV 302a-302e may include a respective LSA module 308a-308e and a respective SSA module 310a-310e. For example, each LSA module 308a-308e may be a different instance of the LSA module 232 of FIG. 2L, and each SSA module 310a-310e may be a different instance of the SSA module 235 of FIG. 2L. As previously discussed, during operations, each of the LSA modules 308 may operate to generate and update local tracks of objects whose presences have been detected by the passive remote sensing system on board the respective AMSV 302 in which the LSA module is included 308, such as by utilizing techniques such as those described elsewhere herein. In embodiments, each AMSV 302a-302e may also transmit detection data to each other of the AMSVs 302a-302e, such that each AMSV in the swarm is generally aware of the detections of the others. Each AMSV may utilize its respective LSA module 308a-308e to generate tracks for the detected objects and for each of the other AMSVs 302a-302e, for local use on the respective AMSV. Because the detections and other transmitted data sent from each AMSV to each of the other AMSVs may, in embodiments, be transmitted via fallible links (e.g., may not use a guaranteed connection in which data are verified as received and, as a result, some data may be lost or incorrectly received), some data shared between the AMSVs may not be received or received correctly by all of the other AMSVs and, therefore, the tracks determined by the respective LSA modules 308a-308e may differ. By contrast, data sent to the active SSA module is sent using a protocol that guarantees receipt, as is data sent from the active SSA module to the AMSVs. As a result, the fused tracks generated by the active SSA module are accurate, as are the fused tracks received from the active SSA module at each of the AMSVs.

Further, although each AMSV 302 of the swarm 300 is illustrated as including a respective on-board SSA module 310, only one of the SSA modules 310 (e.g., SSA module 310c, as denoted by the bolded box) is an active SSA module servicing the swarm 300, while the remainder of the SSA modules 310a, 310b, 310d, and 310e remain in stand-by mode. Typically, during operations, a swarm of AMSVs has, at any given time, only a single SSA module which is in an active state and which performs swarm-level tracking and swarm-level control (e.g., for group and/or coordinated maneuvers) for the group of AMSVs included in the swarm, and the remainder of the inactive or standby SSA modules of the swarm may serve as digital twins, hot spares, or back-ups for the active SSA module. As such, should the active SSA module become disabled or otherwise be unable to serve as the activated SSA module, the swarm 300 of AMSVs may automatically and cooperatively designate another SSA module within the swarm 300 (which may be on another AMSV 302, for example) to serve as the active SSA module of the swarm 300.

Generally speaking, an active SSA module of a swarm (e.g., active SSA module 310c of the swarm 300) operates to control observations, behaviors, and/or operations of the swarm 300, e.g., to perform the mission with which the swarm 300 has been assigned. As such, the active SSA module 310c on-board AMSV 302c may receive, via the wireless mesh network 305, node-specific status information from one or more other nodes 302a, 302b, 302d, and/or 302e. The node-specific status information may include data indicative of a node's current geospatial location, current operational status, and/or current statuses of other types of node-specific resources, such as the node's communication status(es), battery life, processing power, etc. Node-specific status information may be received by the active SSA module 310c on-board the AMSV 302c directly from another node whose status(es) are indicated (e.g., via a direct wireless connection) or via one or more intermediate nodes disposed, within the wireless mesh network 305, between the node whose status(es) are indicated and the AMSV 302c. Received node-specific status information may be stored (e.g., at on-board storage 250 of the ASMV 302c) and utilized by the active SSA module 310c to keep track of where each of the AMSVs 302 of the swarm 300 is located (e.g., with respect to other AMSVs 302 of the swarm 300) and the respective capabilities of each of the ASMVs 302 to perform various roles within the mission. Stored node-specific status information may be updated as updates to node-specific statuses are received from other nodes.

In addition to receiving node-specific status information of other nodes 302 of the swarm 300, the active SSA module 310c may also receive node-specific local tracking information. That is, the active SSA module 310c may receive (e.g., via direct wireless connections and/or via intermediate nodes over the wireless mesh network 305) information indicative of local respective tracks of objects that each of one or more other nodes 302a, 302b, 302d, 302e has locally sensed and generated, and any updates thereto. Additionally, the active SSA module 310c may receive local tracks of objects generated by its corresponding LSA module 308c on-board the AMSV 302c and any updates thereto. As previously discussed, local tracks of sensed objects may be generated by respective LSAs 308, and may include indications of the paths of the sensed objects over time. Indications of the local tracks of the sensed objects may be transmitted, by the nodes 302 which generated the local tracks, to the node 302c on which the active SSA module 310c is executing. The active SSA module 310c may combine or fuse the received local tracks of sensed objects, and thereby generate respective swarm-level tracks of the sensed objects. As each local track for a particular object may vary at least due to the relative position and/or orientation (e.g., relative to the particular object) of the respective AMSV which generates each local track, the swarm-level track may be a more accurate track than at least some (or in some cases, all) of the local tracks from the swarm-level track was generated by the active SSA module 310c. Of course, swarm-level tracks may be updated, by the active SSA module 310c, based on any updated local track information received by the active SSA module 310c.

To illustrate, at the moment in time depicted in the example scenario of FIG. 3A, AMSV 302c is the specific vehicle within the swarm 300 on which the active SSA module 310c of the swarm 300 is located. The swarm 300 is tracking object 315 as it has been moving from a previous location 315a to a present location 315b, e.g., as depicted by the dotted travel path of object 315. Object 315 may be any object-of-interest, such as another maritime vehicle that is not included in the swarm 300 (which may be an enemy or friendly maritime vehicle), or some other remote maritime or land-based object. Although FIG. 3A depicts object 315 as being a moving object, in some situations the swarm 300 may track a stationary object. The LSA 308a of AMSV 302a generates a local track “LT-a” of the object 315, e.g., by utilizing data generated by its on-board passive remote sensing system 212, and in similar manners the LSA 308b of AMSV 302b generates a local track “LT-b” of the object 315, the LSA 308c of AMSV 302c generates a local track “LT-c” of the object 315, and the LSA 308e of AMSV 302e generates a local track “LT-e” of the object 315, e.g., each based on respective, passively-sensed or detected data. As AMSV 302d is blocked by AMSV 302c from passively sensing or detecting the presence of object 315 in its FOV, the AMSV 302d does not generate a local track for object 315 at the moment in time depicted in the scenario (although, as each of the AMSVs 302a-302e and the object 315 has moved over time, AMSV 302d may previously have generated a local track for object 315, which can be then updated after the moment in time when object 315 again moves into the FOV of the AMSV 302d).

FIG. 3B depicts an example environment 330 in which a group or swarm 332 of AMSVs may operate to perform a mission. Generally, the swarm 332 may include two or more AMSVs (such as the AMSV 60, the AMSV 200, the AMSVs 302, and/or other AMSVs) which have been charged as a group 332 (e.g., by mission control) to perform a mission, such as a military mission. For ease of illustration, the two or more AMSVs included in the swarm 332 are not explicitly depicted in FIG. 3B. The swarm 332 may be, for example, the swarm 300 of FIG. 3A, or the swarm 332 may be another swarm of AMSVs. The AMSVs included in the swarm 332 may be communicatively connected with each other via a wireless mesh network of the swarm 332 (also not explicitly shown in FIG. 3B), where the wireless mesh network of the swarm 332 may utilize any one or more of the principles and techniques described with respect to the swarm wireless mesh network 305 of FIG. 3A, for example. For ease of illustration, and not for limitation purposes, the environment 330 of FIG. 3B is described herein with simultaneous reference to FIGS. 2A-2L and 3A.

With reference to FIG. 3B and FIG. 3C, the swarm 332 (e.g., one or more AMSVs included in the swarm 332) may communicatively connect to a mission control system 335 and to a AMSV administration system 338. Typically, the mission control system 335 and the AMSV administration system 338 are located remotely with respect to the swarm 332 and may be implemented on one or more remote computing platforms, such as physical server and/or data storage systems, virtual server and/or data storage systems, cloud-based server and/or data storage systems, and/or the like. Further, the mission control system 335 may or may not be implemented on or located at the same remote computing platform(s) on or at which the AMSV administration system 338 is implemented or located. At any rate, the computing platforms, server systems, and/or data storage systems on which the mission control system 335 and the AMSV administration system 338 are respectively implemented may include one or more public and/or private computing platforms, server systems, and/or data storage systems; however, generally, at least portions of the mission control system 335 and at least portions of the AMSV administration system 338 may be secured and/or require secured access. Permissions, security, and access to the mission control system 335 may be different from or the same as the permissions, security, and access to the AMSV administration system 338.

Generally speaking, the mission control system 335 provides, instructs, or charges the swarm 332 with its mission (e.g., “patrol the coastline of this designated area,” “find and locate an enemy watercraft of which mission control has been informed,” “perform sub-mission A of the overall mission while another swarm performs sub-mission B of the overall mission, and move to the area of the other swarm upon completion of sub-mission A” etc.). In some situations, mission control system 335 may provide updates, modifications, and/or other changes to the overall or high-level mission, e.g., while the swarm 332 is operating to perform the mission. The AMSV administrative system 338 generally operates to administer and maintain the AMSVs of the swarm 332 and various components of the AMSVs, which may include configuring hardware, firmware, and software of the AMSVs; remotely testing and/or running diagnostics on AMSV hardware, firmware, and/or software; providing updates and fixes to AMSV software and/or firmware; receiving, logging, and historizing (e.g., in long-term data storage) data generated by the swarm 332; and the like. In some scenarios, the mission control system 335 and the AMSV administrative system 338 may operate in conjunction with one another. For example, the swarm 332 may establish a connection with the AMSV administrative system 338, upload operational and locally-generated diagnostics status data to the AMSV administrative system 338, and tear down the connection after upload has completed. Subsequently, the AMSV administrative system 338 may analyze the uploaded data and, based on results of its analysis, may notify the mission control system 335 of any information which may affect the mission. The mission control system 335 may generate, based on the notification, a modification to the mission, and may transmit, to the swarm 332 and/or to an active Swarm Situational Awareness (SSA) module of the swarm 332, information indicative of the modification via a temporal connection which is torn down after the modification information has been transmitted to the swarm 332.

Typically, the communicative connection(s) between AMSVs of the swarm 332 and the mission control system 335 are temporal in nature, and the communicative connection(s) between AMSVs of the swarm 332 and the AMSV administration system 338 are temporal in nature, e.g., to minimize radiated energy generated by the swarm 332 for performing remote communications, and thereby decrease the chances of the swarm 332 from being detected. In situations in which one or more of the AMSVs of the swarm 332 do send and/or receive information to and/or from mission control 335 and/or the AMSV administration system 338, though, one or more of the AMSVs of the swarm 332 may communicatively connect to the mission control system 335 and/or to the AMSV administration system 338 the via one or more access points 340, 342, 345, where each of the access points 340, 342, 345 may be communicatively connected to the mission control system 335 and to the AMSV administrative system 338 via one or more data and/or communication networks 348. Data and/or communication networks 348 may include one or more wired and/or wireless networks, one or more public networks (e.g., the Internet), one or more private networks, one or more physical and/or virtual networks, one or more cloud-based networks, etc. The communicative connections between the swarm 332, the one or more access points 340, 342, 345, the mission control system 335, and the AMSV administrative system 338 may be secured as required (e.g., by utilizing one or more virtual private networks (VPNs), encryption, authorization and access permissions, and/or any one or more suitable security techniques).

As shown in FIG. 3B, access point 340 is a Mobile Control System (MCS) corresponding to the swarm 332. Generally speaking, an MCS 340 may be a physical unit or system which includes hardware (e.g., antennas 341, transceivers 343a-343d, GPS hardware 347, ports, wired interfaces, wireless interfaces, processors 349, memories 351, etc.), firmware, and software (e.g., computer-executable instructions stored on the memories and executable by the processors). The memory 351 of the MCS 340 may store received detection data 351a, mission definition data 351b, the SSA module 351c, fused track data 351d, in addition to other data. The received detection data 351a may include the detections received from each of the AMSVs of the swarm 332, which may be used by the routine defined by the SSA module 351c to created the fused tracks 351d. The SSA module 351c may use the fused tracks 351d to determine commands and/or actions to send to the swarm 332 (e.g., with the fused track data 351d) according to the mission definition 351b.

In any event, the MCS 340 may be physically disposed on land or on a maritime vehicle other than an AMSV, such as on a larger vessel or carrier. When utilizing the MCS 340 as an access point to communicate with the mission control system 335 and/or the AMSV administration system 338, one or more of the AMSVs of the swarm 332 may establish respective suitable, direct wireless (e.g., line-of-sight) communicative connections 350 with the MCS 340. The direct, communicative connections 350 between the MCS 340 and one or more AMSVs of the swarm 332 may utilize any type of suitable wireless technology, such as Wi-Fi, mobile communications and/or mobile data technologies and/or protocols, optical and/or infrared technologies, private wireless protocols, etc. For example, each AMSV may communicatively connect to the MCS 340 using one of its off-board communication interfaces 220, such as interface 220b, 220d, or 220n, for example. Additionally, the MCS 340 may include one or more wired and/or wireless interfaces via which the MCS 340 can communicatively connect 352 with mission control 335 and/or the AMSV administration system 338, e.g. via networks 348. When the MCS 340 is no longer able to maintain a communicative connection 350 of sufficient quality or fidelity with any AMSV of the swarm 332, the swarm 332 may utilize an access point other than the MCS 340 to communicate with the mission control server 335 and the AMSV administration server 338, such as the access point 342 or the access point 345 or a combination of devices. That is, as should be understood, each of the MCS 340, the AMSV(s) in the swarm 332, and the access points 345, 342, whether satellite access points, mobile telephony (e.g., 3G, 4G, LTE, 5G, etc.) access points, or wired or wireless Internet connections, may communicate in any combination to facilitate communication with each other and/or with the mission control system 335 and/or the AMSV administration system, directly or through one or more other of these devices.

In addition to serving as an access point, the MCS 340 may additionally or alternatively provide swarm-level control for the swarm 332. As such, the MCS 340 may include its own instance 355a of a Swarm Situational Awareness (SSA) module 355, which may be similar to the SSAs 235, 308, and which is activated to service the swarm 332, e.g., in manners such as previously discussed. (It is noted that, although not depicted in FIG. 3B, respective inactive instances of the SSA 355 may also be included in each of the AMSVs of the swarm 332 serviced by the MCS 340, e.g., in manners such as previously discussed.)

The SSA 355a at the MCS 340 may be the active SSA instance 355 which services the swarm 332, e.g., as long as at least one of the AMSVs of the swarm 332 is able to maintain a suitable, communicative connection 350 with the MCS 340 (e.g., directly via line-of-sight, or through one or more intermediary connections such as satellite, mobile telephony, and/or internet connections). During operations, via the active SSA module 355a, the MCS 340 may perform functions that support the movements of the AMSVs of the swarm 332, such as but not limited to fusing local detections and/or local tracks of detected objects of interest (and of the AMSVs themselves) provided by the swarm 332 to the SSA module 225a into fused tracks and providing the fused tracks and/or other local detections (or indications thereof) to various AMSVs of the swarm 332. Further, during operations, the active SSA module 355a may enable the delivery of data and information between the swarm 332 and the mission control system 335 and/or the AMSV administration system 338, e.g., by forwarding data generated and/or sensed by the swarm 332 and/or by the active SSA module 355a to the mission control system 358 and/or to the AMSV administration system 338, and/or by forwarding mission and/or administrative instructions and/or other information from the mission control system 348 and/or from the AMSV administration system 338 to one or more AMSVs of the swarm 332. Still further, during operations, the active SSA module 355a may autonomously generate and send local (e.g., MCS-based) instructions to one or more AMSVs of the swarm 332, where the instructions may be generated and sent by the active SSA module 355a based on data and/or information received from AMSVs of the swarm 332, based on information and/or instructions received from mission control 335, and/or based on information and/or instructions received from AMSV administration 338. For example, the active SSA module 355a may generate and send respective mid-level or swarm-level mission control instructions to different AMSVs of the swarm 332 responsive to conditions detected by other AMSVs of the swarm 332 and/or changes in the mission which are transmitted from the mission control system 335 to the active SSA module 355a of the swarm 332.

When the MCS 340 is no longer able to maintain a communicative connection 350 of sufficient quality or fidelity with any AMSV of the swarm 332, or when no MCS 340 is implemented, an instance of the SSA 355 on-board one of the AMSVs of the swarm 332 may be activated to provide the functionalities which were previously provided to the swarm 332 by the SSA 355a at the MCS 340, and the SSA 355a may be inactivated. Alternatively, another instance of the SSA 355b disposed at a remote system (e.g., at the mission control system 335 as shown in FIG. 3B, or on some other remote computing platform) may be activated to provide, to the swarm 332, the functionalities which were previously provided to the swarm 332 by the SSA 355a of the MCS 340.

Turning now to access point 342, access point 342 is depicted as being a mobile technology or mobile telephony (MT) base station, which is interchangeably referred to herein as “mobile communications base station” and “base station.” Base station 342 may be physically located on land and/or on another maritime vehicle (such as a carrier), and may utilize any one or more communication technologies and protocols which are typically implemented by land-based cellular and mobile communication systems (such as LTE, 4G, 5G, PCS, and/or any other typically land-based mobile communication technologies, both current and envisioned) to communicate 358 with one or more AMSVs included in the swarm 332, with the MCS 340, etc. Such communicative connections 358 are typically, but not necessarily, direct, wireless (e.g., line-of-sight) connections between one or more of the AMSVs of the swarm and the base station 342, but may also serve as intermediary communication connections between, for example, the MCS 350 and the mission control system 335 or the AMSV administration system 338. Additionally, base station 342 may support one or more communicative connections 360 to the networks 348 (e.g., via a mobile communications system gateway, and/or via other suitable means). Unlike the MCS 340, typically the base station 342 does not include an on-board SSA 355 instance and therefore the base station 342 typically does not perform any swarm-level control or AMSV administrative functions. Rather, the base station 342 may primarily serve as an access point via which the swarm 332 may communicate with the mission control system 358 and with the AMSV administration system 338. Further, when the base station 342 is no longer able to maintain a communicative connection 358 of sufficient quality or fidelity with any AMSV of the swarm 332, the swarm 332 may utilize an access point other than the base station 342 to communicate with the mission control server 335 and the AMSV administration server 338, such as the access point 340 or the access point 345.

Access point 345 is depicted in FIG. 3B as being a satellite. Satellite 345 may be disposed in Earth orbit, and may utilize any one or more satellite communication technologies and protocols to communicate 362 with one or more AMSVs included in the swarm 332. Such communicative connections 362 are typically, but not necessarily, direct, wireless (e.g., line-of-sight) connections between one or more of the AMSVs of the swarm and the base station 342. Additionally, satellite 345 may support one or more communicative connections 365 to the networks 348 (e.g., via a ground or earth station and a gateway of a satellite communications system, and/or via other suitable means) and/or to the MCS 340. Similar to the base station 342, typically the satellite 345 does not include an on-board SSA 355 instance and therefore the satellite 345 typically does not perform any swarm-level control or administrative functions. Rather, the satellite 345 may primarily serve as an access point via which the swarm 332 or MCS 340 may communicate with the mission control system 358 and with the AMSV administration system 338. Further, when the satellite 345 is no longer able to maintain a communicative connection 362 of sufficient quality or fidelity with any AMSV of the swarm 332, the swarm 332 may utilize an access point other than the satellite 345 to communicate with the mission control server 335 and the AMSV administration server 338, such as the access point 340 or the access point 342.

In some situations, transmissions between an AMSV of the swarm 332 (and/or of an active SSA module 225 of the swarm 332) and the mission control system 335 and/or AMSV administrative system 338 (e.g., via any of the access points 340, 342, 345) may utilize a connection-oriented protocol which typically requires the verification of the delivery of messages and data, such as Transmission Control Protocol (TCP). Examples of use cases which may utilize connection-oriented protocols such as TCP include command and control message, tasking information, and the like. Of course, in some situations, communications between an AMSV of the swarm 332 (and/or of an active SSA module 355 of the swarm 332) and the mission control system 335 and/or AMSV administrative system 338 may utilize a message-oriented protocol such as User Data Protocol (UDP) or multitask UDP. Examples of use cases which may utilize message-oriented protocols include live streaming, geospatial positions, speeds, headings, status information, and/or other information which is suitable for sending via publish/subscribe techniques. As such, the transmissions between the AMSVs included in the swarm 332 and other components 335, 338, 340, 342, 345 may utilize multipath connection-oriented and multi-path message-oriented protocols over variable/varying links, e.g., within the wireless mesh network of the swarm (not shown explicitly in FIG. 3B), via links between the swarm 332 and one or more of the access points 340, 342, 345, and via links or communicative connections between the access points 340, 342, 345 and the remote systems 335, 338 via the networks 348.

### Example Communication Architecture for Autonomous Maritime Surface Vehicles (AMSVs)

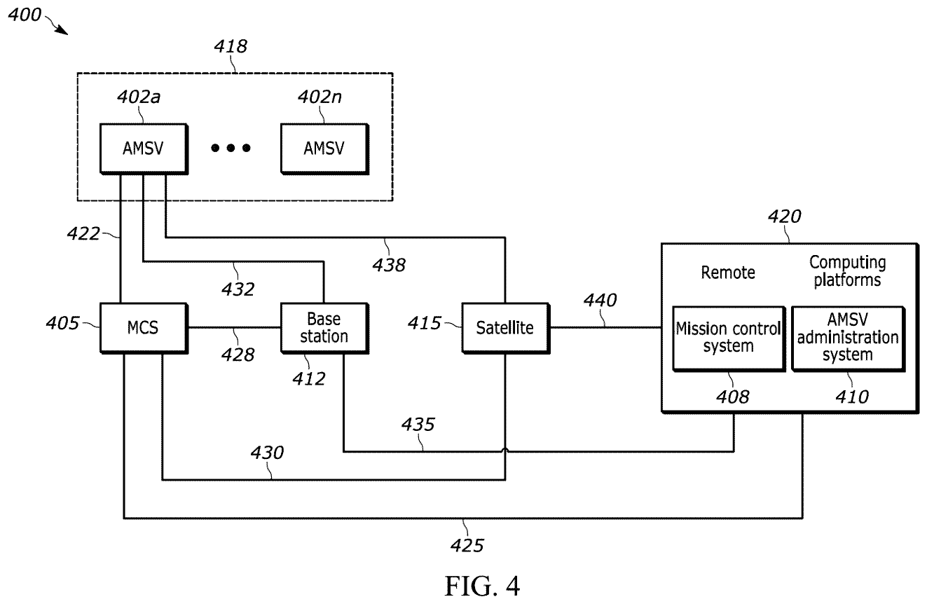

FIG. 4 depicts a block diagram of an example communication architecture 400 supporting communications between components of mission systems in which AMSVs are included. The communication architecture 400 may support, for example, any one or more of the example scenarios described in FIGS. 1A-1C, the AMSVs of FIGS. 2A-2L, the swarm of AMSVs illustrated in FIGS. 3A and 3B, as well as other mission systems which include at least one AMSV. Generally speaking, a “mission system,” as utilized herein, refers to a system that includes a mission control system to provide mission instructions and at least one AMSV which performs tasks associated with the mission. For example, the example environment 330 of FIG. 3B illustrates a mission system having components including the mission control system 335 and the AMSVs of the swarm 332, as well as other components such as the MCS 340 and the AMSV administration system 338. For ease of illustration, and not for limitation purposes, the communication architecture 400 is described below in conjunction with FIGS. 1A-1C, 2A-2L, and 3A-3B.

The communication architecture 400 illustrates communicative connections which may support and may be utilized for communications between different types of components of a mission system, where the components of a mission system may include one or more AMSVs 402, one or more MCSs 405, a mission control system 408, an AMSV administration system 410, etc. It is noted that all mission systems supported by the communication architecture 400 need not include all types of the components 402, 405, 408, 410 illustrated in FIG. 4. For example, while mission systems typically include at least one AMSV 402 and a mission control system 408, a mission system need not include an MCS 405 and/or an AMSV administration system 410. In some mission systems, the mission control system 408 and the AMSV administration system 410 may be implemented on one or more remote computing platforms 420 which are accessible via one or more networks, e.g., in manners such as previously discussed. For example, in some implementations, the mission control system 408 may be the mission control system 335, and/or the AMSV administration system 410 may be the AMSV administration system 338. It is also noted that while FIG. 4 illustrates different types of access points 405, 412, 415 which may be utilized by the AMSV(s) 402 to communicate with mission control system 408, not all mission systems may include or utilize one or more of such types of access points 405, 412, 415. Additionally, as illustrated in FIG. 4, when mission systems include multiple AMSVs, the multiple AMSVs may operate and be controlled as a swarm 418 of AMSVs.

Turning first to the AMSVs 402, in the communication architecture 400, an AMSV 402a may be able to communicatively connect with one or more other AMSVs 402n in its swarm 418 (not shown in FIG. 4) via an ad-hoc wireless mesh network, such as the wireless mesh network 305. Each AMSV 402a-402n (whether operating individually or as a part of a swarm 418) may be able to communicatively connect with an MCS 405 via a respective communicative connection 422 such as the communicative connection 350 of FIG. 3B. Although all AMSVs 402 of a swarm 418 of AMSVs may have the ability to communicatively connect 422 with the MCS 405, in some situations, only some (or only one) AMSVs of a swarm 418 may establish, on behalf of the swarm 418, respective active communication connections 422 with an MCS 405, such as depicted in the scenario of FIG. 1A. Within the communication architecture 400, an MCS 405 may communicatively connect with the mission control system 408 and/or the AMSV administration system 410 via a communicative connection 425, which may be similar to the communicative connection 352 of FIG. 3B. Additionally or alternatively, the MCS 405 may communicatively connect to one or more of the remote systems 408, 410 via a communicative connection 428 with a base station 412 and/or via a communicative connection 430 with a satellite. In these configurations, the MCS 405 may include transceivers, antennas, and other wireless interface components configured to communicate with the base station 412 and/or the satellite 415 by utilizing respective wireless technologies which are native to the base station 412 and the satellite 415. For example, the communicative connection 428 may utilize any one or more communication technologies and protocols which are typically implemented by land-based cellular and mobile communication systems (such as LTE, 4G, 5G, PCS, and/or any other typically land-based mobile communication technologies, both current and envisioned), and the communicative connection 430 may utilize any satellite communications technology.

Additionally in the communication architecture 400, each AMSV 402a-402n (whether operating individually or as a part of a swarm 418) may be able to communicatively connect, via a respective communicative connection 432, with a base station 412 as an access point to the mission control system 408 and/or to the AMSV administration system 410. The communicative connection 432 may be similar to the communicative connection 358 of FIG. 3B, for example. Although all AMSVs 402 of a swarm 418 of AMSVs may have the ability to communicatively connect 432 with the base station 412, in some situations, only some (or only one) AMSVs of a swarm 418 may establish, on behalf of the swarm 418, respective active communication connections 432 with a base station 412. Within the communication architecture 400, a base station 412 may communicatively connect with the mission control system 408 and/or the AMSV administration system 410 via a communicative connection 435, which may be similar to the communicative connection 360 of FIG. 3B.

Also in the communication architecture 400, each AMSV 402a-402n (whether operating individually or as a part of a swarm 418) may be able to communicatively connect, via a respective communicative connection 438, with a satellite 415 as an access point to the mission control system 408 and/or to the AMSV administration system 410. The communicative connection 438 may be similar to the communicative connection 362 of FIG. 3B, for example. Although all AMSVs 402 of a swarm 418 of AMSVs may have the ability to communicatively connect 438 with the satellite 415, in some situations, only some (or only one) AMSVs of a swarm 418 may establish, on behalf of the swarm 418, respective active communication connections 438 with a satellite 415. Within the communication architecture 400, a satellite 415 may communicatively connect with the mission control system 408 and/or the AMSV administration system 410 via a communicative connection 440, which may be similar to the communicative connection 365 of FIG. 3B.

Each of the communicative connections 422-440 of the communication architecture 400 as well as the ad-hoc wireless mesh network communicatively connecting the AMSVs 402 of a swarm 418 may be able to support both connection-oriented protocols (which typically require the verification of the delivery of messages and data, e.g., Transmission Control Protocol (TCP)) and message-oriented protocols (which typically do not require the verification of the delivery of messages and data, e.g., UDP or multitask UDP), e.g., in manners such as previously discussed. As such, the communication architecture 400 may support multipath connection-oriented and multi-path message-oriented protocols over variable/varied downlinks to allow delivery of messages, data, instructions, and/or other information between components 402, 405, 408, 410 of a mission system in which at least one AMSV 402 is included.

Further, each of the communicative connections 422-440 of the communication architecture 400 as well as the ad-hoc wireless mesh network communicatively connecting the AMSVs 402 of a swarm 418 may be implemented using other data communication architectural techniques, such as chained and/or nested Virtual Private Networks (VPN), chained and/or nested IP tunnels, etc. Such techniques may be applied at an overall architectural level (e.g., between applications executing at AMSVs and applications executing at the remote systems 408, 410) and/or may be applied on a per-link and/or per-multiple sequential link basis, as desired.

### Example Perception Hardware Configurations

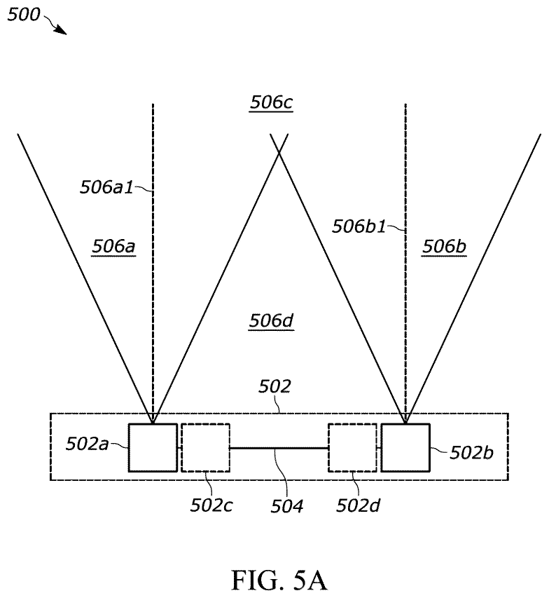

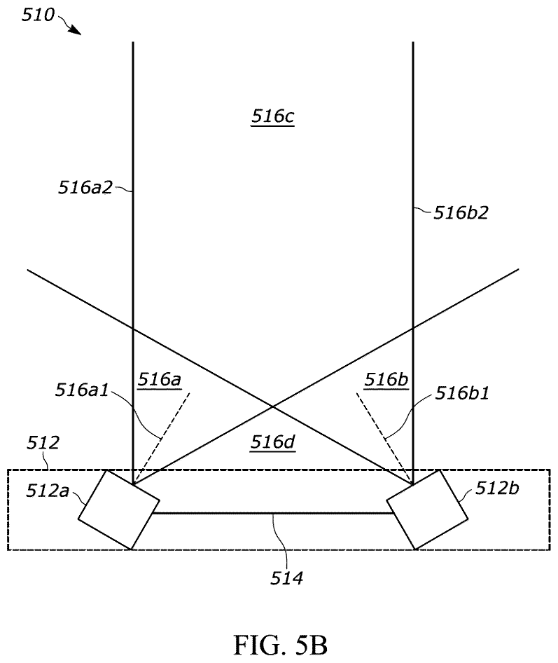

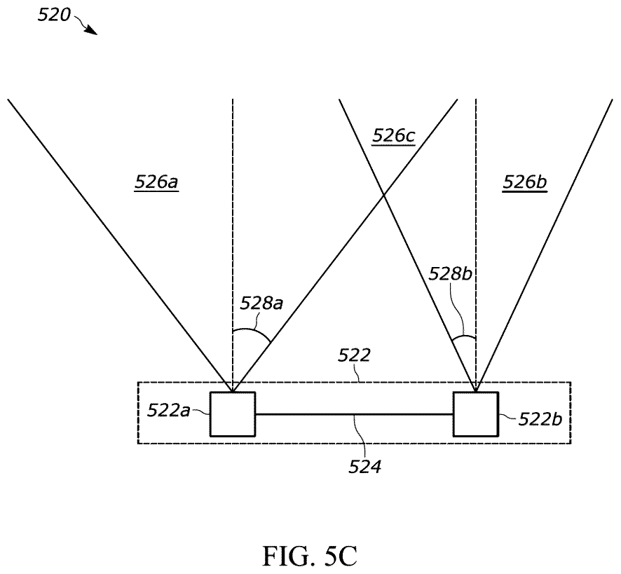

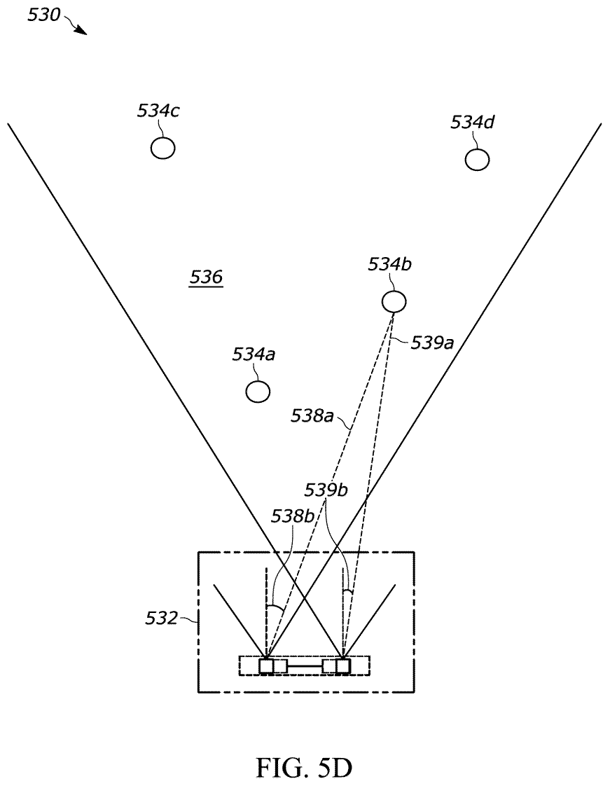

FIG. 5A depicts a first example perception hardware configuration 500, in accordance with various embodiments described herein. Generally, the first example perception hardware configuration 500 includes two stereovision cameras 502 configured to capture radiation from an external environment of the AMSV (e.g., AMSV 200), upon which, the first example perception hardware configuration 500 is mounted, integrated, and/or otherwise associated. In particular, the two stereovision cameras 502 are each configured to capture radiation using two image sensors 502a/b, 502c/d separated by a baseline distance 504 that mimics human binocular vision and thereby enables depth perception based on the feature disparities within the captured images. It should be appreciated that the image sensors 502c and 502d are separated by a shorter baseline distance than the image sensors 502a, and 502b. For example, the baseline distance 504 represents the distance between the image sensors 502c, 502d, and the image sensors 502a, 502b are separated by the baseline distance 504 in combination with some additional distance (e.g., including the dimensions of the image sensors 502c, 502d).

The two stereovision cameras 502 includes an IR stereovision camera comprised of a first IR image sensor 502a and a second IR image sensor 502b and an EO stereovision camera comprised of a first EO image sensor 502c and a second EO image sensor 502d. At least the IR stereovision camera passively captures (e.g., does not include/use an emission source) radiation, but it should be appreciated that any of the perception systems described herein may utilize passive sensing and/or active sensing. Moreover, while the discussion herein focuses primarily on the IR stereovision camera, the descriptions of the IR stereovision camera and corresponding IR image sensors may apply to the EO stereovision cameras, EO image sensors, and/or other sensing systems described herein.

As illustrated in FIG. 5A, the first IR image sensor 502a and the second IR image sensor 502b have FOVs 506a, 506b, represented by the lines extending diagonally outwards from the first and second IR image sensors 502a, 502b. Both IR image sensor FOVs 506a, 506b have an optical axis 506a1, 506b1 that correspond to the principal point of the FOVs 506a, 506b at any distance from the image sensors 502a, 502b. Thus, any object located in the AMSV external environment in-line with either optical axis 506a1, 506b1 will appear at the principal point of the resulting image created by the respective image sensor(s) 502a, 502b.

These two FOVs 506a, 506b intersect/overlap at a particular distance away from the image sensors 502a, 502b, creating a composite FOV 506c and a blind spot 506d. The composite FOV 506c represents a physical region of the AMSV external environment, from which, both image sensors 502a, 502b capture radiation, and consequently capture representations of the same objects/features within the AMSV external environment. However, because the composite FOV 506c includes different portions of the individual image sensor 502a, 502b FOVs 506a, 506b, the same object/feature representations in the images are included at different positions within the images. For example, in simultaneous image captures of the first IR image sensor 502a and the second IR image sensor 502b, a target vessel located within the composite FOV 506c will generally appear more towards the right edge of the first FOV 506a than the target vessel will appear relative to the right edge of the second FOV 506b because the optical axes 506a1, 506b1 are parallel.

The blind spot 506d is a region of the AMSV external environment that is imperceptible by the IR stereovision camera because the IR image sensors 502a, 502b are not oriented and/or the focusing optics are otherwise not configured to capture radiation from this region. It will be appreciated that the FOVs 506a-c and the blind spot 506d in FIG. 5A are not drawn to scale, such that the blind spot 506d may only comprise a relatively small portion of the AMSV external environment, as compared to the portions included/covered by the FOVs 506a-c. Nevertheless, the blind spot 506d may preclude or complicate the AMSV sensing/perception systems described herein from accurately detecting, identifying, and/or otherwise locating objects disposed within this relatively small region proximate to the AMSV. This can lead to issues when the AMSV needs to maneuver precisely relative to objects located within the blind spot 506d, such as when an AMSV path plan involves the AMSV contacting or otherwise maneuvering into very close proximity to a tracked object (e.g., a target vessel).

To overcome these potential issues, FIG. 5B depicts a second example perception hardware configuration 510, in accordance with various embodiments described herein. The second example perception hardware configuration 510 includes an IR stereovision camera 512 that includes a first IR image sensor 512a and a second IR image sensor 512b separated by a baseline distance 514. The first IR image sensor 512a has a first FOV 516a and the second IR image sensor 512b has a second FOV 516b and the image sensors 512a, 512b are oriented slightly towards one another. As a result, and unlike the optical axes 506a1, 506b1 of FIG. 5A, the first optical axis 516a1 of the first FOV 516a is not parallel with the second optical axis 516b1 of the second FOV 516b.

More specifically, the first IR image sensor 512a and the second IR image sensor 512b are oriented towards one another such that a left edge 516a2 of the first FOV 516a is substantially parallel (e.g., within 5° of exactly parallel) to a right edge 516b2 of the second FOV 516b. This configuration of the first IR image sensor 512a and the second IR image sensor 512b yields a central FOV 516c that includes more of the external environment that was previously included as part of the blind spot 506d of FIG. 5A. Thus, the blind spot 516d is significantly smaller than the blind spot 506d and thereby enables the AMSV sensing/perception systems described herein to detect, identify, and/or otherwise locate objects disposed proximate to the AMSV (e.g., near a front or a front portion of the AMSV) more accurately than in the first example perception hardware configuration 500. In some embodiments, the first IR image sensor 512a and the second IR image sensor 512b may be oriented towards one another, but the left edge 516a2 and the right edge 516b2 may not be substantially parallel.

Further, the first IR image sensor 512a and the second IR image sensor 512b may be physically oriented towards one another and/or may include optical components that yield the FOVs 516a, 516b illustrated in FIG. 5B. For example, the first IR image sensor 512a and the second IR image sensor 512b may include various optical components (e.g., lenses, mirrors, prisms, gratings, etc.) configured to focus, reflect, diffract, and/or otherwise manipulate the incoming radiation that may consequently impact the FOVs 516a, 516b. In this configuration 510, any objects within the central FOV 516c will move to the opposite side of the image sensor 512a, 512b from what is intuitively expected. Namely, objects positioned in the central FOV 516c (e.g., at distances greater than a few meters from the IR stereovision camera 512) will be on the left side of the optical axis 516a1 and on the right side of the optical axis 516b1.

It should be appreciated that the angular size of the overlap illustrated in FIG. 5B decreases significantly with distance, but stereovision accuracy also becomes significantly less accurate with distance. Thus, the angular alignment of the two image sensors 512a, 512b should be chosen to optimize the total angle of both FOVs 516a, 516b (e.g., the union of FOVs 516a, 516b) and the distance at which the overlap angle becomes too small. Orienting the image sensors 512a, 512b inward past where the edges 516a2, 516b2 are substantially parallel will create an FOV overlap of finite size.

In some embodiments, the second example perception hardware configuration 510 may facilitate interception of target objects detected/identified by the AMSV. Target objects located within the FOVs 516a, 516b may be detected and identified as target objects, and the AMSV and/or any host device (e.g., MCS 18) may determine an AMSV path plan configured to cause the AMSV to intercept the target object. The AMSV may maneuver in accordance with the AMSV path plan to execute the plan and intercept the target object. For example, the target object may be a friendly vessel, and the AMSV path plan may cause the AMSV to intercept the friendly vessel by maneuvering proximate to the friendly vessel (e.g., within 1-3 meters) to enable the crew of the friendly vessel to board the AMSV and/or otherwise retrieve a deliverable stored in the AMSV. As another example, the target object may be an unfriendly vessel, and the AMSV path plan may cause the AMSV to intercept the unfriendly vessel by maneuvering proximate to the unfriendly vessel (e.g., physically impact or otherwise contact the vessel) and delivering an explosive payload into the unfriendly vessel. Accordingly, the minimal blind spot 516d (also referenced herein as a “reduced” blind spot) enables the AMSV to accurately execute such AMSV path plans at least by reducing the time spent without viewing the target object/location indicated in the AMSV path plan.

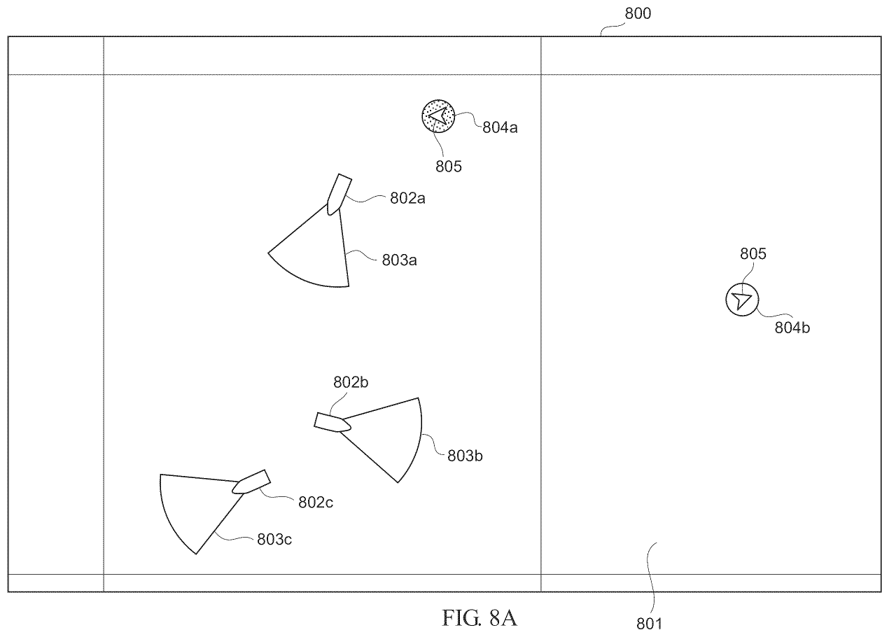

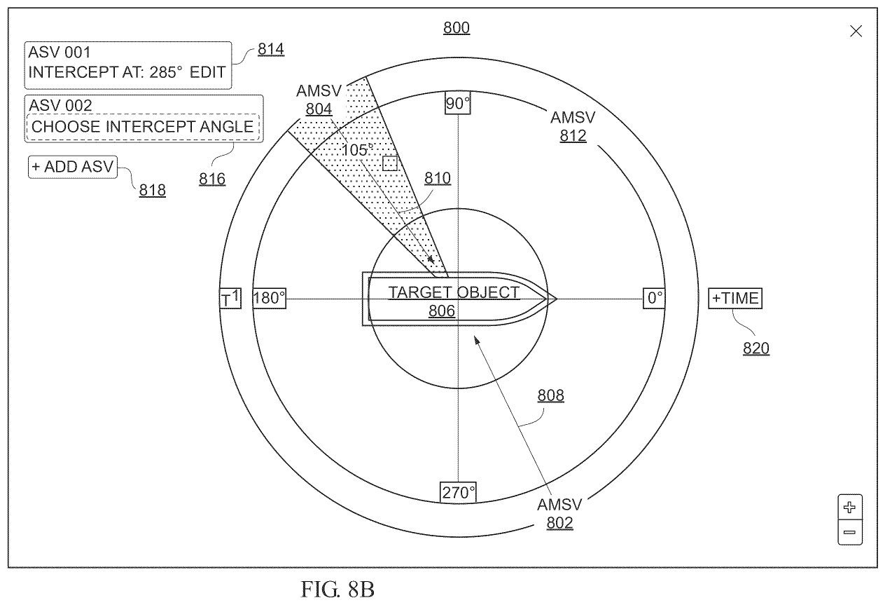

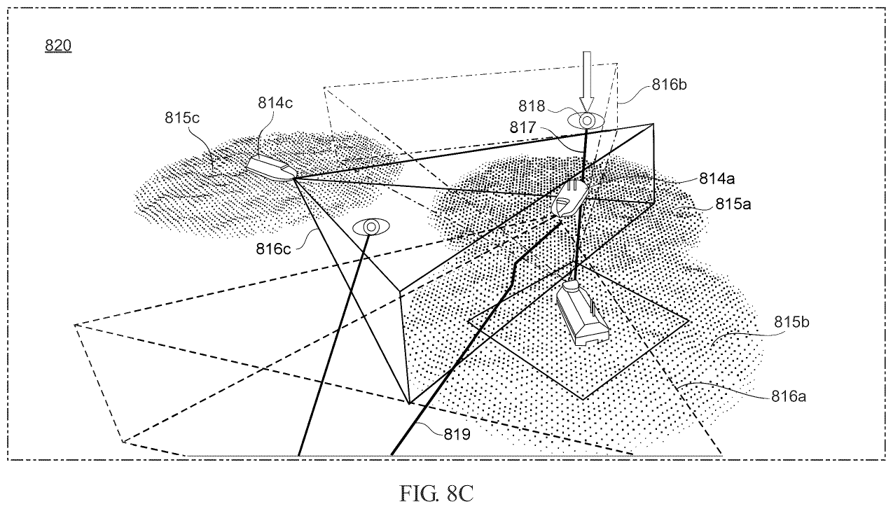

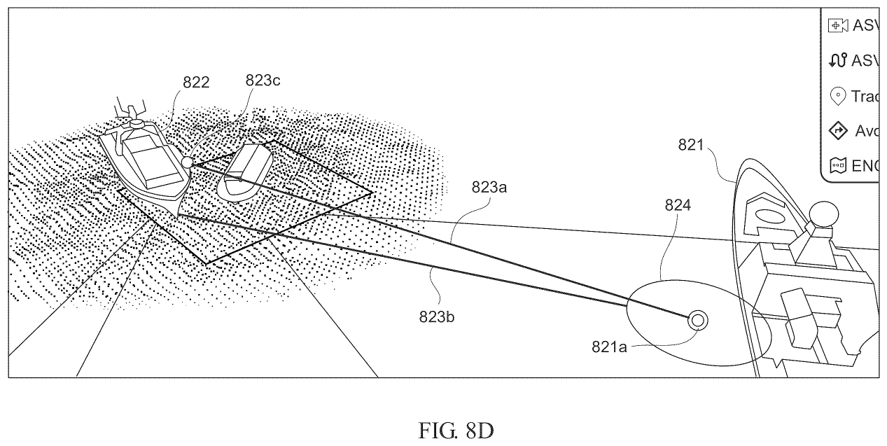

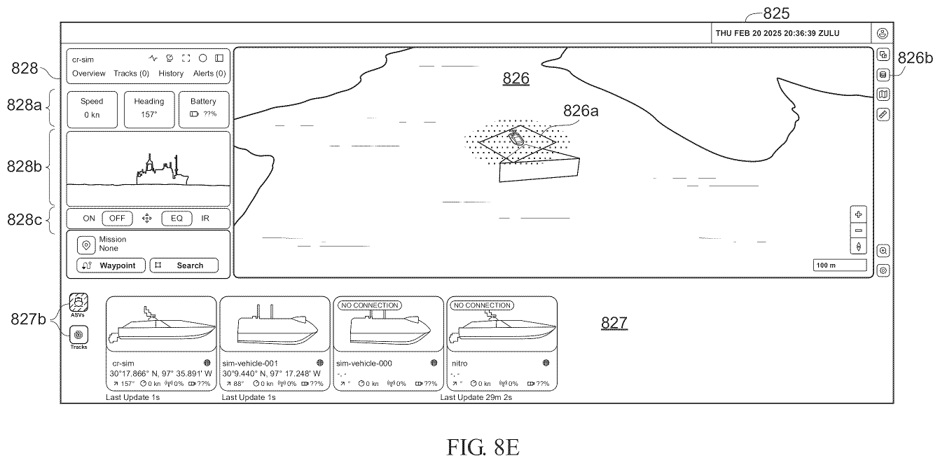

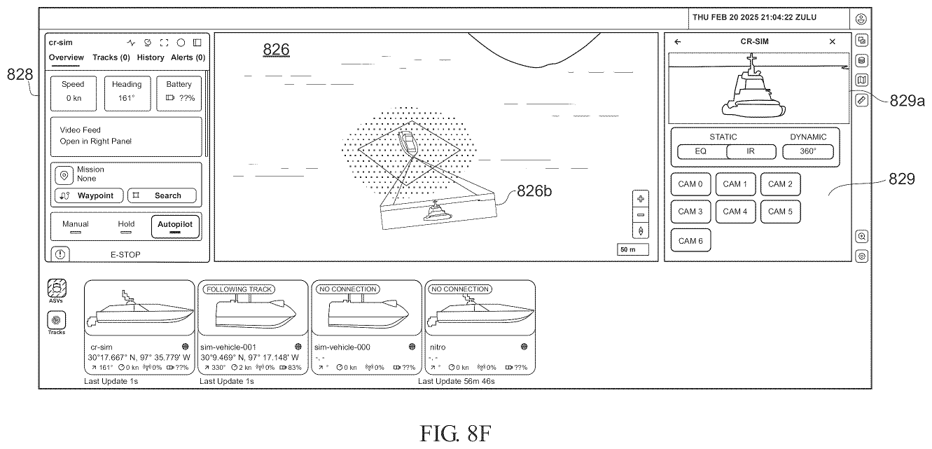

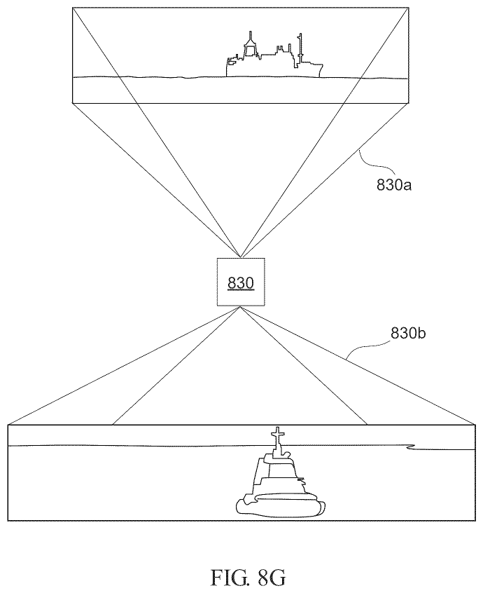

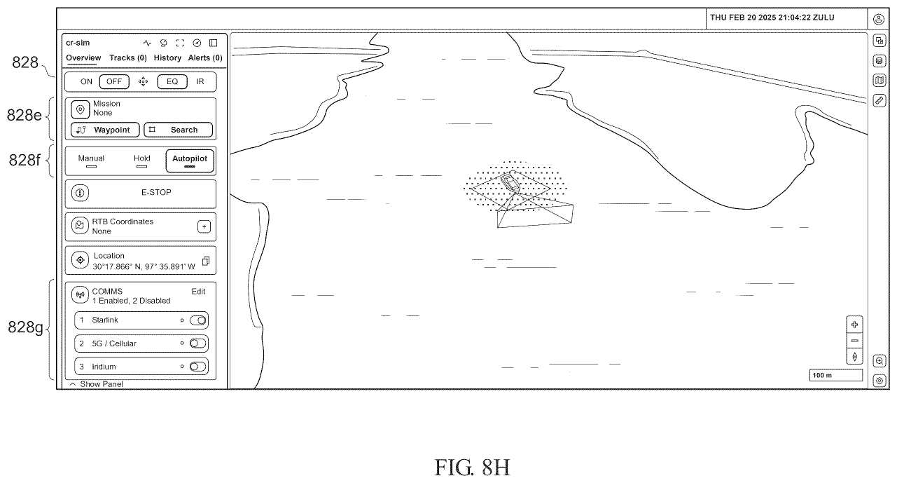

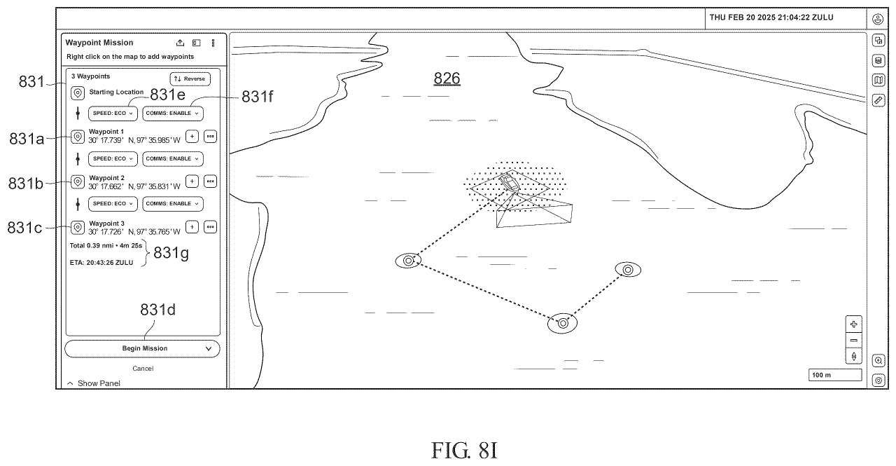

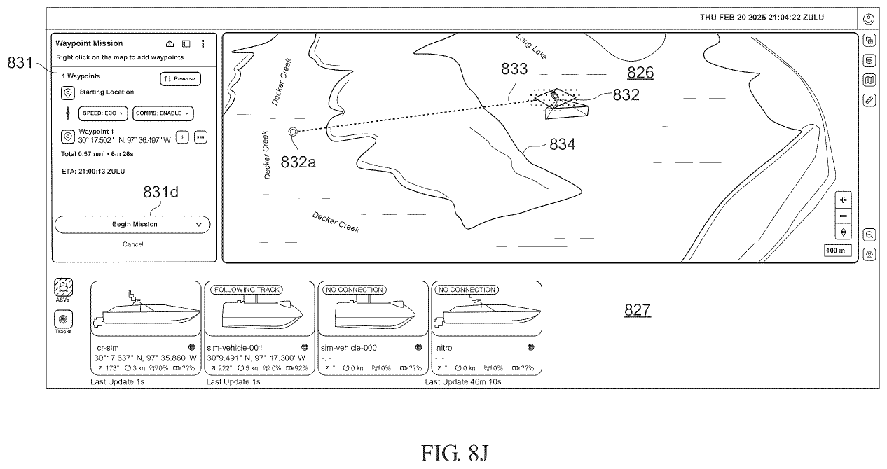

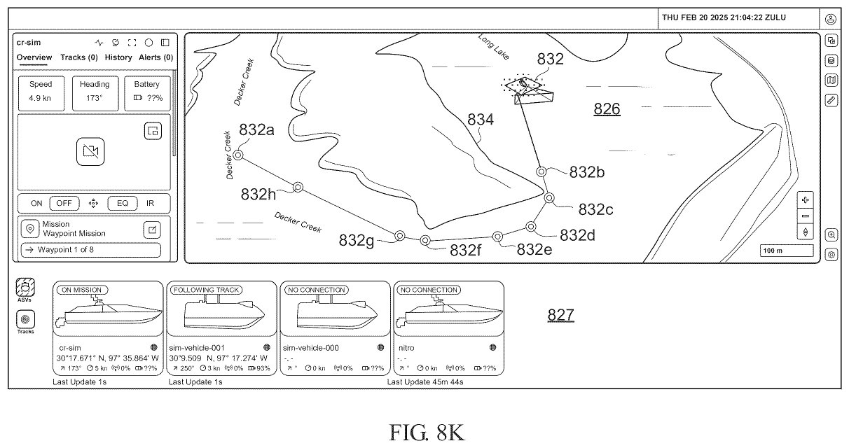

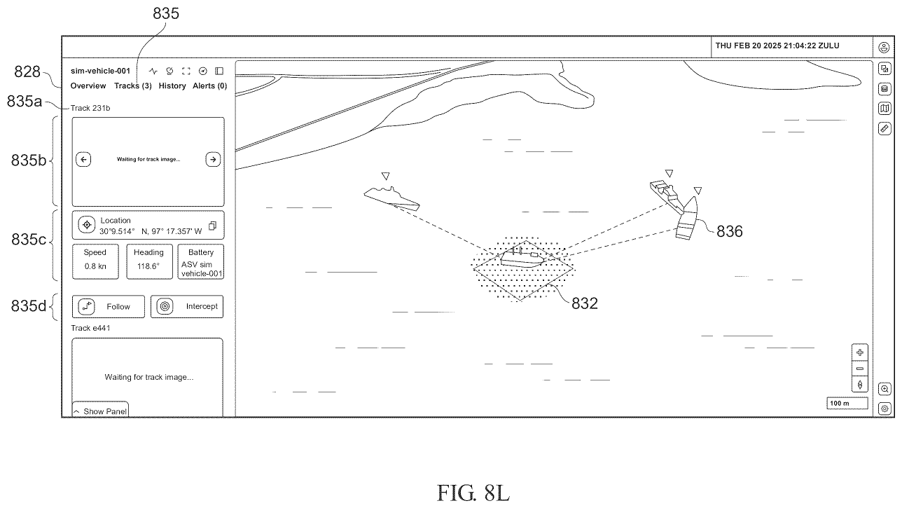

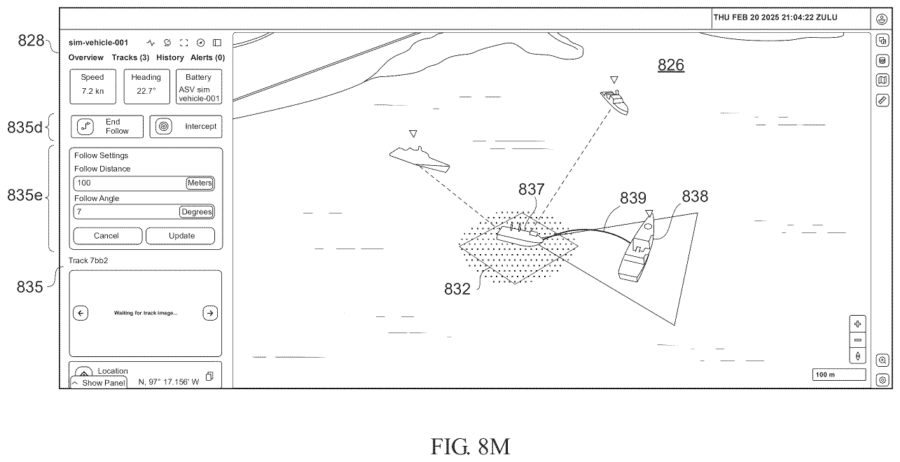

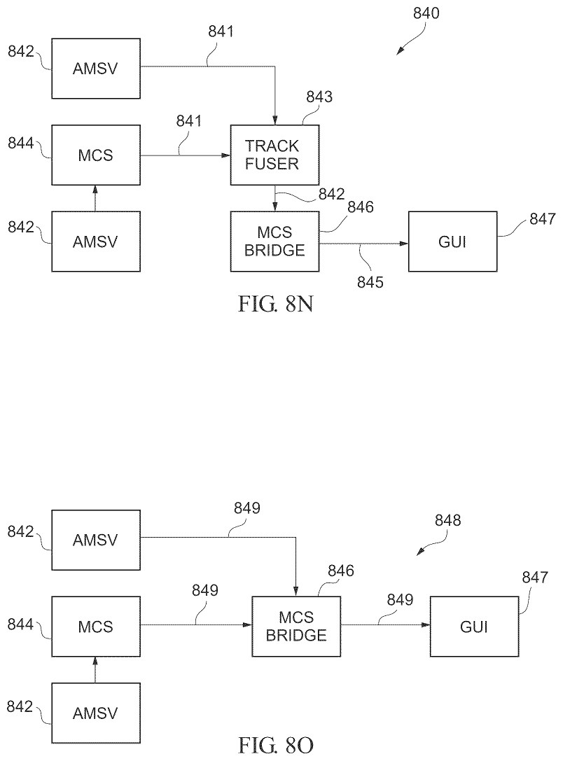

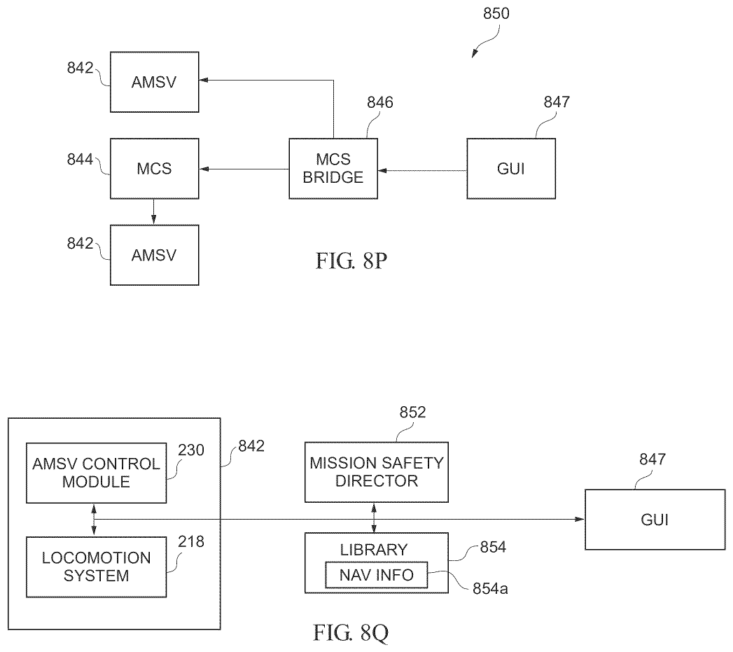

Moreover, these AMSV path planning functionalities may be performed on a group level, e.g., for multiple AMSVs simultaneously. The host device may determine respective AMSV path plans for the multiple AMSVs to intercept a single (or multiple) target objects. These interceptions may need to occur substantially simultaneously, so the AMSV path plans for each AMSV of the group may account for the estimated time to contact and/or other conclusion to the AMSV path plans of every other AMSV included in the group. In such scenarios, each AMSV in the group may receive their respective AMSV path plans, and each AMSV may execute maneuvers in accordance with their respective path plans at the indicated time(s) to ensure the nearly simultaneous completion of each AMSV path plan. This group AMSV path planning and target object interception are further illustrated and described herein at least in reference to FIGS. 8A-8Q.

Regardless, each AMSV path plan may also include instructions causing each respective AMSV to deactivate all radio transceivers on-board the AMSV prior to intercepting the target object. Generally, the radio systems described herein may not create substantial noise that can result in straightforward detection of any particular AMSV. However, as the AMSVs approach a target object, even these devices may result in unwanted detections. Each AMSV path plan may account for this unwanted result by instructing each AMSV to deactivate these components prior to intercepting the target object. For example, as an AMSV approaches a target object, the AMSV path plan (or other suitable instructions) may cause the AMSV to deactivate all on-board radio transceivers to eliminate the potential of detection from radio signal transmissions/receptions. The AMSV in this scenario would then travel the remaining distance to the target object completely “radio silent” until the AMSV completes the AMSV path plan, thereby substantially reducing the likelihood of unwanted detection by the target object. The AMSV path plan may instruct the AMV to deactivate the on-board radio transceivers (and/or other components) at any suitable distance from the target object, such as approximately 50-100 meters away from the target object. In any event, the AMSV can maintain a stable course to the target object even without receiving updates (e.g., via radio) from other AMSVs or host devices, in part, because the AMSV can readily view the target object up to the point of contact using only passive sensing as a result of the minimal blind spot 516d.

In certain embodiments, the imagers 512a, 512b may be faced in opposite directions (e.g., outward), which will decrease the FOV overlap (e.g., size of central FOV 516c) and increase the size of the union of the FOVs 516a, 516b. However, turning the imagers 512a, 512b outward will necessarily create a larger blind spot than the blind spot 516d illustrated in FIG. 5B, such that the systems described herein may lack data of objects proximate to the AMSV.

In certain instances, the AMSV may benefit from expanding or narrowing the perception system FOVs. For example, a wider FOV enables more robust object tracking within the FOV at least by reducing the likelihood of the object slipping outside of the FOV edges and therefore exceeding the AMSV's perceptive range. A narrower FOV can increase the accuracy of object detection/identification/tracking by increasing the effective image resolution as a direct result of increasing the pixel density in the observed angular region. FIG. 5C depicts a third example perception hardware configuration 520 that leverages wider/narrower FOVs, in accordance with various embodiments described herein.

The third example perception hardware configuration 520 includes an IR stereovision camera 522 with a first IR image sensor 522a and a second IR image sensor 522b separated by a baseline distance 524. The first IR image sensor 522a has a relatively wide FOV 526a, as indicated by the first angle 528a. The second IR image sensor 522b has a relatively narrow FOV 526b, as indicated by the second angle 528b. In particular, the first angle 528a is greater than the second angle 528b, and results in a wider FOV 526a than the FOV 526b, as well as the FOVs 506a, 506b, 516a, and 516b illustrated in FIGS. 5A and 5B. By contrast, the second angle 528b results in a narrower FOV 526b than the FOV 526a, as well as the FOVs 506a, 506b, 516a, and 516b illustrated in FIGS. 5A and 5B.

Using this third example perception hardware configuration 520, the perception systems described herein may detect/identify/track objects located within the composite FOV 526c more accurately based on the narrow FOV 526b and/or may achieve more robust tracking capabilities due to the larger overall FOV from the wide FOV 526a. Namely, the narrow FOV 526b achieves a higher angular pixel density for objects detected within the composite FOV 526c, and the wide FOV 526a may achieve a larger overall FOV (e.g., FOV 526a combined with FOV 526b) to ensure tracked objects do not fall outside of the FOV edges.

Of course, the example configuration 520 represented in FIG. 5C is for the purposes of discussion only, and it should be appreciated that any combination of image sensors with narrower/wider FOVs and/or image sensors or optics (e.g., lenses, etc.) orientations may be utilized to achieve the desired advantages. For example, a first combination may include an image sensor (e.g., 522b) with the narrow FOV 526b and an image sensor with any of the other FOVs (506a, 506b, 516a, 516b) illustrated and described herein. A second example combination may include an image sensor (e.g., 522a) with the wide FOV 526a and an image sensor with any of the other FOVs illustrated and described herein. Any of these image sensor configurations may yield one or more of the advantages described herein, such as greater pixel density for improved detection/identification/tracking accuracy, larger overall FOV to reduce the likelihood of objects slipping outside of the FOV edges, and/or any other advantages described herein.

In any event, the combined FOVs (e.g., 506c, 516c, 526c) described herein enable the depth measurements of the stereovision perception systems of the AMSV. As such, the AMSV's described herein generally maintain at least objects of interest (e.g., targets) within the combined FOV to determine the three-dimensional (3D) position of such objects. FIG. 5D depicts a fourth example perception hardware configuration 530 that highlights the combined FOV and objects disposed within therein, in accordance with various embodiments described herein.

The fourth example perception hardware configuration 530 includes a stereovision system 532 that includes, for example, a stereovision IR camera and a stereovision EO camera. The stereovision IR camera includes two IR image sensors that each have a FOV, resulting in a combined FOV 536. For example, the stereovision system 532 may be similar to the first example perception hardware configuration 500 of FIG. 5A, and the combined FOV 536 may be an extension of the combined FOV 506c.

Multiple objects 534a-d are disposed within the combined FOV 536. Thus, both the IR image sensors of the IR stereovision camera will capture radiation reflected or emitted from each of the objects 534a-d, but each of the objects 534a-d will be in a slightly different position within the images captured by the different IR image sensors. For example, the first object 534a will appear more towards the right edge of the left IR image sensor FOV than the first object 534a will appear relative to the right edge of the right IR image sensor FOV. This difference in perceived location represents the disparity between the two image sensors resulting from the baseline distance separating the two image sensors, and enables depth measurements based on these sets of images in accordance with the below equation:

$$D = \frac{fB}{δ} , \qquad ( 1 )$$

where D is the depth, f is the focal length of the image sensors, B is the baseline distance between the two image sensors, and δ is the disparity between the coordinate locations of an object in the two images.

To illustrate, the IR image sensors may each capture images featuring the object 534b, as represented by the lines of sight 538a, 539a of the respective imagers. The position of the object 534b within the respective images captured by the different IR image sensors is represented by the different angles 538b, 539b of the lines of sight 538a, 539a from the respective optical axes. The object 534b thus appears at different coordinate positions within the images captured by the different IR image sensors, such that the processing components described herein can determine the disparity between the two coordinate locations and the depth of the object 534b based on equation (1). Thus, each of the example perception hardware configurations illustrated herein enable depth measurements based on the principles represented by equation (1) because each hardware configuration includes stereovision cameras separated by a baseline distance.

It should be appreciated that some/all of the imagers/sensors described herein may be stacked and/or otherwise organized in a manner that maximizes the baseline between each pair of stereo imagers to further improve the vision systems described herein. For example, each IR image sensor of an IR stereovision camera may be stacked below/on top of EO image sensors of an EO stereovision camera at opposite corners of a housing to increase the effective baseline of both stereovision cameras. Further, it should be appreciated that the angular overlap of the stereovision FOVs described herein will decrease with distance, but this does not represent a genuine disadvantage because stereovision techniques generally lack resolving power over these distances. Accordingly, any of the angles described herein can be selected to optimize maximum overlap for a given camera resolution and baseline.

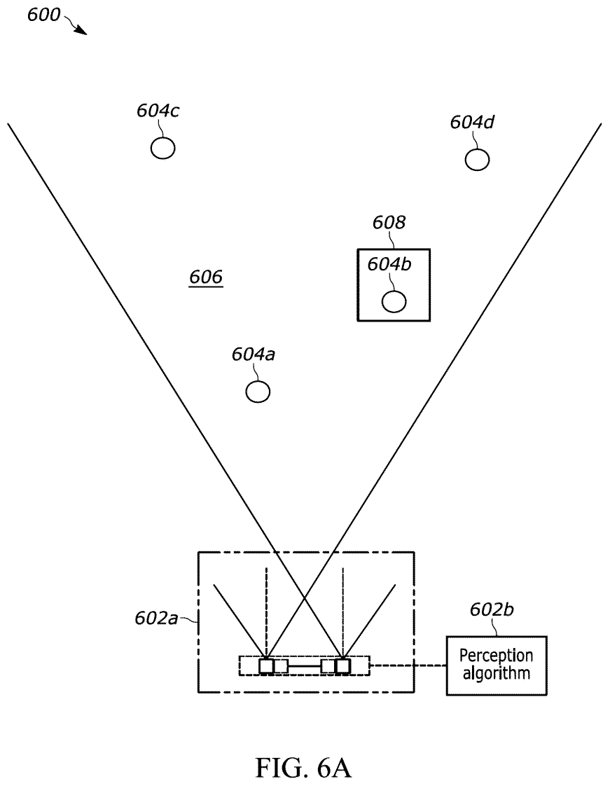

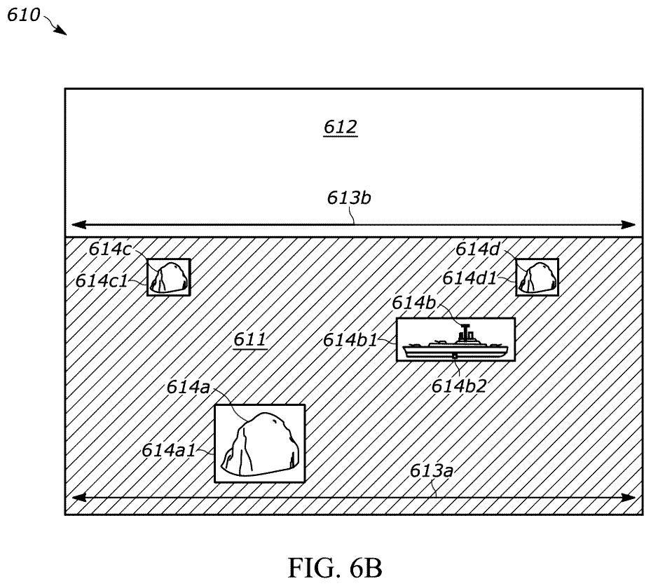

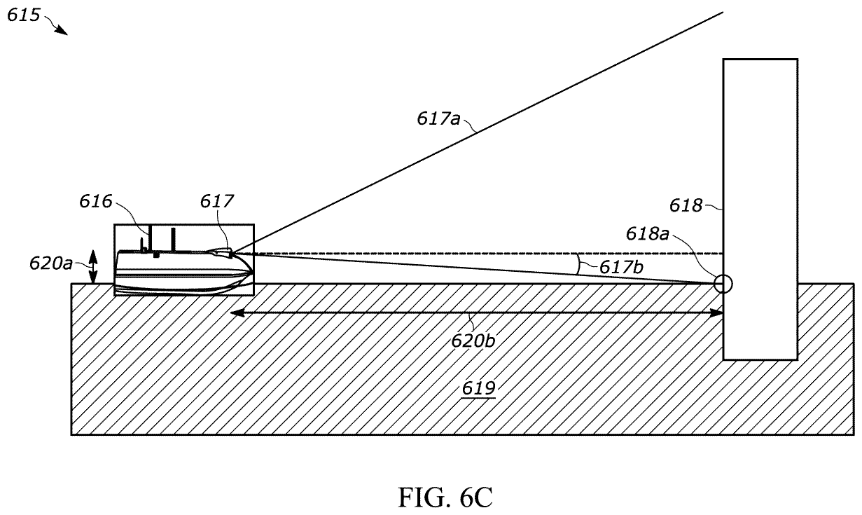

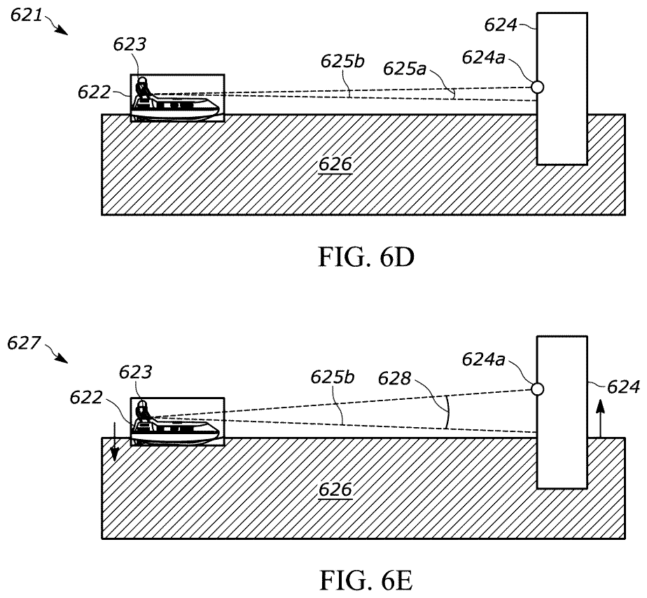

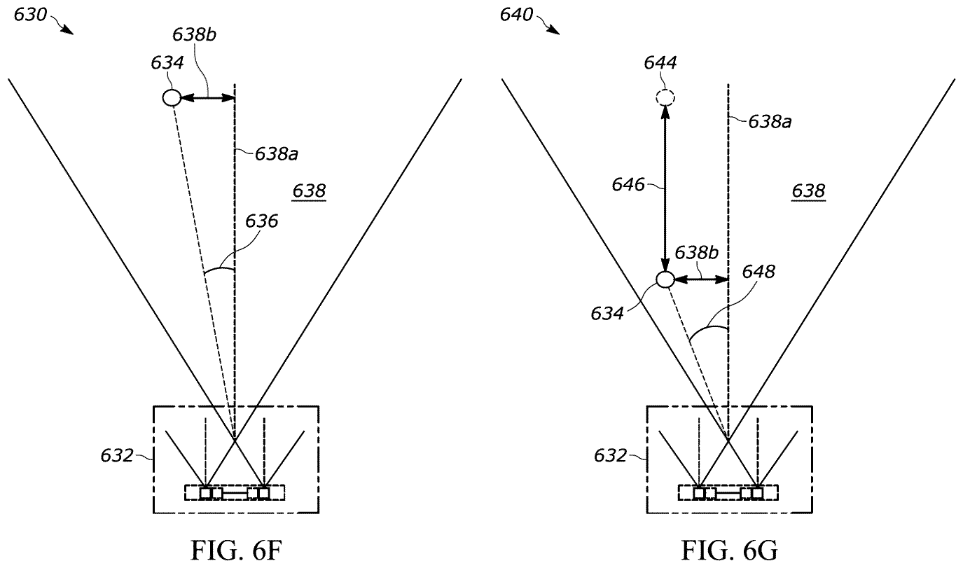

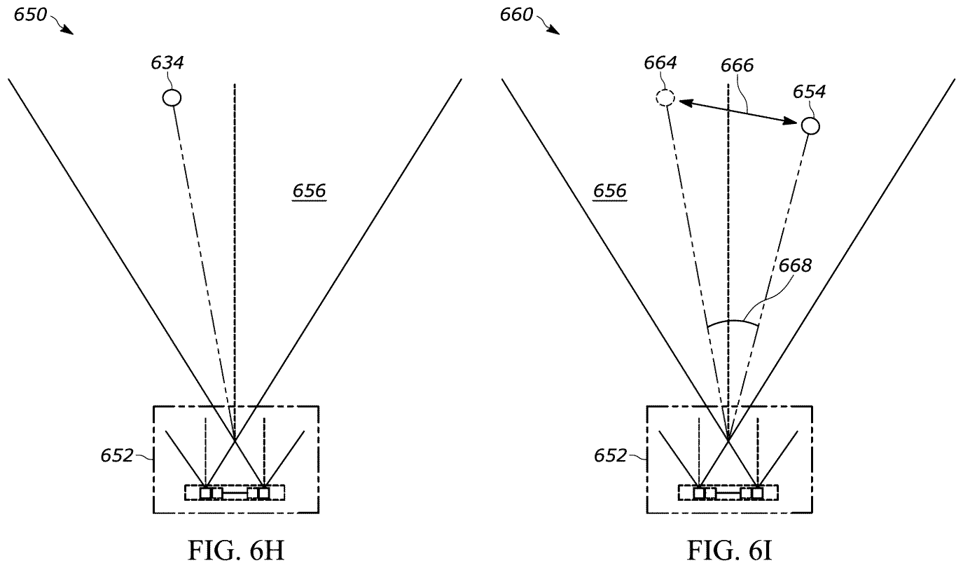

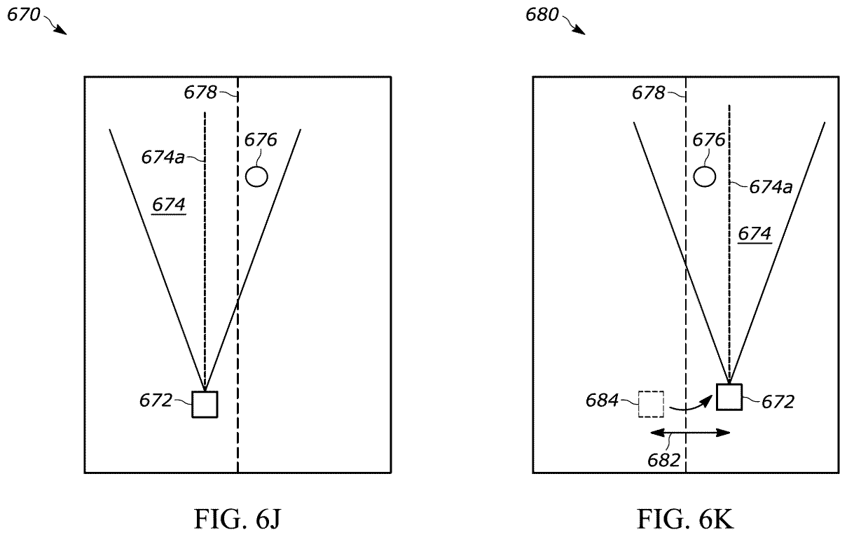

In any event, the perception techniques described herein use these hardware configurations in combination with various perception algorithms to improve conventional techniques, particularly those for perception in an external environment of an AMSV (e.g., a marine environment). These perception techniques are described further herein in reference to FIGS. 6A-6K.

### Example Perception Software Analyses

Generally speaking, any of the example perception software analysis scenarios illustrated and described herein may utilize any of the hardware components described herein in reference to FIGS. 5A-5D. For example, any of the example perception software analysis scenarios may use or include a stereovision system, including a stereovision IR camera with two IR image sensors and/or a stereovision EO camera with two EO image sensors. It should also be appreciated that the perception algorithm described herein may utilize (e.g., simultaneously or otherwise in combination) any one or more of the algorithms, evaluations, analyses, calculations, equations, and/or any other concepts described herein in reference to FIGS. 6A-6K to improve, adjust, and/or otherwise influence the perception algorithm's depth/distance estimates/measurements. Moreover, any of the perception techniques described herein may be utilized by a single AMSV, multiple AMSVs in combination, and/or at a fleet-level among an entire fleet of AMSVs to create an aggregate/collective perception (e.g., object detection/identification/location) of the external environment for a single AMSV, multiple AMSVs, and/or a fleet of AMSVs.

FIG. 6A depicts a first example perception software analysis scenario 600 using any of the hardware configurations 500-530 of FIGS. 5A-5D, in accordance with various embodiments described herein. The first example perception software analysis scenario 600 includes a stereovision system 602a with a composite FOV 606. There are multiple objects 604a-d positioned within the composite FOV 606, such that the stereovision system 602a can capture radiation representing each of the objects 604a-d.

The first example perception software analysis scenario 600 is similar to the fourth example perception hardware configuration 530 of FIG. 5D, but further includes a perception algorithm 602b communicatively coupled with the stereovision system 602a. The perception algorithm 602b is configured to process the image data generated by the stereovision system 602a and detect objects within the image data. In particular, the perception algorithm 602b causes the AMSV processors to perform one or more machine vision techniques (e.g., image segmentation, scale invariant feature transforms (SIFT), histogram of oriented gradients (HOG), implementing a convolutional neural network (CNN), etc.) on the image data generated by the stereovision system 602a. These machine vision techniques may separate/segment the image data into various classes or classifications that correspond to one or more objects.

In certain embodiments, the perception algorithm 602b may also identify the objects within the image data and/or may further generate and/or output data contributing to track determinations, as described herein. In these embodiments, each AMSV may generate an individual track which can be combined for a collective (e.g., fleet-level) track, as further described herein.

As a simple example, the stereovision system 602a may capture images of the objects 604a-d located within the composite FOV 606, and the perception algorithm 602b may cause the AMSV processors to analyze these images. The perception algorithm 602b may cause the AMSV processors to execute one or more machine vision techniques that detect each of the four objects 604a, 604b, 604c, and 604d within the image data. Further, based on this machine vision analysis instructed by the perception algorithm 602b, the AMSV processors may determine that the second object 604b is an object of interest (e.g., a target vessel) that the AMSV should track and/or otherwise accurately locate. The perception algorithm 602b may cause the AMSV processors to indicate this identification as an object of interest based on a mask 608 associated with a class/classification of one or more objects of interest.

The mask 608 may be a segmentation mask, and it should be appreciated that such a mask 608 may appear within an image captured by the stereovision system 602a. Thus, the representation of the mask 608 over the second object 604b within the composite FOV 606 is for the purposes of illustration/discussion only. Similar masks are discussed herein in reference to FIG. 6B, which depicts a second example perception software analysis scenario 610 using any of the hardware configurations 500-530 of FIGS. 5A-5D, in accordance with various embodiments described herein.

The second example perception software analysis scenario 610 generally is an example image the perception algorithm (e.g., algorithm 602b) analyzes and/or indicates analysis performed to detect objects and/or identify the objects. The example image includes a marine (water) portion 611 and an air portion 612. The marine portion 611 has multiple objects 604a-d floating and/or otherwise disposed therein, including a first object 614a (e.g., a rock), a second object 614b (e.g., a target vessel), third object 614c (e.g., a rock), and a fourth object 614d (e.g., a rock). It should be understood that the bottom of the marine portion 611 represents a first distance 613a that is shorter than a second distance 613b represented by the top of the marine portion 611.

To detect each of the objects 614a-d in the example image, the perception algorithm may cause the AMSV processors to perform any suitable machine vision techniques or combinations thereof. More specifically, the perception algorithm may cause the AMSV processors to analyze an image by examining the image pixel data to identify patterns, shapes, and/or contrasts that correspond to known characteristics of objects and/or that otherwise differ from the known/consistent characteristics of the background environment (e.g., marine environment). Through techniques such as edge detection, image segmentation, and pattern recognition, the perception algorithm can cause the AMSV processors to differentiate objects from the background environment and determine which pixels likely correspond to a complete “object” within the image.

For example, the perception algorithm detects each of the objects 614a-d within the example image by determining that each of the pixels comprising those objects 614a-d are sufficiently similar to one another and/or sufficiently different from the pixels representing the surrounding environment that the pixels should be grouped together to represent an object. At this point, the perception algorithm may or may not identify the object (e.g., identification agnostic detection), but may only recognize the presence of a distinct object within the image. Once the perception algorithm detects the objects 614a-d within the example image, the algorithm may proceed to identify each object 614a-d based on many/all of the same pixel characteristics used to detect the objects 614a-d. In certain embodiments, the perception algorithm may simultaneously or nearly simultaneously identify the objects 614a-d as part of the object detection.

With continued reference to FIG. 6B, each of the multiple objects 614a-d has an associated mask 614a1, 614b1, 614c1, 614d1 corresponding to the machine vision processes performed by the perception algorithm to detect and/or identify each of the objects 614a-d. IN embodiments where the perception algorithm identifies each object 614a-d, each mask 614a1-d1 may represent and/or otherwise include an associated class or classification, which the perception algorithm determines is applicable to the respective object 614a-d. For example, the first mask 614a1, the third mask 614c1, and the fourth mask 614d1 may each represent and/or include a class/classification indicating that the objects 614a, 614c, 614d referenced by the masks 614a1, 614c1, 614d1 are each an environmental object (e.g., rocks). As another example, the second mask 614b1 may represent and/or include a class/classification indicating that the second object 614b referenced by the second mask 614b1 is a non-environmental object (e.g., man-made object) or another vessel (e.g., target vessel).

In certain embodiments, the masks 614a1-d1 may be segmentation masks corresponding to the objects in the image as a result of image segmentation and/or other suitable machine vision techniques performed by the perception algorithm. In some embodiments, the masks 614a1-d1 may appear as part of an image output for display to a user, and may also visually indicate (e.g., via color, patterning, etc.) the classes/classifications associated with each object 614a-d.

Additionally, the second object 614b also includes a representation of a lowest pixel 614b2. This lowest pixel 614b2 indicates a pixel that the perception algorithm determined corresponds with the second object 614b and has the lowest or smallest vertical position value of any pixel associated with the second object 614b. Broadly speaking, the perception algorithm may analyze the example image such that each pixel has associated coordinate values (e.g., Cartesian coordinates) in addition to the other pixel values corresponding to the image characteristics. For ease of discussion, each pixel in the example image may have a corresponding x-value associated with the pixel's lateral (e.g., left/right) position within the image and a corresponding y-value associated with the pixel's vertical (e.g., up/down) position within the image. The lateral position may correspond to the physical, lateral location of the corresponding object in real space, and the vertical position may correspond to a physical height of the corresponding object in real space.

Thus, the lowest pixel 614b2 is a pixel within the example image that represents the lowest visible point (e.g., height) of the second object 614b in real space. In certain embodiments, the perception algorithm can use this lowest pixel 614b2 to further improve the distance/depth measurements made using the stereovision cameras described herein. For example, FIG. 6C depicts a third example perception software analysis scenario 615 using any of the hardware configurations 500-530 of FIGS. 5A-5D, in accordance with various embodiments described herein.

Specifically, the third example perception software analysis scenario 615 includes an AMSV 616 capturing radiation with a stereovision system 617 having a FOV 617a to generate an image of a target 618. As illustrated in FIG. 5C, the lowest point 618a of the target 618 is within the stereovision system 617 FOV 617a, and therefore appears within the generated image of the target 618. Using the vertical position value of the pixel corresponding to the lowest point 618a and the known height 620a of the stereovision system 617 from the water 619 surface, the perception algorithm can estimate the distance 620b to the target 618.

For example, the perception algorithm may determine the distance 620b to the target 618 in a two-step process. The perception algorithm may first calculate the angle of depression 617b from the stereovision system 617 to the lowest point 618a of the target 618 based on, e.g., inference using the lowest pixel's vertical position. The perception algorithm may then calculate the distance 620b to the target 618 using the tangent function in combination with the known height 620a of the stereovision system 617 from the water 619 surface.

In certain embodiments, the perception algorithm may utilize this distance estimate as a comparison with the depth/distance measurement resulting from the stereovision system 617 image captures, as generally defined by equation (1). In this manner, the perception algorithm may reduce the error associated with the depth measurements resulting from the stereovision system 617 image captures at least by checking that the distance measurements resulting from equation (1) do not differ significantly from the distance measurements resulting from the lowest pixel analysis described in reference to FIG. 6C. Moreover, the perception algorithm may utilize multiple other depth/distance measurement techniques to reduce the error associated with the measurements utilizing the stereovision system 617 images and equation (1).

For example, FIGS. 6D and 6E depict a fourth example perception software analysis scenario 621 and a fifth example perception software analysis scenario 627, respectively, using any of the hardware configurations 500-530 of FIGS. 5A-5D, and in accordance with various embodiments described herein. Generally speaking, the fourth and fifth example perception software analysis scenarios 621, 627 depict the same AMSV 622 with a stereovision system 623 and a target 624 with a static point 624a at two distinct times. The fourth example perception software analysis scenario 621 may be at a first time (also referenced herein as a first/second/etc. “time instance”) when the AMSV 622 and the target 624 are significantly, vertically aligned, and the fifth example perception software analysis scenario 627 may be at a second time when the AMSV 622 and the target 624 are significantly, vertically misaligned due to the undulations of the water surface 626.

Thus, in the fourth example perception software analysis scenario 621, the static point 624a is at a relatively minimal vertical angle 625a relative to the stereovision system 623 FOV central vertical axis 625b. At this point, the stereovision system 623 may capture images of the target 624 that include the static point 624a. At a high level, the static point 624a may include distinctive visual characteristics (e.g., bright colors, high contrast with surrounding portions of the target 624, etc.) and/or otherwise be readily identifiable by the perception algorithm across subsequent image captures of the target 624. This visual and/or otherwise distinctiveness of the static point 624a is crucial because the perception algorithm may utilize the pixel(s) representing this static point 624a in combination with known and/or measurable height differences between subsequent image captures to create a vertical synthetic baseline between the stereovision system 623 image captures at the first time and the image captures at the second time.

Namely, at the second time (e.g., in scenario 627), the AMSV 622 may have significantly vertically shifted relative to the target 624 due to the undulations of the water surface 626. As illustrated in FIG. 6E, the AMSV 622 may have lowered (e.g., in a trough) relative to the first time while the target 624 may have elevated (e.g., at a wave crest) relative to the first time. Practically speaking, the elevation differences experienced by the AMSV 622 may be equally experienced by the target 624, such that the vertical baseline measurements described in reference to FIGS. 6D and 6E may be negatively impacted by movement of the target within the stereovision system 623 that is not attributable to the vertical movement of the AMSV 622. However, at least at substantial distances from the target 624, the target's 624 vertical movement may have a negligible impact on the target's vertical position in image captures relative to the vertical movement of the AMSV 622, so any vertical displacement of the target between subsequent image captures is approximately attributable solely to the vertical movement of the AMSV 622.

In any event, due to the vertical movement of the AMSV 622 and the target 624, the static point 624a is at a large vertical angle 628 relative to the stereovision system 623 FOV central vertical axis 625b, and the stereovision system 623 may capture images of the target 624 that include the static point 624a at the large vertical angle 628. The perception algorithm may identify the static point 624a in these subsequent image captures (e.g., based on the distinctive visual characteristics and/or other features) and utilize the vertical position value of the pixel(s) corresponding to the static point 624a in combination with measured height differentials to calculate the distance/depth of the target 624 (e.g., using equation (1)). The measured height differentials of the AMSV 622 between the first time and the second time may be the baseline distance value B in equation (1). The perception algorithm may infer the height differential based on the change in vertical angles 625a, 628 and the vertical position value of the pixel(s) corresponding to the static point 624a. Additionally, or alternatively, the perception algorithm may measure the height differential using any suitable sensor or combinations thereof, such as an accelerometer, a gyroscope, a GPS (e.g., GPS communication interface 220a), and/or an inertial measurement unit (IMU).

FIGS. 6F and 6G depict a sixth example perception software analysis scenario 630 and a seventh example perception software analysis scenario 640, respectively, using any of the hardware configurations 500-530 of FIGS. 5A-5D, and in accordance with various embodiments described herein. Generally speaking, the sixth and seventh example perception software analysis scenarios 630, 640 depict the same stereovision system 632 and a target 634 at two distinct times. The sixth example perception software analysis scenario 630 may be at a first time when the target 634 is at a first distance from the stereovision system 632 and is maintained at an offset 638b from the stereovision system 632 FOV 638 optical axis 638a. The seventh example perception software analysis scenario 640 may be at a second time when the target 634 is at a second distance from the stereovision system 632 and is still maintained at the offset 638b from the stereovision system 632 FOV 638 optical axis 638a.

As previously mentioned, when tracking or otherwise locating an object, conventional systems maintain the object at/near the center of their FOV. Successive image captures of the target when using these conventional techniques may thus experience changes to the “y” coordinate value as the target moves closer or further from the imaging system, but do not typically experience changes to the “x” coordinate value because the target is maintained in a static, principal position within the FOV.

By contrast, the present techniques illustrated in FIGS. 6F and 6G maintain the target 634 in an offset position, and thereby cause successive image captures of the target 634 to reflect changes in both coordinate positions (e.g., x and y), as indicated below in equation (2). Because the AMSV maintains the target 634 in a relatively static offset 638b from the optical axis 638a, the changes in at least the “x” coordinate position may be perceived lateral movement resulting from the changes in the “y” coordinate. In other words, as the AMSV moves closer to the target 634 (or vice versa), the target 634 appears to move laterally across the FOV 638 due to the FOV's 638 conical shape. The perception algorithm may utilize this change in “x” (and “y”) coordinate positions to determine the depth/distance to the target 634 more accurately (e.g., using equation (1)) by leveraging the covariant relationship between the perceived “x” movement and the estimated change in depth/distance. Namely, the covariant relationship may be negative because the perceived “x” movement generally increases as the depth/distance decreases. Additionally, or alternatively, the perception algorithm may utilize trigonometric principles to determine and/or infer the distance to the target 634 based on the perceived angular difference between the first angle 636 and the second angle 648.

In particular, in the sixth example perception software analysis scenario 630, the stereovision system 632 captures images of the target 634 at the offset 638b and at a first angle 636 relative to the optical axis 638a. In the captured images at the first time, the target 634 may have a first set of x and y coordinates (e.g., “(x,y)”) representing the Cartesian coordinate position of the target 634 in a coordinate plane defined for the captured image. For example, the stereovision system 632 may define a middle pixel(s) of any captured image as the origin or “(0,0),” or may define any of the pixels in an image corner as “(0,0)”.

In the seventh example perception software analysis scenario 640, the stereovision system 632 captures images of the target 634 at the offset 638b and at a second angle 648 relative to the optical axis 638a. In the captured images at the second time, the target 634 may have moved from the prior location 644 due to movement of the AMSV including the stereovision system 632 and/or of the target 634, but the AMSV may maintain the target 634 at the same offset 638b from the optical axis 638a. In so doing, the images captured by the stereovision system 632 at the second time feature the target 634 at a Cartesian position generally defined as

$$( x + {Δ}_{1} , y + {Δ}_{2} ) , \qquad ( 2 )$$

where Δ_1 and Δ_2 represent the respective differences in the target's 634 x/y position within the captured image coordinate plane at the second time relative to the target's 634 x/y position at the first time. These values (Δ_1 and Δ_2) may be any suitable positive or negative values, such that the target 634 may be perceived as moving away or towards the optical axis 638a. For example, the AMSV may intentionally maintain the target 634 in the offset 638b position at the first time and may subsequently rotate towards the target 634 to cause the target 634 to appear closer to the optical axis 638a than the offset 638b at the second time. In certain embodiments, the AMSV may maintain the target 634 at a similar offset from the optical axis 638a without the offset being approximately the same as the offset 638b between the first time and the second time.

Based on the perceived lateral (“x”) movement of the target 634 indicated in equation (2), the perception algorithm may constrain the depth/distance measurements generated in accordance with equation (1) based on the covariant relationship between the two values. As mentioned, the perceived lateral movement may have a negative/invariant relationship with the target 634 depth/distance. The perception algorithm can utilize this relationship to inform or check the depth/distance estimates/measurements using the stereovision system 632 images and equation (1) and thereby ensure that the error associated with the depth/distance estimates is reduced/minimized. In other words, the perception algorithm can utilize this covariant relationship to check that the depth/distance estimate from equation (1) is not significantly different from what would be expected based on the corresponding estimated change in depth/distance from the first time to the second time and the associated, known perceived change in “x” position over the same period (e.g., first time to second time). If the estimated depth/distance value differs significantly from what would be expected based on the covariant relationship, the perception algorithm may adjust the estimated depth/distance value based on the perceived lateral movement.

In many instances, the target or object of interest may be moving within the AMSV's FOV, which can further complicate accurate depth/distance measurements. In these scenarios, the perception algorithm may utilize these changes in the target's position to determine the target's speed, direction, and/or other quantities to inform the subsequent guidance of the AMSV. For example, FIGS. 6H and 61 depict an eighth example perception software analysis scenario 650 and a ninth example perception software analysis scenario 660, respectively, using any of the hardware configurations 500-530 of FIGS. 5A-5D, and in accordance with various embodiments described herein.

The eighth example perception software analysis scenario 650 includes an AMSV stereovision system 652 with a target 654 within the FOV 656 at a first time. The ninth example perception software analysis scenario 660 includes the AMSV stereovision system 652 at a second time where the target 654 has moved from the first position 664 to a second position, as indicated by the displacement 666 and the lateral movement angle 668 within the FOV 656. By accounting for the AMSV's movement in the period between the first time and the second time, the perception algorithm can utilize this change in the target's 654 position to determine several important quantities about the target 654.

For example, the perception algorithm may determine a depth/distance value from the target 654 by comparing the first position 664 of the target 654 at the first time with the second position of the target 654 at the second time. Namely, the perception algorithm may infer the depth/distance of the target 654 from the AMSV based on trigonometric principles utilizing the lateral movement angle 668.

Additionally, or alternatively, the perception algorithm may determine (i) the target's 654 orientation and/or (ii) the target's 654 speed based on the movement of the target 654 within the FOV between the first time and the second time. For example, the perception algorithm may determine the target's 654 speed at least by evaluating the estimated change in position (i.e., distance traveled by the target 654) and dividing that estimate by the change in time between the first time and the second time. The perception algorithm may also determine/estimate the target's 654 orientation based on the target's 654 movement in combination with the image analysis and classification/categorization described herein. For example, the perception algorithm may generally determine (via image analysis) that the target 654 is a large vessel oriented towards the right side of the FOV in a three-quarter view, such that the front of the vessel is mostly visible. In this example, the perception algorithm may supplement this image analysis with the detected movement of the vessel (e.g., between the first position 664 and the second position) to confirm that the vessel is oriented in a right-ward direction moving slightly towards and to the right of the AMSV FOV 656.

Based on any/all of these determinations regarding the target's position/movement/etc., the perception algorithm may output or otherwise transmit data to the AMSV guidance systems (e.g., AMSV control module 230, locomotion system 218) to adjust the path planning/guidance of the AMSV. In particular, the perception algorithm may output data that causes the AMSV guidance systems to adjust (i) an AMSV orientation and/or (ii) an AMSV speed of the AMSV based on the target 654 orientation or the target 654 speed.

In general, the baseline distance between image sensors of a stereovision system plays a critical role in the resolution/accuracy of resulting depth/distance measurements, and a larger baseline distance typically yields higher resolution/accuracy. Accordingly, in certain instances, the baseline distance between individual image sensors (e.g., first IR image sensor 502a, second IR image sensor 502b) may be less than optimal to achieve high-resolution depth/distance measurements. To overcome these challenges, the present techniques described in reference to FIGS. 6J and 6K provide another method to create a synthetic baseline that greatly improves the perception algorithm's ability to provide high accuracy/resolution depth/distance measurements.

FIGS. 6J and 6K depict a tenth example perception software analysis scenario 670 and an eleventh example perception software analysis scenario 680, respectively, using any of the hardware configurations 500-530 of FIGS. 5A-5D, and in accordance with various embodiments described herein. The tenth example perception software analysis scenario 670 includes an AMSV 672 with an FOV 674 having an optical axis 674a and a target 676 included in the FOV 674 at a first time. In this scenario 670, the AMSV 672 is on the left side of a central line 678 and the target 676 is on the right side of the central line 678. At this first time, the AMSV 672 may capture images of the target 676 on the right side of the optical axis 674a. Further, the FOV 674 generally represents the composite FOV (e.g., composite FOVs 506c, 516c, 526c, 536) of multiple image sensors operating as part of a stereovision system/camera.

The eleventh example perception software analysis scenario 680 includes the AMSV 672 having moved from the first position 684 to the right side of the central line 678 along with the target 676 at a second time. This movement of the AMSV 672 is reflected by the lateral displacement 682 of the AMSV 672 from the first time to the second time, which generally represents the synthetic baseline the perception algorithm uses to generate high accuracy/resolution depth/distance measurements of the target 676. At the second time, the AMSV 672 may again capture images of the target 676, which in this example, features the target 676 on the left side of the optical axis 674a.

Using these two sets of image captures at the first time and the second time, the perception algorithm may determine the depth/distance to the target 676 using equation (1). Namely, the perception algorithm may generate a composite image of the target 676 using the image captures from the individual image sensors at the first time to serve as one of the images captured as part of the synthetic stereovision system having a baseline separation between imagers defined by the lateral displacement 682. The perception algorithm may repeat this process for the images captured at the second time and may thereby have a pair of images representing the target 676 captured at distinct locations separated by the lateral displacement 682 (e.g., the synthetic baseline). The perception algorithm may then account for the movement of the AMSV 672 between the first time and the second time and may then utilize equation (1) with the lateral displacement 682 serving as the baseline value B to generate a depth/distance value for the target 676.

Additionally, or alternatively, the perception algorithm may utilize any suitable combination of the captured images at the first/second times to calculate the target's 676 depth/distance. For example, the perception algorithm may utilize the image captured by the left IR image sensor at the first time and the right IR image sensor at the second time to achieve the largest possible synthetic baseline between image captures.

In certain embodiments, the perception algorithm may analyze data from a group/plurality of AMSVs that are connected via a mesh network (e.g., mesh network 305). A host device, such as one AMSV in the group and/or a mobile control system (e.g., MCS 18) servicing the group of AMSVs, may transmit control instructions to each of the AMSVs of the group to maneuver each of them as illustrated in FIG. 6K. In particular, the host device may cause the group of AMSVs to laterally maneuver in a manner that creates a synthetic baseline between the image sensors of the respective AMSVs, resulting in a synthetic disparity between the images at the two laterally separated locations. Each AMSV may capture radiation using their respective passive sensing systems, and the perception algorithm may detect one or more objects in the image data corresponding to the captured radiation for each AMSV. The host device and/or any individual AMSV may analyze these one or more detected objects and determine and transmit further control instructions to at least a subset of the group of AMSVs to change an orientation, a geospatial location, and/or a speed of any respective AMSV of the subset.

As previously mentioned, creating a synthetic baseline generally improves the resolution/accuracy of depth/distance measurements resulting from the stereoscopic vision techniques described herein. Thus, because multiple AMSVs of the group of AMSVs are laterally maneuvered to create a respective synthetic baseline when capturing their radiation/image data, the depth estimation and corresponding object detection/identification for each laterally maneuvered AMSV is increased. When these independent high-resolution/accuracy object detections and/or identifications are analyzed in tandem and/or otherwise compared for consistency, these resolution/accuracy improvements are further compounded, as the propagation of errors during this comparative analysis can be significantly lower than when synthetic baselines (and resulting synthetic disparities) are not utilized.

In some embodiments, each AMSV may maneuver a different lateral distance and/or one or more of the group of AMSVs may laterally maneuver the same distance. In certain embodiments, not all of the group of AMSVs may be maneuvered laterally, such that only a subset of the group of AMSVs create a synthetic baseline for their image sensors.

In certain embodiments, the AMSV 672 may iteratively/repeatedly perform the lateral movement illustrated in FIG. 6K in a back-and-forth pattern to iteratively/repeatedly determine the target's 676 depth/distance using the synthetic baseline technique described in reference to FIGS. 6J and 6K.

### Example Computer-Implemented Methods

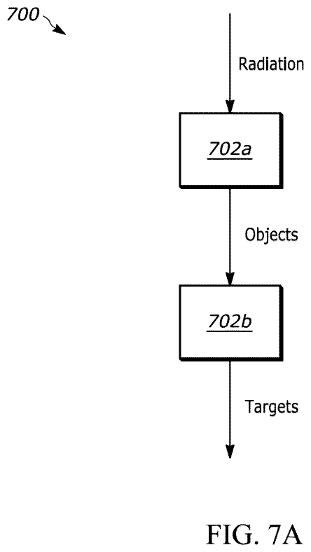

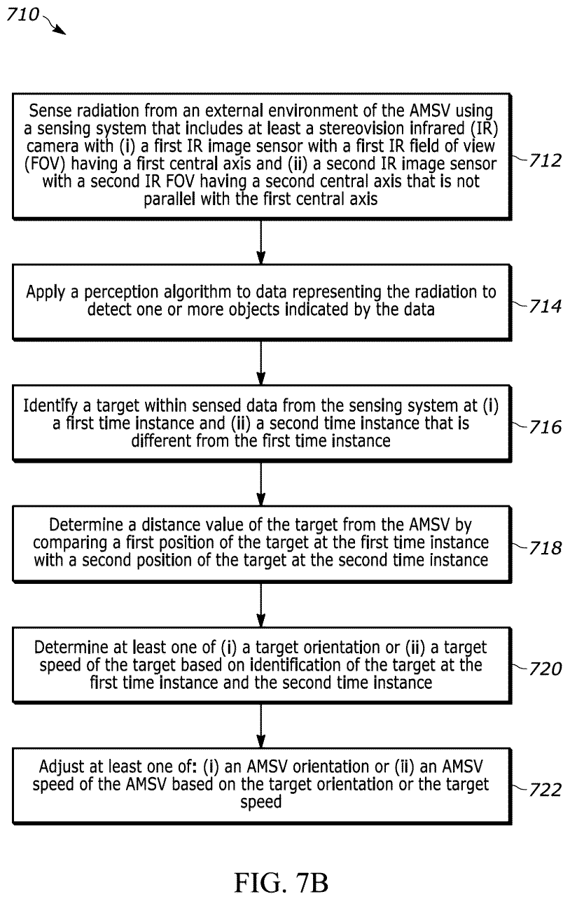

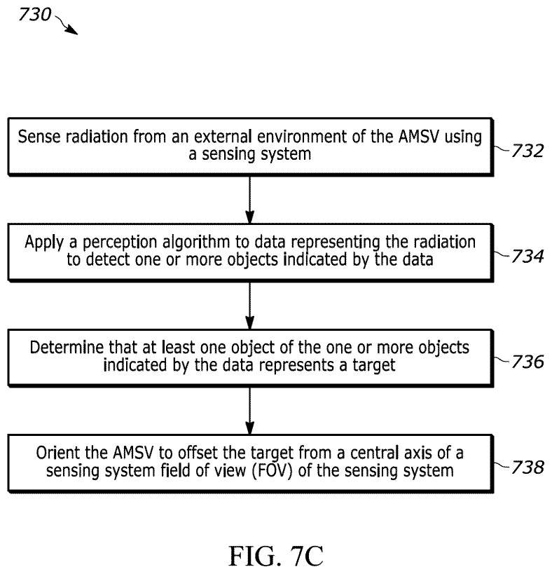

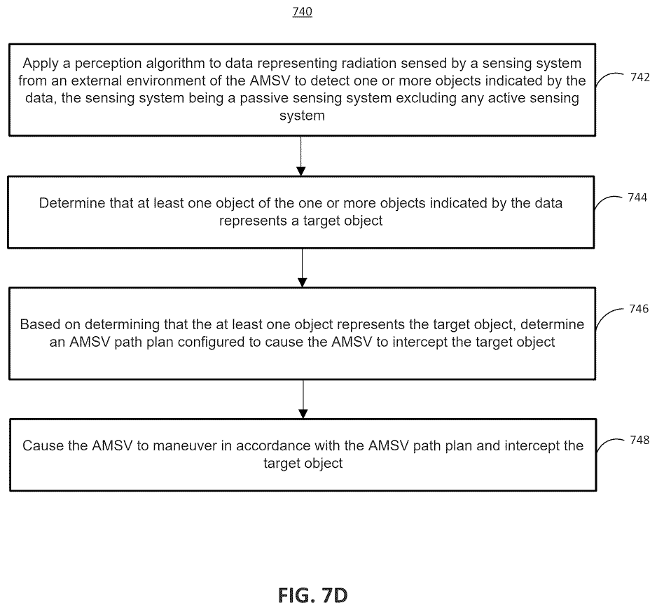

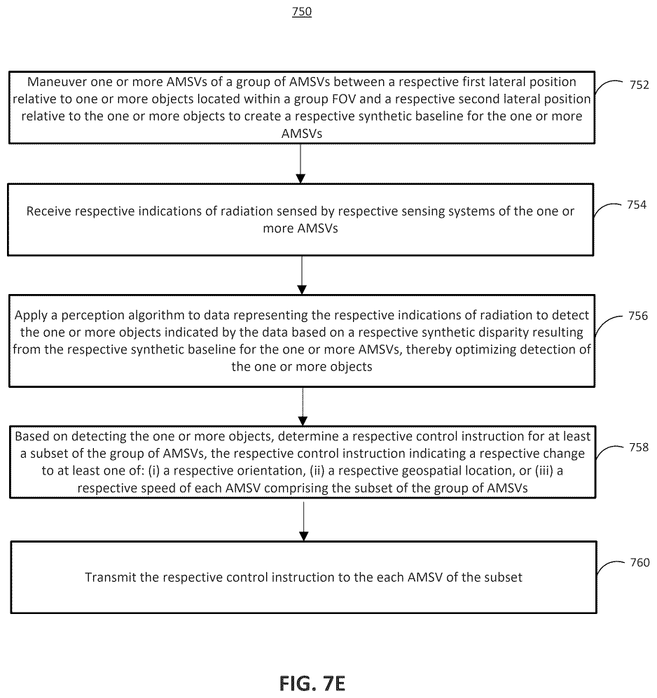

FIG. 7A depicts a first flow diagram representing an example computer-implemented method 700, in accordance with various embodiments described herein. The method 700 may be implemented by one or more processors of the AMSV 200, such as the processors 222 executing the LSA module 232 and/or other hardware/software of the AMSV 200 (e.g., passive sensing system 212), for example.

At a high level, the method 700 represents the target detection/identification process performed by an AMSV with the perception algorithm described herein. Namely, the method 700 includes capturing radiation from an external environment of the AMSV. This radiation may be or include IR radiation that is passively sensed by a passive sensing system (e.g., system 212) of the AMSV, but may be or include any suitable radiation of any suitable wavelength. As an example, the AMSV may include passive sensors configured to sense radiation in near IR, mid IR, far IR, and visible light spectra.

When the passive sensing system senses/captures the radiation from the external environment and converts the radiation into image data, the method 700 further includes analyzing the captured radiation to detect one or more objects within the data representing the radiation (block 702a). The perception algorithm includes instructions to perform object detection within the image data, and may include instructions to utilize any suitable methods, as described herein. For example, the perception algorithm may include instructions that cause the AMSV processors to perform image segmentation, object detection, edge detection, scale invariant feature transforms (SIFT), histogram of oriented gradients (HOG), implementing a convolutional neural network (CNN), and/or any other suitable image processing techniques or combinations thereof to detect objects within the image data. The objects identified within the image data may include any object that is determined to be distinct or otherwise separate from the external/marine environment of the AMSV (e.g., targets, rocks, etc.).

The method 700 further includes identifying targets based on the detected objects within the image data (block 702b). The image processing techniques described above to detect objects within the image data may also identify the targets from amongst the set of detected objects. For example, the perception algorithm may include instructions that cause the AMSV processors to perform image segmentation on the image data, after which, the pixels corresponding to each object in the image data may be assigned to one or more classes via an applied segmentation mask. These masks contain different labels (e.g., integer values) that correspond to different object classes/categories, and thereby associate the pixels with a known object. The perception algorithm analyzes these outputs of the image segmentation process and can readily identify targets from amongst the detected objects by determining which objects have segmentation masks corresponding with a “target” object class. Of course, in practice, the “target” object class may be labelled in accordance with any suitable target, such as the name/designation of a ship or vessel of interest.

Of course, it is to be appreciated that the actions of the method 700 may be performed any suitable number of times, and that the actions described in reference to the method 700 may be performed in any suitable order.

FIG. 7B depicts a second flow diagram representing another example computer-implemented method 710, in accordance with various embodiments described herein. The method 710 may be implemented by one or more processors of the AMSV 200, such as the processors 222 executing the LSA module 232 and/or other hardware/software of the AMSV 200 (e.g., passive sensing system 212), for example.

The method 710 includes sensing radiation from an external environment of the AMSV using a sensing system that includes at least a stereovision IR camera (block 712). The stereovision IR camera includes (i) a first IR image sensor with a first IR field of view (FOV) having a first optical axis and (ii) a second IR image sensor with a second IR FOV having a second optical axis that is not parallel with the first optical axis. The method 710 further includes applying a perception algorithm to data representing the radiation to detect one or more objects indicated by the data (block 714).

The method 710 further includes identifying the target within sensed data from the sensing system at (i) a first time instance and (ii) a second time instance that is different from the first time instance (block 716). The method 710 further includes determining a distance value of the target from the AMSV by comparing a first position of the target at the first time instance with a second position of the target at the second time instance (block 718).

The method 710 further includes determining at least one of (i) a target orientation or (ii) a target speed of the target based on identification of the target at the first time instance and the second time instance (block 720). The method 710 further includes adjusting at least one of: (i) an AMSV orientation or (ii) an AMSV speed of the AMSV based on the target orientation or the target speed (block 722).

In some aspects, the sensing system further includes at least two electro-optical (EO) image sensors including a first EO image sensor with a first EO FOV and a second EO image sensor with a second EO FOV.

In some aspects, the method 710 further includes determining that at least one object of the one or more objects indicated by the data represents a target; and orienting the AMSV to offset the target from an optical axis of a sensing system FOV of the sensing system.

In some aspects, determining that the at least one object represents the target by performing image segmentation on the data.

In some aspects, performing image segmentation on the data includes determining one or more segmentation masks associated with the one or more objects, and the method 710 further includes identifying a target within the one or more objects based on the one or more segmentation masks.

In some aspects, the method 710 further includes determining a lowest pixel associated with the target that has a lowest vertical position value of pixels corresponding to the target; and determining a distance value of the target from the AMSV based on (i) depth data derived from a disparity of the sensing system and (ii) a height differential between the lowest vertical position and a vertical position of the sensing system.

In some aspects, determining the distance value further includes determining, using a stereoscopic distance algorithm, a preliminary distance value based on at least one of the first position or the second position; determining a lateral displacement value of the target based on a perceived lateral movement of the target within the sensing system FOV between the first position and the second position; and adjusting the preliminary distance value to the distance value based on the lateral displacement value.

In some aspects, the method 710 further includes determining a lateral angular displacement value based on the lateral displacement value, wherein the lateral angular displacement value results from maintaining the offset of the target from the optical axis of the sensing system FOV at the first time instance and the second time instance; and wherein adjusting the preliminary distance value based on the lateral displacement value further includes: adjusting, based on the lateral angular displacement value, the preliminary distance value in accordance with a covariant relationship between the preliminary distance value and the lateral angular displacement value.

In some aspects, the method 710 further includes determining a vertical displacement value of the target based on a perceived vertical movement of the target within the sensing system FOV between the first position and the second position; and adjusting a preliminary distance value to the distance value based on the vertical displacement value.

In some aspects, the method 710 further includes determining a vertical angular displacement value based on the vertical displacement value, wherein the vertical angular displacement value results from water surface oscillations at the first time instance and the second time instance; and wherein adjusting the preliminary distance value based on the vertical displacement value further includes: adjusting, based on the vertical angular displacement value, the preliminary distance value in accordance with a covariant relationship between the preliminary distance value and the vertical angular displacement value.

In some aspects, the covariant relationship between the preliminary distance value and the lateral angular displacement value is a first covariant relationship, the covariant relationship between the preliminary distance value and the vertical angular displacement value is a second covariant relationship, and the method 710 further includes adjusting the preliminary distance value based on (i) the first covariant relationship and (ii) the second covariant relationship.

In some aspects, the offset is between approximately 2° to approximately 7° from the optical axis of the sensing system FOV. In some aspects, the first IR FOV represents at least 65° of visibility and the second IR FOV represents less than 55° of visibility.

In some aspects, the sensing system includes at least one monochrome image sensor and at least one multi-color sensor. Generally, removing color filters from a typical color sensor increases the total incident light by up to approximately a factor of five, which significantly improves the imaging resolution, especially at distance and in lower light conditions. Moreover, the techniques of the present disclosure may partially recover chroma information by superimposing the information from other sensors, including lower resolution sensors.

In some aspects, the at least one monochrome image sensor has a wider FOV than the at least one multi-color sensor; or the at least one monochrome image sensor has a narrower FOV than the at least one multi-color sensor.

In some aspects, a first edge of the first IR FOV is oriented to be substantially parallel with a second edge of the second IR FOV.

In some aspects, an overlap point between the first IR FOV and the second IR FOV is less than approximately ten meters from a front surface of the AMSV.

In some aspects, the method 710 further includes determining a thermal expansion value corresponding to thermal expansion of one or more materials including a support structure of the sensing system; and applying, by the one or more processors, the perception algorithm to (i) the data representing the radiation and (ii) the thermal expansion value to detect the one or more objects indicated by the data.

In some aspects, the method 710 further includes maneuvering the AMSV between a first lateral position relative to the one or more objects and a second lateral position relative to the one or more objects to create a synthetic baseline for the sensing system; and detecting the one or more objects based on a synthetic disparity resulting from the synthetic baseline.

In some aspects, the sensing system is a passive sensing system excluding any active sensing system.

Of course, it is to be appreciated that the actions of the method 710 may be performed any suitable number of times, and that the actions described in reference to the method 710 may be performed in any suitable order.

FIG. 7C depicts a third flow diagram representing another example computer-implemented method 730, in accordance with various embodiments described herein. The method 730 may be implemented by one or more processors of the AMSV 200, such as the processors 222 executing the LSA module 232 and/or other hardware/software of the AMSV 200 (e.g., passive sensing system 212), for example.

The method 730 includes sensing radiation from an external environment of the AMSV using a sensing system (block 732). The method 730 further includes applying a perception algorithm to data representing the radiation to detect one or more objects indicated by the data (block 734). The method 730 further includes determining that at least one object of the one or more objects indicated by the data represents a target (block 736). The method 730 further includes orienting the AMSV to offset the target from an optical axis of a sensing system field of view (FOV) of the sensing system (block 738).

In some aspects, the sensing system includes at least a stereovision IR camera with (i) a first IR image sensor with a first IR FOV and (ii) a second IR image sensor with a second IR FOV.

In some aspects, the first IR FOV has a first optical axis and the second IR FOV has a second optical axis that is not parallel with the first optical axis.

In some aspects, the sensing system includes at least two electro-optical (EO) image sensors including a first EO image sensor with a first EO FOV and a second EO image sensor with a second EO FOV.

In some aspects, the method 730 further includes determining that the at least one object represents the target by performing image segmentation on the data.

In some aspects, performing image segmentation on the data includes determining one or more segmentation masks associated with the one or more objects, and wherein the perception method further includes: identifying a target within the one or more objects based on the one or more segmentation masks.

In some aspects, the method 730 further includes determining a lowest pixel associated with the target that has a lowest vertical position value of pixels corresponding to the target; and determining a distance value of the target from the AMSV based on (i) depth data derived from a disparity of the sensing system and (ii) a height differential between the lowest vertical position and a vertical position of the sensing system.

In some aspects, the method 730 further includes identifying the target within sensed data from the sensing system at (i) a first time instance and (ii) a second time instance that is different from the first time instance; and determining a distance value of the target from the AMSV by comparing a first position of the target at the first time instance with a second position of the target at the second time instance.

In some aspects, the method 730 further includes determining at least one of (i) a target orientation or (ii) a target speed of the target based on identification of the target at the first time instance and the second time instance.

In some aspects, the method 730 further includes adjusting at least one of: (i) an AMSV orientation or (ii) an AMSV speed of the AMSV based on the target orientation or the target speed.

In some aspects, the method 730 further includes determining the distance value by determining, using a stereoscopic distance algorithm, a preliminary distance value based on at least one of the first position or the second position; determining a lateral displacement value of the target based on a perceived lateral movement of the target within the sensing system FOV between the first position and the second position; and adjusting the preliminary distance value to the distance value based on the lateral displacement value.

In some aspects, the method 730 further includes determining a lateral angular displacement value based on the lateral displacement value, wherein the lateral angular displacement value results from maintaining the offset of the target from the optical axis of the sensing system FOV at the first time instance and the second time instance; and wherein adjusting the preliminary distance value based on the lateral displacement value further includes: adjusting, based on the lateral angular displacement value, the preliminary distance value in accordance with a covariant relationship between the preliminary distance value and the lateral angular displacement value.

In some aspects, the method 730 further includes determining a vertical displacement value of the target based on a perceived vertical movement of the target within the sensing system FOV between the first position and the second position; and adjusting a preliminary distance value to the distance value based on the vertical displacement value.

In some aspects, the method 730 further includes determining a vertical angular displacement value based on the vertical displacement value, wherein the vertical angular displacement value results from water surface oscillations at the first time instance and the second time instance; and wherein adjusting the preliminary distance value based on the vertical displacement value further includes: adjusting, based on the vertical angular displacement value, the preliminary distance value in accordance with a covariant relationship between the preliminary distance value and the vertical angular displacement value.

In some aspects, the covariant relationship between the preliminary distance value and the lateral angular displacement value is a first covariant relationship, the covariant relationship between the preliminary distance value and the vertical angular displacement value is a second covariant relationship, and the method 730 further includes adjusting the preliminary distance value based on (i) the first covariant relationship and (ii) the second covariant relationship.

In some aspects, the offset is between approximately 2° to approximately 7° from the optical axis of the sensing system FOV. In some aspects, the first IR FOV represents at least 65° of visibility and the second IR FOV represents less than 55° of visibility. In some aspects, the sensing system includes at least one monochrome image sensor and at least one multi-color sensor.

In some aspects, the at least one monochrome image sensor has a wider FOV than the at least one multi-color sensor; or the at least one monochrome image sensor has a narrower FOV than the at least one multi-color sensor.

In some aspects, one of the first IR FOV or the second IR FOV is oriented to have an optical axis that is angularly offset from an orientation of the AMSV. In some aspects, a first orientation of the first IR FOV is different than a second orientation of the second IR FOV.

In some aspects, a first edge of the first IR FOV is oriented to be substantially parallel with a second edge of the second IR FOV. In some aspects, an overlap point between the first IR FOV and the second IR FOV is less than approximately ten meters from a front surface of the AMSV.

In some aspects, the method 730 further includes determining a thermal expansion value corresponding to thermal expansion of one or more materials including a support structure of the sensing system; and applying, by the one or more processors, the perception algorithm to (i) the data representing the radiation and (ii) the thermal expansion value to detect the one or more objects indicated by the data.

In some aspects, the method 730 further includes maneuvering the AMSV between a first lateral position relative to the one or more objects and a second lateral position relative to the one or more objects to create a synthetic baseline for the sensing system; and detecting the one or more objects based on a synthetic disparity resulting from the synthetic baseline.

In some aspects, the sensing system is a passive sensing system excluding any active sensing system.

Of course, it is to be appreciated that the actions of the method 730 may be performed any suitable number of times, and that the actions described in reference to the method 730 may be performed in any suitable order.

FIG. 7D depicts a fourth flow diagram representing another example computer-implemented method 740, in accordance with various embodiments described herein. The method 740 may be implemented by one or more processors of the AMSV 200, such as the processors 222 executing the LSA module 232 and/or other hardware/software of the AMSV 200 (e.g., passive sensing system 212), for example.

The method 740 includes applying a perception algorithm to data representing radiation sensed by a sensing system from an external environment of the AMSV to detect one or more objects indicated by the data, the sensing system being a passive sensing system excluding any active sensing system (block 742). The method 740 further includes determining that at least one object of the one or more objects indicated by the data represents a target object (block 744).

The method 740 further includes, based on determining that the at least one object represents the target object, determining an AMSV path plan configured to cause the AMSV to intercept the target object (block 746). The method 740 further includes causing the AMSV to maneuver in accordance with the AMSV path plan and intercept the target object (block 748).

In some embodiments, the method 740 further includes determining, by the one or more processors, respective AMSV path plans for a plurality of AMSVs located at a plurality of different locations relative to the target object based on radiation sensed by respective sensing systems of each AMSV of the plurality of AMSVs, wherein each respective sensing system is a passive sensing system excluding any active sensing system; and causing, by the one or more processors, each AMSV of the plurality of AMSVs to maneuver in accordance with the respective AMSV path plans to intercept the target object.

In some embodiments, causing the AMSV to maneuver in accordance with the AMSV path plan further comprises: deactivating, by the one or more processors, all radio transceivers on-board the AMSV prior to intercepting the target object.

In some embodiments, the sensing system includes a stereovision infrared (IR) camera with (i) a first IR image sensor with a first IR field of view (FOV) having a first optical axis and (ii) a second IR image sensor with a second IR FOV having a second optical axis that is not parallel with the first optical axis, the stereovision IR camera configured to sense radiation from the external environment of the AMSV.

In some embodiments, the first optical axis is angled towards the second optical axis, and the second optical axis is angled towards the first optical axis, thereby creating a reduced blind spot near a front portion of the AMSV.

In some embodiments, the sensing system includes at least two electro-optical (EO) image sensors including a first EO image sensor with a first EO FOV and a second EO image sensor with a second EO FOV.

In some embodiments, the method 740 further includes orienting, by the one or more processors, the AMSV to offset the target object from an optical axis of a sensing system FOV of the sensing system.

In some embodiments, determining that the at least one object represents the target object by performing image segmentation on the data.

In some embodiments, performing image segmentation on the data includes determining one or more segmentation masks associated with the one or more objects, and wherein the method 740 further includes identifying, by the one or more processors, the target object within the one or more objects based on the one or more segmentation masks.

In some embodiments, the method 740 further includes determining, by the one or more processors, a lowest pixel associated with the target object that has a lowest vertical position value of pixels corresponding to the target object; and determining, by the one or more processors, a distance value of the target object from the AMSV based on (i) depth data derived from a disparity of the sensing system and (ii) a height differential between the lowest vertical position and a vertical position of the sensing system.

In some embodiments, the method 740 further includes identifying, by the one or more processors, the target object within sensed data from the sensing system at (i) a first time instance and (ii) a second time instance that is different from the first time instance; and determining, by the one or more processors, a distance value of the target object from the AMSV by comparing a first position of the target object at the first time instance with a second position of the target object at the second time instance.

In some embodiments, the method 740 further includes determining, by the one or more processors, at least one of (i) a target orientation or (ii) a target speed of the target object based on identification of the target object at the first time instance and the second time instance.

In some embodiments, the method 740 further includes adjusting, by the one or more processors, at least one of: (i) an AMSV orientation, (ii) an AMSV geospatial location, or (iii) an AMSV speed of the AMSV based on the target orientation or the target speed.

In some embodiments, determining the distance value further includes determining, using a stereoscopic distance algorithm, a preliminary distance value based on at least one of the first position or the second position; determining, by the one or more processors, a lateral displacement value of the target object based on a perceived lateral movement of the target object within the sensing system FOV between the first position and the second position; and adjusting, by the one or more processors, the preliminary distance value to the distance value based on the lateral displacement value.

In some embodiments, the method 740 further includes determining, by the one or more processors, a lateral angular displacement value based on the lateral displacement value, wherein the lateral angular displacement value results from maintaining the offset of the target object from the optical axis of the sensing system FOV at the first time instance and the second time instance; and wherein adjusting the preliminary distance value based on the lateral displacement value further includes adjusting, based on the lateral angular displacement value, the preliminary distance value in accordance with a covariant relationship between the preliminary distance value and the lateral angular displacement value.

In some embodiments, the method 740 further includes determining, by the one or more processors, a vertical displacement value of the target object based on a perceived vertical movement of the target object within the sensing system FOV between the first position and the second position; and adjusting, by the one or more processors, a preliminary distance value to the distance value based on the vertical displacement value.

In some embodiments, the method 740 further includes determining, by the one or more processors, a vertical angular displacement value based on the vertical displacement value, wherein the vertical angular displacement value results from water surface oscillations at the first time instance and the second time instance; and wherein adjusting the preliminary distance value based on the vertical displacement value further includes adjusting, based on the vertical angular displacement value, the preliminary distance value in accordance with a covariant relationship between the preliminary distance value and the vertical angular displacement value.

In some embodiments, the covariant relationship between the preliminary distance value and the lateral angular displacement value is a first covariant relationship, the covariant relationship between the preliminary distance value and the vertical angular displacement value is a second covariant relationship, and wherein the method 740 further includes adjusting, by the one or more processors, the preliminary distance value based on (i) the first covariant relationship and (ii) the second covariant relationship.

In some embodiments, the offset is between approximately 2° to approximately 7° from the optical axis of the sensing system FOV.

In some embodiments, the first IR FOV represents at least 65° of visibility and the second IR FOV represents less than 55° of visibility.

In some embodiments, the sensing system includes at least one monochrome image sensor and at least one multi-color sensor.

In some embodiments, the method 740 further includes the at least one monochrome image sensor has a wider FOV than the at least one multi-color sensor; or the at least one monochrome image sensor has a narrower FOV than the at least one multi-color sensor.

In some embodiments, a first edge of the first IR FOV is oriented to be substantially parallel with a second edge of the second IR FOV.

In some embodiments, an overlap point between the first IR FOV and the second IR FOV is less than approximately ten meters from a front surface of the AMSV.

In some embodiments, the method 740 further includes determining, by the one or more processors, a thermal expansion value corresponding to thermal expansion of one or more materials comprising a support structure of the sensing system; and applying, by the one or more processors, the perception algorithm to (i) the data representing the radiation and (ii) the thermal expansion value to detect the one or more objects indicated by the data.

In some embodiments, the method 740 further includes maneuvering the AMSV between a first lateral position relative to the one or more objects and a second lateral position relative to the one or more objects to create a synthetic baseline for the sensing system; and detecting, by the one or more processors, the one or more objects based on a synthetic disparity resulting from the synthetic baseline.

FIG. 7E depicts a fifth flow diagram representing another example computer-implemented method 750, in accordance with various embodiments described herein. The method 750 may be implemented by one or more processors of the AMSV 200, such as the processors 222 executing the LSA module 232 and/or other hardware/software of the AMSV 200 (e.g., passive sensing system 212), for example.

The method 750 includes maneuvering one or more AMSVs of the group of AMSVs between a respective first lateral position relative to one or more objects located within a group FOV and a respective second lateral position relative to the one or more objects to create a respective synthetic baseline for the one or more AMSVs (block 752). The group FOV may comprise respective FOVs of each AMSV in the group of AMSVs. The method 750 further includes receiving respective indications of radiation sensed by respective sensing systems of the one or more AMSVs (block 754). The method 750 further includes applying a perception algorithm to data representing the respective indications of radiation to detect the one or more objects indicated by the data based on a respective synthetic disparity resulting from the respective synthetic baseline for the one or more AMSVs, thereby optimizing detection of the one or more objects (block 756).

The method 750 further includes, based on detecting the one or more objects, determining a respective control instruction for at least a subset of the group of AMSVs, the respective control instruction indicating a respective change to at least one of: (i) a respective orientation, (ii) a respective geospatial location, or (iii) a respective speed of each AMSV comprising the subset of the group of AMSVs (block 758). The method 750 further includes transmitting the respective control instruction to the each AMSV of the subset (block 760).

In some embodiments, the one or more AMSVs comprises a plurality of AMSVs.

In some embodiments, each respective sensing system includes a stereovision infrared (IR) camera with (i) a first IR image sensor with a first IR field of view (FOV) having a first optical axis and (ii) a second IR image sensor with a second IR FOV having a second optical axis that is not parallel with the first optical axis, the stereovision IR camera configured to sense radiation from a respective external environment of the one or more AMSVs.

In some embodiments, the first optical axis is angled towards the second optical axis, and the second optical axis is angled towards the first optical axis, thereby creating a reduced blind spot near a front portion of the one or more AMSVs.

In some embodiments, the method 750 further includes determining, by the one or more processors, respective AMSV path plans for a plurality of AMSVs located at a plurality of different locations relative to a target object of the one or more objects based on radiation sensed by respective sensing systems of each AMSV of the plurality of AMSVs, wherein each respective sensing system is a passive sensing system excluding any active sensing system; and causing, by the one or more processors, each AMSV of the plurality of AMSVs to maneuver in accordance with the respective AMSV path plans to intercept the target object.

In some embodiments, causing each AMSV to maneuver in accordance with the respective AMSV path plans further includes deactivating all radio transceivers on-board the each AMSVs prior to intercepting the target object.

In some embodiments, one or more sensing systems of the respective sensing systems include at least two electro-optical (EO) image sensors including a first EO image sensor with a first EO FOV and a second EO image sensor with a second EO FOV.

In some embodiments, the method 750 further includes orienting at least one AMSV to offset a target object of the one or more objects from an optical axis of a sensing system FOV of the respective sensing system of the at least one AMSV.

In some embodiments, the method 750 further includes determining, by the one or more processors, that at least one object represents a target object by performing image segmentation on the data.

In some embodiments, wherein performing image segmentation on the data includes determining one or more segmentation masks associated with the one or more objects, and wherein the method 750 further includes identifying, by the one or more processors, the target object within the one or more objects based on the one or more segmentation masks.

In some embodiments, the method 750 further includes determining, by the one or more processors, a lowest pixel associated with the target object that has a lowest vertical position value of pixels corresponding to the target object; and determining, by the one or more processors, a distance value of the target object from each of the respective AMSVs based on (i) depth data derived from the respective synthetic disparity of the respective sensing systems and (ii) a height differential between the lowest vertical position and a vertical position of the respective sensing systems.

In some embodiments, the method 750 further includes identifying, by the one or more processors, the target object within sensed data from the respective sensing systems at (i) a first time instance and (ii) a second time instance that is different from the first time instance; and determining, by the one or more processors, a distance value of the target object from each of the respective AMSVs by comparing a first position of the target object at the first time instance with a second position of the target object at the second time instance.

In some embodiments, the method 750 further includes determining, by the one or more processors, at least one of (i) a target orientation or (ii) a target speed of the target object based on identification of the target object at the first time instance and the second time instance.

In some embodiments, the method 750 further includes adjusting at least one of: (i) an AMSV orientation, (ii) an AMSV geospatial location, or (iii) an AMSV speed of the one or more AMSVs based on the target orientation or the target speed.

In some embodiments, determining the distance value further includes determining, using a stereoscopic distance algorithm, a preliminary distance value based on at least one of the first position or the second position; determining, by the one or more processors, a lateral displacement value of the target object based on a perceived lateral movement of the target object within the sensing system FOV between the first position and the second position; and adjusting, by the one or more processors, the preliminary distance value to the distance value based on the lateral displacement value.

In some embodiments, the method 750 further includes determining, by the one or more processors, a lateral angular displacement value based on the lateral displacement value, wherein the lateral angular displacement value results from maintaining the offset of the target object from the optical axis of the sensing system FOV at the first time instance and the second time instance; and wherein adjusting the preliminary distance value based on the lateral displacement value further includes adjusting, based on the lateral angular displacement value, the preliminary distance value in accordance with a covariant relationship between the preliminary distance value and the lateral angular displacement value.

In some embodiments, the method 750 further includes determining, by the one or more processors, a vertical displacement value of the target object based on a perceived vertical movement of the target object within the sensing system FOV between the first position and the second position; and adjusting, by the one or more processors, a preliminary distance value to the distance value based on the vertical displacement value.

In some embodiments, the method 750 further includes determining, by the one or more processors, a vertical angular displacement value based on the vertical displacement value, wherein the vertical angular displacement value results from water surface oscillations at the first time instance and the second time instance; and wherein adjusting the preliminary distance value based on the vertical displacement value further includes adjusting, based on the vertical angular displacement value, the preliminary distance value in accordance with a covariant relationship between the preliminary distance value and the vertical angular displacement value.

In some embodiments, the covariant relationship between the preliminary distance value and the lateral angular displacement value is a first covariant relationship, the covariant relationship between the preliminary distance value and the vertical angular displacement value is a second covariant relationship, and the method 750 further includes adjusting, by the one or more processors, the preliminary distance value based on (i) the first covariant relationship and (ii) the second covariant relationship.

In some embodiments, the offset is between approximately 2° to approximately 7° from the optical axis of the sensing system FOV.

In some embodiments, the first IR FOV represents at least 65° of visibility and the second IR FOV represents less than 55° of visibility.

In some embodiments, the one or more of the respective sensing systems include at least one monochrome image sensor and at least one multi-color sensor.

In some embodiments, the method 750 further includes the at least one monochrome image sensor has a wider FOV than the at least one multi-color sensor; or the at least one monochrome image sensor has a narrower FOV than the at least one multi-color sensor.

In some embodiments, a first edge of the first IR FOV is oriented to be substantially parallel with a second edge of the second IR FOV.

In some embodiments, an overlap point between the first IR FOV and the second IR FOV is less than approximately ten meters from a front surface of the AMSV.

In some embodiments, the method 750 further includes determining, by the one or more processors, a thermal expansion value corresponding to thermal expansion of one or more materials comprising a support structure of one or more of the respective sensing systems; and applying, by the one or more processors, the perception algorithm to (i) the data representing the radiation and (ii) the thermal expansion value to detect the one or more objects indicated by the data.

### Control Interfaces for Autonomous Vehicles

FIGS. 8A-8Q depict exemplary control interfaces for controlling one or more autonomous vehicles (“AVs” or “assets”) (such as the AMSVs described herein). With reference to FIG. 3B, the control interfaces may, for example, be embodied in the mission definition module 351b of the Mobile Control System 340, or may be embodied as part of the mission control system 335. They may operate on user devices as local instances of software communicating with a local (i.e., on a local network or device) server or a cloud-based server. Alternatively, the control interfaces may be web-based internet applications served by a cloud-based server. In any event, the control interfaces allow a user to provide control inputs to individual AVs and/or to one or more groups of AVs that are operating in a coordinated fashion. The control inputs can be navigation inputs, targeting inputs, or other inputs designed to position the controlled AVs for observation or interception purposes, and may include any number of parameters, as will be understood in view of the following description.

FIG. 8A depicts an example of a two-dimensional graphical user interface (GUI) 800 for controlling AVs. In the interface 800, individual AVs 802a-c are depicted with corresponding indicators 803a-c indicating the field of view for each AV (e.g., via its passive remote sensing system 212). Two detected objects 804a and 804b are also depicted in the GUI 800, with arrows 805 indicating the direction of travel of each. In FIG. 8A, the detected object 804a is depicted in a first color (indicated by stippling) to indicate that the detected object 804a is a target object. In embodiments, the fact of the detected object 804a being a target may be indicated by the user through the interface, automatically identified by the software on the AV (e.g., by the SSA module 235 and/or the LSA module 232, etc.), or some combination of the two. A user of the GUI 800 may click on any one of the AMSVs 802a-c and may direct the AV to a particular point though a user input (e.g., by dragging it, by clicking on a point on the display 800 subsequent to clicking on the AV, by entering specific coordinates into a data entry field (not shown in FIG. 8A), etc.). A user of the GUI 800 may also select a group of AVs 802a-c and may direct the group to a particular point through a similar user input.

While depicted in FIG. 8A as having a generic background 801, the background 801 on which the AVs 802a-c and detected objects 805 are depicted may, in embodiments, be a map (which may, in embodiments, include a map such as a marine navigation chart indicating underwater obstructions, channel depths, and the like). In such embodiments, the user may select one or more of the AVs 802a-c and may direct the one or more selected AVs to a point on the map. In some embodiments, the user interface may utilize the map (or stored navigational charts or maps separate from that displayed) to determine a safe route for the one or more AVs to traverse the environment (e.g., the water) from the current location of the AVs to the indicated destination, and may do so, in some embodiments, by setting one or more waypoints through which the selected AVs should pass along the route to the destination point indicated by the user.

FIG. 8B depicts another example AV graphical user interface (GUI) 800a that could be used for target object interception and includes path plans for multiple AVs. The AV target object interception GUI 800A generally depicts a plurality of AVs 806a-c located around a target object 807 with various AV path plans 808a, 808b for intercepting the target object 807. The AV target object interception GUI 800a further includes a first AMSV interception angle panel 809, a second AV interception angle panel 810, an add AV interactive button 811, and an add time interactive button 812.

The path planning illustrated in the AV target object interception GUI 800a may be performed locally on an AV, such as the first AV 806c or the second AV 806a, and/or may be performed by a host device (e.g., MCS 18). For example, the first AV 806c may receive geospatial locations, headings/orientations, speeds, and/or other data of the target object, and may additionally receive similar information corresponding to the other AVs 806a, 806b. The first AV 806c may also receive one or more AV paths, such as the second AV path plan 808b from the second AV 806a and may determine the first AV path plan 808a to intercept the target object 807.

The first AV interception angle panel 809 and the second AV interception angle panel 810 indicate where a user may choose a desired intercept angle, and the systems described herein may determine a suitable AV path plan. If the user determines that additional AVs should or would be included as part of a particular group mission/plan, then the user may interact with the add AV interactive button 811, which may add another AV (e.g., AV 806b) to the diagram and enable the user to further specify the intercept angle for that new AV. Moreover, the add time interactive button 812 may allow a user to specify a desired intercept time or sequence for one or more of the AVs. For example, the user may interact (e.g., click, tap, swipe, gesture, voice command) with the add time interactive button 812, and may specify that all illustrated AVs should simultaneously (or nearly simultaneously) intercept the target object 807. In response, the systems described herein may adjust the AV path plans accordingly to ensure that each depicted AV intercepts the target object 807 nearly simultaneously.

In still other embodiments, such as that depicted in FIG. 8C, the graphical user interface for controlling one or more AVs may depict a three-dimensional environment (i.e., a three-dimensional depiction on a two-dimensional screen). FIG. 8C depicts a GUI control interface 813 implementing a three-dimensional representation. The GUI 813 depicts multiple AVs 814a-c. Each of the AVs 814a-c is depicted as a representation of the corresponding real-world vehicle. That is, the vehicles depicted in the GUI 813 may be presented visually in a pictorial manner such that the AVs 814a-c on the GUI 813 are visually identifiable as the corresponding vehicle-type. Additionally, and as depicted in FIG. 8C, the AVs 814a-c may be depicted in the GUI 813 in a manner that depicts graphically the relative positions and headings of each of the AVs 814a-c. In embodiments where the AVs are marine vehicles, the GUI 813 may also depict, for each AV 814a-c, a sea state 815a-c. In embodiments, the sea state 815a-c depicts a general energy level of the local sea state for the AV, which may be derived from observations on the AV. For example, the observations may be from one or more inertial measurement units on the vehicle, from one or more accelerometers on the vehicle, and/or from the passive remote sensing system 212. In embodiments, the sea state 815a-c may depict more specific sea-state information, such as the wave period and direction. The GUI 813 may also depict the real-time motion of the AV in the environment (e.g., in the water), using information from the inertial measurement units and other sensors on the vehicle. In this way, a user of the GUI 813 can visualize the reaction of the AV to its surroundings and trajectory. For instance, the user is able to see whether the vehicle is experiencing repeated bow shocks due to heavy waves and can adjust the velocity or trajectory of the vehicle accordingly. The GUI 813 implementing a three-dimensional view, like the GUI 800 depicted in FIG. 8A, may also depict the field of view 816a-c of each vehicle's passive remote sensing system 212.

In a manner similar that described with respect to FIGS. 8A and 8B, the GUI 813 depicted in FIG. 8C may allow a user to direct one or more of the AVs 814a-c by selecting one or more of the AVs 814a-c and then inputting a destination. The selection of the one or more AVs may be accomplished by clicking on individual ones of the AVs (e.g., by using control to select more than one AV), by selecting AVs from a menu (not depicted in FIG. 8C) on the GUI, and/or clicking and dragging to select a group of displayed AVs. The input of the destination may similarly be accomplished by selecting a destination location using a mouse input and/or by entering a destination (e.g., latitude/longitude) on an input field (not shown in FIG. 8C) on the GUI. The GUI 813 depicts the various routes in progress for each vehicle, in addition to facilitating the selection of destinations. In FIG. 8C, a user selects a destination for the AV 814b, as indicated by a line 817 extending from the AV 814b to an indicated destination 818. Once a destination is selected for an AV, the AV may navigate to that destination autonomously, avoiding detected obstacles as it goes. A line 819 in FIG. 8C depicts a route in progress for the AV 814A, which jogs to avoid coming within a predetermined distance of the AV 814b (i.e., to avoid an obstacle).

As with FIG. 8A, FIG. 8C is depicted as having a generic background 820, the background 820 on which the AVs 814a-c are depicted may, in embodiments, be a map (which may, in embodiments, include a map such as a marine navigation chart indicating underwater obstructions, channel depths, and the like). In such embodiments, the user may select one or more of the AVs 814a-c and may direct the one or more selected AVs to a point on the map. In some embodiments, the user interface may utilize the map (or stored navigational charts or maps separate from that displayed) to determine a safe route for the one or more AVs to traverse the environment from the current location of the AVs to the indicated destination, and may do so, in some embodiments, by setting one or more waypoints through which the selected AVs should pass along the route to the destination point indicated by the user.

FIG. 8D illustrates additional visual elements of the GUI 813. A target vessel 821 may be visualized in a specific color (e.g., red) or with special markings to indicate that the system has identified the object as a target. An AV 822, commanded to intercept the target 821, is depicted with two lines 823a and 823b extending from the AV 822 to a destination point 821a adjacent to the target 821. The lines 823a and 823b may be different colors and/or may be different line types (e.g., dashed and solid) and/or may be different weights. In any event, the line 823a indicates an initially planned “mission” between a current position and a destination 821a, while the line 823b indicates the route that the AV 822 will take based on obstacles that are between the current position of the AV 822 and the destination point 821a. In FIG. 8D, an additional indicator 824 indicates a zone of influence within which a payload (not shown) on the AV 822 may have a desired effect on the target vessel 821.

The GUIs 800, 813 may be a sub-portion of a larger GUI, as depicted in, and described with respect to, FIGS. 8E-8O. With reference first to FIG. 8E, a GUI 825 may be composed of a situational awareness panel 826, an object panel 827, and a control panel 828. As described above with respect to the GUIs 800 and 813, the situational awareness panel 826 depicts—in two or three dimensions (three dimensions in the situational awareness panel 826 of FIG. 8E)—the real-time situation in a space. This may include, by way of example and not limitation, assets (i.e., AVs) within the control of the user or the user's organization, detected objects (“tracks”), targets, the known and/or predicted paths of assets and tracks, mission waypoints, sea-states, asset states, asset fields of view, and the like, as described above. A user may perform a variety of view adjustments within the situational awareness panel 826, including zooming in or out and panning in any direction. Additionally, in three-dimensional representations, such as that depicted in FIGS. 8C-8O, the user may adjust the elevation and/or rotation of the view so that the space may be viewed from essentially any angle. FIG. 8E illustrates a situational awareness panel 826 that has includes satellite data superimposed on the space, such that the user can see where assets and tracks are in the space with respect to landmasses. In embodiments, a button 826b allows a user to add or switch overlay information displayed in the situational awareness panel 826. Overlay information may include navigational charts, maps, satellite information, or other information as desired.

The object panel 827 displays tracks (i.e., detected objects) and assets (e.g., AVs) that are presently displayed in the situational awareness panel 826. Each track and/or asset may be displayed with an identifier, if known (e.g., for assets), a vehicle type, if known, a representative image, and other various information about the status of the asset or track, such as whether the asset is currently on a mission, whether the asset has a GPS lock, and summary information about the asset or track's current position, current heading, current speed, battery/fuel reserve, and communication status. The object panel 827 may be used to select (e.g., by clicking with a mouse or touching a touch-screen) an asset or track or a group of assets or tracks. Of course, assets and tracks may also be selected by clicking on the assets or tracks, or dragging a box around the assets or tracks, in the situational awareness panel 826, as described above. Buttons 827b in the object panel 827 facilitate easy filtering between assets and tracks, in embodiments.

The control panel 828 allows the user to command, control, and monitor selected assets (e.g., AMSVs). In FIG. 8E, an asset cr-sim is selected, as indicated by the outlined box 827a in the object panel 827 and by a selection box 826a surrounding the AMSV in the situational awareness panel 826. The control panel 828 displays information about, and controls related to, the selected AMSV cr-sim. A set of indicators 828a in the control panel 828 show the speed, heading, and battery/fuel reserve information for the asset. It should be recognized, in particular with respect to the indicator labeled “battery” in the set of indicators 828a, that depending on the asset (e.g., whether the asset is battery powered, combustion powered, or some combination), the indicator may show battery reserve, remaining battery operational life based on current use, fuel reserve, remaining range based on current fuel consumption, and/or other related data. A panel 828b, expandable to a wider window, may allow the user to select one or more cameras on the asset to view real-time video streamed from the camera(s). A set of controls 828c in the control panel 828 may allow the user to activate and/or manipulate cameras on the displayed asset. For example, on an asset with both electro-optical and infrared camera systems, each system may be activated or deactivated independently, in embodiments, and cameras with pan-tilt-zoom (PTZ) capability may also be actuated via the control panel interface.

FIG. 8F illustrates additional controls within the control panel 828. The control panel 828 may include a control 828d (which may cooperate with the control 828b) that opens a camera control panel 829. The camera control panel 829 may include a camera view 829a that displays a selected camera feed from a selected camera of a selected asset. For example, with reference to FIG. 8F, the camera view 829a shows a video feed from IR camera 6 (selected in the camera control panel 829) of selected asset cr-sim. At the same time, in embodiments, the user can choose to display the camera feed within the situational awareness panel 826, and the camera feed may be displayed as an overlay to the field of view indicator 826b for the associated selected camera. Turning to FIG. 8G, within the situational awareness panel 826, users may opt, in various embodiments, to display, for one or more cameras associated with a depicted asset, the live camera feed for the camera. Thus, an asset 830, which may have multiple cameras, may be illustrated in the situational awareness panel 826 as having multiple fields of view 830a, 830b. While illustrated in FIG. 8G as having two fields of view 830a, 830b, certain assets may have more or fewer cameras, may have multiple cameras with overlapping fields of view (e.g., electro-optical and infrared cameras). In such cases, the user may determine which cameras are shown with the asset 830. By way of example, the user may choose to show front- and rear-facing cameras, as illustrated in FIG. 8G, and may choose a front-facing EO camera (such as associated with the field of view indicator 830a) and a rear-facing IR camera (such as associated with the field of view indicator 830b). The user may also choose to overlay on each of the field of view indicators the live camera feed from the associated camera, as depicted in FIG. 8G.

FIG. 8H illustrates additional features of the control panel 828. A mission definition control 828e facilitates defining of a mission for a selected asset or group of assets. The mission definition control 828e allows a user to enter a destination and, if desired, a series of waypoints to traverse en route to the destination. Selecting (i.e., clicking or tapping) on the “Waypoint” control 828h, opens a waypoint mission window 831, as illustrated in FIG. 8I. The user may then add and define a destination and/or a series of waypoints 831a-c that will be traversed by the selected asset(s) upon selection of a “begin mission” control 831d. For each waypoint 831a-c, the user may also define a speed mode 831e (e.g. eco, for conserving battery/fuel; cruise, for fastest traversal; etc.) and a communication mode (i.e., enabling or disabling various communication modes/transceivers) for the traversal to the waypoint. The user may select to specify the destination, as well as the waypoints, according to exact location (e.g., latitude/longitude) or according to relative location (e.g., heading and distance from the asset's current location). With the waypoints set, the waypoint control 828h displays mission information 831g, such as a total distance of the mission, a total time of the mission, and an estimated time of completion. At the same time, the situational awareness panel 826 displays the waypoints relative to the selected (assets).

In instances where multiple assets are selected to move together, the waypoint mission window 831 may display additional fields (not shown) that allow the user to set, for example, minimum distances to be maintained between the assets, follow distances, formations, etc.

Of course, as described above, the user can set a destination by selecting an asset in the situational awareness panel 826, and selecting a position in the situational awareness panel 826 as the destination. Similarly, the user may set waypoints within the situational awareness panel 826 by, for example, right-clicking (bringing up a context menu) and selecting “waypoint selection” (or something similar) and selecting waypoints within the panel 826. In embodiments, waypoints may also be changed/moved by selecting and dragging them within the panel 826.

Referring again to FIG. 8H, the control panel 828 may also include a mode selection 828f, in embodiments. While one could of course program various modes, some modes contemplated within the scope of the invention include an “autopilot” mode, in which the selected asset will navigate according to the waypoints and destination selected by the user, a “hold” mode, in which the selected asset will initiate a holding pattern around the asset's location at the time the hold is initiated, and a “manual” mode, which would allow the user to assume direct control over the propulsion systems to control the asset manually. Of course, it is contemplated that in some embodiments, an asset may be placed into “manual” or “hold” modes during a mission already underway and, upon being placed back into “autopilot” mode, may resume the mission already in progress.

The control panel 828 may also include a “comms” control 828g that allows the user to enable or disable the various communication platforms (e.g., cellular, satellite, etc.) for the selected asset(s).

In embodiments, the system is operable to facilitate autonomous navigation of one or more assets such that the assets safely traverse a space from a current position to a destination via a plurality of waypoints that the user does not explicitly select. This is illustrated with respect to FIGS. 8J and 8K. In FIG. 8J, the user selects an asset (cr-sim) indicated by a selection box 832 either by selecting the asset within the situational awareness panel 826 or by selecting an asset from the object panel 827. The user may then set a destination waypoint in the waypoint mission window 831, or may select a point 832a within the situational awareness panel 826 as the destination. A line 833, between the indicated selected asset 832 and the selected destination 832a, shows the most direct path between the current location of the selected asset and the selected destination 832a. However, in FIG. 8J, there is a land mass 834 between the asset and the selected destination 832a. In the case of a water-borne asset, such as an AMSV, the land mass 834 is not traversable and, as such, the asset must navigate to the selected destination 832a in a non-direct route. Through a process described further below, a series of waypoints 832b-h, traversable by the asset (in this case, via the water) is determined and depicted within the situational awareness panel 826 and within the waypoint mission window 831.

As alluded to above, the control panel 828 includes not just information about assets, but also about tracks (detected objects, targets, etc.) that are in the vicinity of the assets. FIG. 8L illustrates a tracking panel 835 that provides information about, and options with respect to, various tracks detected by the asset(s). The tracking panel 835, may include, for each track, a track identifier 835a, a track image 835b (e.g., a still image or a live camera feed of the tracked object), and track data 835c. The track data 835c may include, for instance, the current location of the tracked object, the speed of the tracked object, the heading of the tracked object, and which asset(s) are currently tracking the object. At the same time, the tracks may be visible (selectively, in embodiments) on the situational awareness panel 826 and, in particular, may be depicted in a color or other indication that sets the tracks apart from the assets so that the user may readily distinguish between the assets and the tracks. Controls 835d may allow the user to select to have the selected asset(s) follow or intercept a particular track. In embodiments, the user may similarly invoke following or interception behavior for a selected asset by selecting a track and using a context menu (e.g., right-clicking) to select a follow or intercept behavior. When follow or intercept behavior is invoked for a selected asset with respect to a selected track, additional settings 835e (e.g., follow settings or intercept settings) may become available, as depicted in FIG. 8M. In FIG. 8M, a selected asset 837 (indicated by a selection indicator 832) is following a track 838, as indicated by a line 839. The controls 835d, in which a “follow” control was previously selected (or invoked via the situational awareness panel 826) now shows an “end follow” control that would allow the user to stop the asset 837 from following the track 838. The additional settings 835e allow the user to set a follow distance and angle from the track, which may be used to maintain a distance at which the asset is undetectable or safe from interference or aggression by the track. In intercept mode, the additional settings 835e may include intercept angle, intercept time (relative or absolute), intercept speed, or other settings relevant to an interception.

FIGS. 8N-8Q are block diagrams illustrating data flows between the GUI and various components of the system. In embodiments, the GUI receives near real-time (e.g., delayed only by communication latency and intermediary processing, as will be described below) data from the assets. FIGS. 8N and 8O depict, respectively, data flows of track data and telemetry data from the assets to the GUI. In FIG. 8N, a data flow 840 illustrates that track data 841 is transmitted by the assets 842 to a track fuser 843. As described above, each of the assets 842 has its own local situational awareness (LSA) module 232 that uses data from its passive remote sensing system 212 to detect and classify objects and determine the heading and speed of each. Each of the assets 842 transmits the detected tracks, directly (e.g., via a satellite link) or indirectly (e.g., via an MCS 844) to the tracker fuser 843. In embodiments, the track fuser 843 is part of an active swarm situational awareness (SSA) module 235 operating on one of the assets 842 or in the MCS 844. In other embodiments, the track fuser 843 is a routine operating in a server (e.g., local or cloud-based) with which the MCS 844 and assets 842 are in communication. In either event, where the track fuser 843 receives tracks for the same object from different assets, the track fuser 843 uses the data to determine a “fused” track based on the available data. The track fuser 843 sends the fused track data 845 through an MCS Bridge routine 846 (which may be part of a local or cloud-based server, for example) that serves, in part, as an interface between the GUI 847 and the device on which the track fuser 843 is operating.

The MCS Bridge routine 846 also serves as an interface between the assets 842 and the GUI 847. Turning to FIG. 8O, a data flow 848 illustrates that telemetry data 849 is transmitted by the assets 842 directly to the MCS bridge routine 846, which transmits the telemetry data 849 directly to the GUI 847. The telemetry data transmitted by each asset 842 includes, by way of example and not limitation, speed data, heading data, fuel/battery reserve data, position data, attitude data (e.g., pitch, roll, yaw, G-force, etc. determined by the asset's inertial measurement unit and other sensors), sea-state data, and video feed data from the passive remote sensing system 212.

It should be noted that, in some embodiments, the MCS bridge 846 may execute on a local server running on the same network, or on the same device, as the GUI 847. The telemetry data 849 and the track data 841 transmitted by the assets 842, and the control commands and data sent from the GUI 847 to the assets 842, may be transmitted via the cloud as described above, but may also be transmitted directly in certain implementations. By way of example, and not limitation, the MCS Bridge routine 846 could execute on a processor of the MCS device 340. The MCS device 340 may communicate directly (via direct wireless (e.g., line-of-sight) communicative connections) with some or all of the assets 842, may communicate with some or all of the assets 842 via indirect communication (e.g., via satellite, mobile telephony, the internet, or some combination), or via both direct and indirect methods. In such embodiments, the server executing on the MCS device 340 and, in particular, the MCS Bridge routine 846 may receive data directly from the assets 842 via a radio-frequency line-of-sight connection, and the MCS Bridge routine 846 may communicate that data to the GUI 847, which could also be operating on the MCS device 340 (or another local device).

A data flow 850 from the GUI 847 back to the assets 842 is depicted in FIG. 8P. Commands from the GUI 847 are transmitted from the GUI 847 to the MCS bridge routine 846 and from the MCS bridge routine 846 to the assets 842 either directly or via the MCS 844. The commands may include, without limitation, definitions of waypoints and/or destinations, propulsion commands, speeds, headings, propulsion mode settings (e.g., cruise, eco, etc.), communication mode settings (e.g., turning various communication platforms on or off), commands to follow and/or intercept tracks, and commands to hold or stop.

With reference also to FIGS. 8J and 8K, FIG. 8Q depicts data flow between the GUI 847 and the various modules/routines that facilitate automatic determination of waypoints allowing the traversal of the asset 842 to a selected destination. In one embodiment, the GUI 847 receives an input form the user selecting/setting a destination for a selected asset 842. The GUI 847 transmits the destination to the selected asset 842, which inputs the command into a mission safety director routine 852. The mission safety director routine 852 is responsible for ensuring that the asset 842 is operating in a safe manner with respect to the environment around it. As part of this responsibility, the mission safety directory routine 852 verifies that the asset can safely traverse a path from a current location to an intended destination. The mission safety director routine 852 may accomplish this with reference to one or more files 854a in a library 854. The files 854a may include, for example, data indicating where there is and is not water (e.g., when the assets 842 are marine vehicles), data indicating the depth of water, data indicating underwater obstacles, and/or other data. Using this data, the mission safety director routine 852 may determine a path, implementing a plurality of waypoints, to safely traverse the distance between the asset's current location and the selected destination, as depicted in FIG. 8K. The selected asset 842, receiving the routing data from the mission safety director routine 852, transmits the routing data back to GUI 847 (e.g., for display in the waypoint mission panel 831 and the situational awareness panel 826), which, in embodiments, may implement a confirmation process to allow a user (or the system, automatically) to accept the routing data and instruct the asset 842 to implement the route. While, in embodiments, the mission safety director routine 852 and the library 854 are disposed in the AMSC control system 215 and may be part of the AMSV control module 230, it should be understood that the mission safety director routine 852 and the attendant library 854 could, in alternate embodiments, be located in the server, in the MCS bridge 846, be part of the GUI 847, etc.

Of course, it should be understood that references in the description of FIGS. 8A-8Q to an asset or an AMSV should be understood encompassing multiple assets or AMSVs in any instance where such an interpretation would consistent with the use of the described graphical user interface. Additionally, while described in the context of a system for AMSVs, the graphical user interface described herein with respect to FIGS. 8A-8Q is usable with a variety of autonomous vehicle types and, as such, the use of the word “assets” should be interpreted as inclusive of types of autonomous vehicles other than AMSVs, including aerial drones, submersible drones, land-based vehicles (whether on-road or off-road vehicles), and the like.

### Method Descriptions

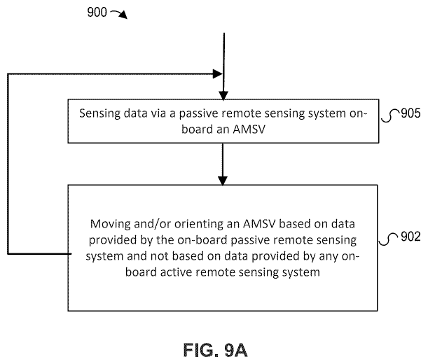

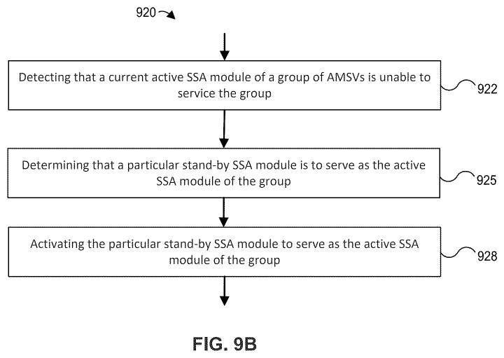

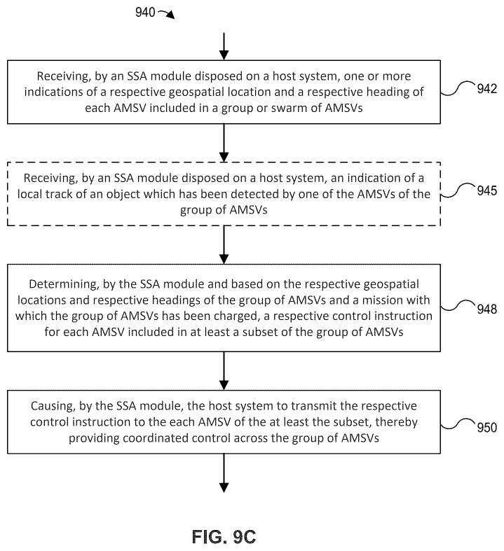

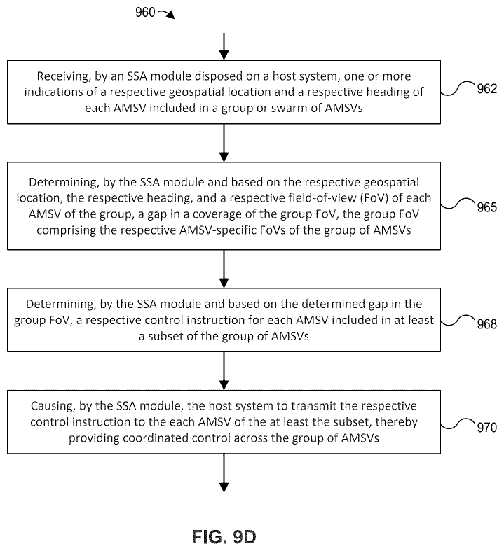

FIG. 9A is a flow diagram of an example method 900 performed by an autonomous maritime surface vehicle (AMSV). For example, the method 900 may be performed at one or more of the AMSVs 20, 26, 30, 60, 200, 302, 402, 616, 622, 672, 802, 804, or 812. In an embodiment, the AMSV control module 230 performs at least a portion of the method 900. For ease of discussion, and not for limitation purposes, the method 900 is described with simultaneous reference to FIGS. 1A-1C, 2A-2L, 3A-3B, and/or 4 (and to various elements thereof), although it is understood that any one or more portions of the method 900 may be performed in conjunction with other embodiments of AMSVs and/or other AMSVs. Further, in embodiments, the method 900 may operate in conjunction with one or more of the other methods described herein, and/or the method 900 may include additional and/or alternate blocks other than those described herein.

At a block 902, the method 900 may include at least one of moving, orienting, or re-orienting an AMSV based on data provided by a passive remote sensing system on-board the AMSV, and not based on any data provided by any active remote sensing system on-board the AMSV. That is, at the block 902, the method 900 may include the AMSV autonomously navigating itself based on (only) the data provided by its on-board passive remote sensing system, and not based on any data provided by any on-board active remote sensing system. For example, the AMSV control module 230 may instruct the locomotion system 218 on-board the AMSV 200 to move and/or orient 902 the AMSV 200 based on data provided by the on-board passive remote sensing system 212 of the AMSV 200. If the AMSV does include an on-board active remote sensing system, such as the active remote sensing system 248, the moving and/or (re-)orienting 902 of the AMSV may not be based on any data generated by the active remote sensing system. For example, any active remote sensing system may be disabled (at least partially), turned off, or ignored for the purposes of directionally moving and/or orienting 902 the AMSV.

Indeed, at a block 905, the method 900 may include sensing the data provided by the passive remote sensing system and based on which the moving and/or orienting 902 is performed. For example, the passive remote sensing system 212 may include a stereovision camera 240 which (passively) senses objects and/or external features within its field-of-view (FoV) and generates data indicative of the sensed objects and/or features, such as by using one or more of the techniques described elsewhere herein. The stereovision camera 240 may include a group of image sensors 242, which may include, for example, at least two infrared (IR) image sensors and/or at least two electro-optical (EO) image sensors. In some implementations, an orientation of a field of view (FoV) central axis of a first image sensor 242a of the stereovision camera 240 is different than an orientation of a FoV central axis of a second image sensor 242b of the stereovision camera. For example, the FoV central axis of the first image sensor 242a may not be parallel to the FoV central axis of the second image sensor 242b. The stereovision camera 240 itself (e.g., as a whole) may or may not be fixedly oriented with respect to the AMSV 200. The data generated by the stereovision camera 240 and/or indications thereof may be provided to and/or sensed by the AMSV control system 230, for example. Upon sensing 905 the data via the passive remote sensing system on-board the AMSV, the method 900 may return to the block 902 so that the AMSV is moved and/or (re-)oriented based on the sensed data. As such, via multiple executions of the loop 902-905, the AMSV may autonomously move, self-orient, and self-navigate through the body of water.

The moving and/or orienting 902 of the AMSV based on the data provided by the passive remote sensing system of the AMSV may be in accordance with a mission (e.g., a military mission or some other type of mission) with which the AMSV has been charged with performing. For example, the moving and/or orienting 902 of the AMSV may be to thereby survey the surroundings or the environment in which the AMSV is located (e.g., on a body of water) and to detect (e.g., via the on-board passive remote sensing system) the respective presences of one or more other objects (e.g., other AMSVs, other maritime vehicles, objects and/or locations for surveillance, objects for retrieval, objects for interception, etc.) and to track the movements of the detected objects. Additionally or alternatively, the moving and/or the orienting 902 of the AMSV may be to thereby intercept a target or target object. Still additionally or alternatively, the moving and/or the orienting 902 of the AMSV may be to thereby evade detection by another maritime vehicle.

In some situations, the at least one of the moving, orienting, and/or re-orienting 902 of the AMSV may be additionally based on the geospatial coordinates or some other type of indicators of the geospatial location of the AMSV. The geo-spatial coordinates may be obtained in real-time (e.g., obtained in-line with the execution of the method 900) via a suitable on-board transceiver such as the communication interface 220a, and/or the geo-spatial coordinates may be obtained from a memory on-board the AMSV, such as from on-board data storage 250.

In some situations, during the execution of the method 900, one or more (or all) communications transceivers on-board the AMSV (e.g., one or more of the external communication interfaces 220) which actively generate radiation energy during operations may be inactive, disabled, turned off, and/or otherwise not transmitting any signals, e.g., to thereby decrease the AMSV from being detected. In these situations, the moving and/or the orienting 902 of the AMSV based on the data provided by the on-board passive remote sensing system may be performed at the AMSV while such communication interfaces are inactive, disabled, turned off, and/or otherwise not transmitting any signals. As such, the AMSV may be autonomously moved, oriented, and re-oriented without emitting any radiation which may be detectable (e.g., while the AMSV is operating in a radio-silent mode).

In some embodiments, the block 902 may include propelling the AMSV towards a target, e.g., based on the data provided by the passive remote sensing system on-board the AMSV and not based on any data provided by any active remote sensing system on-board the AMSV. For example, the locomotion system 218 may propel the AMSV 200 towards a target based on an instruction generated by the AMSV control module 230. The propelling of the AMSV towards the target may utilize an orientation in which the target is offset from the field of view (FoV) central axis of the stereovision camera 240, in some situations. In some situations, the propelling of the AMSV towards the target may dynamically change the orientation of the AMSV over time while the AMSV is being propelled 908 towards the target. For example, an orientation of the AMSV may cross back and forth across a direct line-of-sight between the AMSV and the target while the AMSV is being propelled towards the target, e.g., to more accurately track the target and/or to avoid detection, such as in manners described elsewhere herein.

In some embodiments, the AMSV is included in a group of AMSVs that is charged with performing a mission corresponding to an object which has been detected by at least one AMSV of the group of AMSVs. For example, the group of AMSVs may be a swarm of AMSVs, such as the swarm 300. In such embodiments, the moving and/or the orienting 902 of the AMSV may be responsive to a control signal generated (e.g., by the AMSV control module 230 or by an active SSA module servicing the group of AMSVs) based on a fused track of the detected object. The fused track may have been generated (e.g., by the active SSA module servicing the group of AMSVs) based on data generated by respective passive remote sensing systems of two or more AMSVs included in the group, such as in manners described elsewhere herein. An active SSA module which generates the control signal and/or the fused track of a detected object may be located on the AMSV, on another AMSV of the group, or in an MCS, such as in embodiments discussed elsewhere herein. Further, a current fused track of the detected object based on which the AMSV is moved and/or oriented 902 may or may not be based on a local track of the detected object which has been generated by the AMSV itself. For example, the AMSV may be included in a group of AMSVs which is tracking an object of interest which has been detected by at least some AMSVs of the group, but the AMSV itself may not currently be able to individually detect the target object, e.g., due to obstruction, orientation, range, etc.

As previously discussed, when the AMSV is included in a group of AMSVs, the group of AMSVs may be communicatively connected, e.g., via a wireless mesh network, of which one or more (or all) AMSVs of the group may be respective nodes. As such, in embodiments, the method 900 may further include communicatively connecting the AMSV to at least one other AMSV of the group of AMSVs via at least one wireless link. In some situations, the method 900 may include communicating, by the AMSV, with the at least one other AMSV via direct line-of-sight transmissions delivered over the at least one of wireless link.

Additionally, as previously discussed in detail elsewhere herein, the wireless communicative connections among the group of AMSVs may be utilized to transmit, among the group of AMSVs, geospatial locations of AMSVs of the group and/or tracks (e.g., local and/or fused tracks) of AMSVs and/or of target or tracked objects. As such, in embodiments, the method 900 may include providing, by the AMSV and via one or more wireless communicative connections, an indication of a geospatial location of the AMSV and optionally an indication of at least some of the data generated by the passive remote sensing system of the AMSV to one or more other AMSVs of the group of AMSVs and/or to an active SSA nodule servicing the group of AMSVs. In some embodiments, the method 900 may include generating, by the AMSV, a local track of a detected object based on the at least some of the data generated by the passive remote sensing system of the AMSV, and providing, e.g., via one or more wireless communicative connections, the local track of the detected object to \at least one other AMSV of the group of AMSVs, and/or to an active SSA module servicing the group of AMSVs. Generally speaking, the block 902 may include moving, orienting, and/or re-orienting the AMSV based on information or data received by the AMSV via the one or more wireless connections.

FIG. 9B is a flow diagram of an example method 920 performed by a group or swarm of autonomous maritime surface vehicles (AMSVs). For example, the method 920 may be performed by the group of AMSVs 20a-20e of FIG. 1A, the group of AMSVs 26a-26g of FIG. 1B, the group of AMSVs 30 of FIG. 1C, the group or swarm of AMSVs 302a-302e of FIG. 3A, the group or swarm of AMSVs 332 of FIG. 3B, the group or swarm of AMSVs 418 of FIG. 4, or other groups or swarms of AMSVs. In an embodiment, the respective AMSV control modules 230 of one or more AMSVs included in the group of AMSVs perform at least a portion of the method 920. For ease of discussion, and not for limitation purposes, the method 920 is described with simultaneous reference to FIGS. 1A-1C, 2A-2L, 3A-3B, and/or 4 (and to various elements thereof), although it is understood that any one or more portions of the method 920 may be performed in conjunction with other embodiments of AMSVs, other AMSVs, and/or groups or swarms of AMSVs. Further, in embodiments, the method 920 may operate in conjunction with one or more of the other methods described herein, and/or the method 920 may include additional and/or alternate blocks other than those described herein.

The method 920 may be performed by a group or swarm of autonomous maritime surface vehicles (AMSVs) which are communicatively connected, e.g., via an ad-hoc wireless mesh network, where at least some (or all) of the AMSVs of the group are respective nodes of the wireless network, such as in manners described elsewhere herein. Each AMSV of the group or swarm executing the method 920 may store and execute a respective instance of an AMSV control module, such as an instance of the AMSV control module 230. Additionally, each AMSV of the group or swarm may store and execute a respective instance of a local situational awareness (LSA) module (such as an instance of the LSA module 232 of FIG. 2L or an instance of one of the LSA modules 308a-308e of FIG. 3A), and each AMSV of the group or swarm may store and execute a respective instance of a swarm situational awareness (SSA) module (such as an instance of the SSA module 235 of FIG. 2L, an instance of one of the SSA modules 310a-310e of FIG. 3A, or an instance of one of the SSA modules 355a-355B of FIG. 3B).

Each ASMV of the group of AMSVs may operate to at least one of move or orient the each AMSV based on a current geospatial location of the each AMSV and a fused track of an object detected by one or more AMSVs of the group, where the fused track of the detected object is (e.g., has been) generated by an active SSA module servicing the group of AMSVs, such as by using techniques such as those described with respect to FIGS. 3A, 3B, 9A, 9C, and elsewhere herein. The active SSA module servicing the group of AMSVs may execute on a first AMSV included in the group of AMSVs, on another maritime vehicle in communicative connection with the group of AMSVs but excluded from the group of AMSVs, on another system or device disposed on a shore of a body of water in which the group of AMSVs are operating, where the another system or device is in communicative connection with the group of AMSVs, or on a remote system, where the group of AMSVs is communicatively connected with the remote system via at least one of a satellite communications link or a cellular communications link. The remote system may include a cloud computing system, in some embodiments.

At a block 922, the method 920 may include detecting that the current active SSA module is unable to service the group. For example, one or more AMSVs of the group may (independently and/or cooperatively) detect that the current active SSA module is unable to service the group, e.g., by detecting a loss of or a decrease in fidelity of direct wireless communications with the current active SSA module, by detecting that the current active SSA module is not able to be communicatively connected to via the ad-hoc wireless mesh network, by a host AMSV of the current active SSA module voluntarily inactivating the current active SSA module (e.g., due to on-board processing load, hardware malfunction, and/or other criteria) and notifying at least one other AMSV in the group, or by other means of detection. In embodiments, an indication of the detection of the inability of the current active SSA module to continue servicing the group may be communicated, e.g., via the wireless mesh network, to at least a portion of the group of AMSVs.

At a block 925, the method 920 may include determining, at the group of AMSVs and based on the detecting 922, that a particular instance of a stand-by SSA module is to activate to serve as the new active SSA module of the group. The determining 925 may be based on (e.g., triggered by) one or more communicated indications (which have been communicated via the wireless mesh network and among various AMSVs of the group) of the detection that the active SSA module is unable to service the group, for example. As previously discussed, each AMSV may include an instance of the SSA module, and in some scenarios, one of the SSA modules may be serving as the active SSA module of the group of AMSVs while the other remaining SSA modules may be operating as stand-by SSA modules. In scenarios in which the active SSA module of the group is hosted by a non-AMSV platform (such as another maritime vehicle, an MCS, a remote system, etc.), all of the SSA modules of the group of AMSVs may be stand-by SSA modules. The stand-by SSA modules may be continually updated or synchronized with the active SSA module so that each of the stand-by SSA modules is, in a sense, a hot spare of the active SSA module. For example, dynamically changing information that is received and stored at and/or generated by the active SSA module may be synchronized with the stand-by SSA modules, and vice versa. Examples of dynamically changing information may include, for example, indications of data generated by respective passive remote sensing systems of AMSVs within the group; local tracks of AMSVs, local tracks of detected objects, fused tracks of detected objects, respective current statuses of AMSVs of the group, respective current geospatial locations, headings, and speeds of AMSVs of the group, and/or mission information, to name a few. Synchronizing information stored at the active SSA module with a stand-by SSA module may be performed via direct wireless communications between the active SSA module and the stand-by SSA module, or via an indirect wireless path through the ad-hoc wireless mesh network between the active SSA module and the stand-by SSA module. In some scenarios, at least a portion of dynamically changing information that is received and stored at the active SSA module may be multicast or broadcast, via the wireless mesh network, to two or more of the stand-by SSA modules, e.g., for synchronization purposes.

The determining 925 of the particular instance of a stand-by SSA module may be based on a pre-determined priority or algorithm, a voting mechanism among at least some of the AMSVs of the group, one or more other dynamic characteristics associated with the group of AMSVs (such as available processing power at host AMSVs, interconnectedness, e.g., within the wireless mesh network, of various host AMSVs with other AMVSs, quality of wireless links to/from various host AMSVs, statuses of hardware on-board various AMSVs, and/or other dynamic characteristics), and/or other determination criteria. In some embodiments, a single AMSV of the group of AMSVs may make the determination 925. In some embodiments, a subset of two or more AMSVs of the group of AMSVs may collectively make the determination 925, and in some embodiments, all AMSVs of the group of AMSVs may collectively make the determination 925.

At a block 928, the method 920 may include activating the determined, particular instance of the SSA module to serve as a new active SSA module of the group. Upon activation, the newly activated SSA module may operate to, for example: maintain updated geospatial locations, headings, and speeds of the AMSVs within the group; receive and store indications of data generated by respective passive remote sensing systems of AMSVs within the group; receive and store local tracks of AMSVs and of detected objects; generate new fused tracks of newly detected object, update existing fused tracks of detected objects, and optionally provide the updated fused tracks to AMSVs of the group; upload or otherwise transmit data generated by the group of AMSVs to one or more remote systems, e.g., for historization, analytics, interactions with other missions, and/or other types of post-processing; receive additional, updated, and/or alternate instructions related to the mission (e.g., from mission control, which may be remotely located with respect to the group of AMSVs); generate various command and/or control messages for respective AMSVs within the group, e.g., based on the information that has been received and stored at the active SSA module; and the like. In an embodiment, the block 928 may include activating the determined, particular instance of the SSA module to perform, as the newly-activated active SSA module of the group, at least a portion of the method 940, at least portions of other methods described herein, and/or other actions, such as described elsewhere herein.

FIG. 9C is a flow diagram of an example method 940 for providing coordinated control of a group or swarm of Autonomous Marine Surface Vehicles (AMSVs). The method 940 may be performed at least partially by a Swarm Situational Awareness (SSA) module corresponding to a group of autonomous maritime surface vehicles (AMSVs). For example, the method 940 may be performed by the SSA module 235 of FIG. 2L, one or more of the SSA modules 310a-310e of FIG. 3A, and/or one or more of the SSA modules 355a-355B of FIG. 3B. For ease of discussion, and not for limitation purposes, the method 940 is described with simultaneous reference to FIGS. 1A-1C, 2A-2L, 3A-3B, and/or 4 (and to various elements thereof), although it is understood that any one or more portions of the method 940 may be performed in conjunction with other embodiments of AMSVs, other AMSVs, and/or groups or swarms of AMSVs. Further, in embodiments, the method 940 may operate in conjunction with one or more of the other methods described herein, such as the method 960, and/or the method 940 may include additional and/or alternate blocks other than those described herein.

At a block 942, the method 940 may include receiving, by a Swarm Situational Awareness module (SSA) disposed on a host system and from one or more AMSVs of a group or swarm of AMSVs, one or more indications of a respective geospatial location and a respective heading of each AMSV included in the group of AMSVs. The host system may be an AMSV included in the group of AMSVs, or the host system a mobile control system (MCS) servicing the group of AMSVs and wirelessly connected to the group of AMSVs. The group of AMSVs may be communicatively connected via an ad-hoc wireless mesh network, e.g., such as in manners described elsewhere herein, and the SSA module may include computer-executable instructions stored on one or more memories of the host system and executable by one or more processors of the host system, e.g., such as in manners described elsewhere herein. The SSA module may be an active SSA module servicing the group of AMSVs, for example. Additionally, an indication of respective geospatial locations and respective headings of one or more specific AMSVs may be received by the SSA module via a respective, direct wireless connection between the host system and the one or more specific AMSVs to which the geospatial locations and headings pertain, or indirectly via one or more intermediate AMSVs that are disposed, within the wireless mesh network, between the host system and the one or more specific AMSVs.

In embodiments, at the block 942 the SSA module may receive an indication of a respective local track of at least one AMSV, where the respective local track is indicative of the respective geospatial location and/the respective heading of the at least one AMSV. Additionally or alternatively, at the block 942 the SSA module may receive an indication of respective data or information generated by respective passive remote sensing systems of one or more AMSVs, and the SSA module may generate a respective local track of each of the one or more AMSVs based on the received indication of the respective data or information, where the respective local track is indicative of the respective geospatial location and/the respective heading of the each of the one or more AMSVs.

At a block 948, the method 940 may include determining, by the SSA module and based on the respective geospatial locations and respective headings of the group of AMSVs and based on a mission with which the group of AMSVs has been charged with performing, a respective control instruction for each AMSV included in at least a subset of the group of AMSVs. The respective control instruction may indicate a respective change to at least one of the respective geospatial location or the respective heading of the each AMSV of the at least the subset of the group of AMSVs, for example.

In some embodiments, at the block 942 the method 940 may include receiving an indication of a respective speed of one or more AMSVs of the group of AMSVs. In these embodiments, the determining 948 of the respective control instruction for the each AMSV of the at least the subset may be further based on the respective speeds of the group of AMSVs, and the respective control instruction may indicate a respective change to at least one of the respective geospatial location, the respective heading, or the respective speed of the each AMSV of the at least the subset of the group of AMSVs.

At a block 950, the method 940 may include causing the host system to transmit the respective control instruction to the each AMSV of the at least the subset, thereby providing coordinated control across the group of AMSVs. The respective control instructions may be transmitted via the wireless mesh network interconnecting the group of AMSVs.

In some embodiments, the method 940 may include additionally receiving 945, by the SSA module disposed on the host system and via the wireless mesh network, an indication of a local track of an object which has been detected via a passive remote sensing system of one of the AMSVs of the group (which may be referred to herein as a “detected object” or a “target object”). The SSA module may receive the indication of the local track via a direct wireless connection between the host system and the detecting AMSV or via one or more intermediate AMSVs disposed, within the wireless network, between the host system and the detecting AMSV. The received indication of the local track may include data or information generated by the passive remote sensing system of the detecting AMSV or an indication thereof, and the SSA module may determine or generate the local track of the object based on the received data or information. In some embodiments, the indication of the local track of the detected object is generated by the detecting AMSV and received by the SSA module. At any rate, in embodiments of the method 940 which include the block 945, the determining 948 of the control instructions for the at least the subset of the group of AMSVs may be further based on the local track of the detected object.

In some embodiments, the block 945 may further include receiving, via the wireless mesh network and from the detecting AMSV, an indication of an update to the local track of the detected object corresponding to the detecting AMSV. In these embodiments, at the block 945, the method 940 may include determining, based on the update to the first local track of the target object, a respective updated control instruction for at least one AMSV included in the group of AMSVs, and causing the respective updated control instruction to be transmitted to the at least one AMSV included in the group of AMSVs.

In some embodiments of the block 945, indications of multiple local tracks of the detected object (e.g., which have been generated by different detecting AMSVs) may be received by the SSA module (e.g., via the wireless mesh network), and/or indications of one or more respective local tracks of each object of a plurality of objects which have been detected by the group of AMSVs may be received by the SSA module (e.g., via the wireless mesh network). For example, different AMSVs of the group may detect a respective subset of the plurality of objects (e.g., based on the respective geospatial location, the respective heading, and the respective on-board passive remote sensing system of each different AMSV). In these embodiments, the determining 948 of the control instructions for the at least the subset of the group of AMSVs may be further based on the received indications of the multiple local tracks of the detected object and/or based on the received indications of the one or more respective local tracks of each object of the plurality of objects which have been detected by the group of AMSVs.

In some embodiments of the block 945, the indications of the multiple local tracks of the detected object may be fused by the SSA module into a swarm-level track of the detected object. In these embodiments, the determining 948 of the control instructions for the at least the subset of the group of AMSVs may be based on the swarm-level track of the detected object. Additionally, in some instances of these embodiments, the method 940 may include providing an indication of the swarm-level track of the detected object to one or more (or all) of the AMSVs included in the group of AMSVs. Further, in some instances of these embodiments in which the SSA module generates the swarm-level track, the method 940 may additionally include receiving, via the wireless mesh network, an indication of an update to one or more of the local tracks of the detected object. In these instances, the SSA module may generate, based on the update(s) to the local track(s) of the detected object, an update to the swarm-level track of the detected object, and the SSA module may determine, based on the updated swarm-level track of the detected object, a respective updated control instruction for at least one AMSV included in the swarm of AMSVs. The SSA module may cause the respective updated control instruction to be transmitted to the at least one AMSV included in the swarm of AMSVs, for example. Still additionally or alternatively, in these instances, the SSA module may cause an indication of the updated swarm-level track to be transmitted to each AMSV included in the swarm of AMSVs.

FIG. 9D is a flow diagram of an example method 960 for optimizing field-of-view (FoV) coverage of a group or swarm of Autonomous Marine Surface Vehicles (AMSVs). The method 960 may be performed at least partially by a Swarm Situational Awareness (SSA) module corresponding to a group of autonomous maritime surface vehicles (AMSVs). For example, the method 960 may be performed by the SSA module 235 of FIG. 2L, one or more of the SSA modules 310a-310e of FIG. 3A, and/or one or more of the SSA modules 355a-355B of FIG. 3B. For ease of discussion, and not for limitation purposes, the method 960 is described with simultaneous reference to FIGS. 1A-1C, 2A-2L, 3A-3B, and/or 4 (and to various elements thereof), although it is understood that any one or more portions of the method 960 may be performed in conjunction with other embodiments of AMSVs, other AMSVs, and/or groups or swarms of AMSVs. Further, in embodiments, the method 960 may operate in conjunction with one or more of the other methods described herein, such as the method 940, and/or the method 960 may include additional and/or alternate blocks other than those described herein.

At a block 962, the method 900 may include receiving, by a Swarm Situational Awareness module (SSA) disposed on a host system and from one or more AMSVs of the group of AMSVs, one or more indications of a respective geospatial location and a respective heading of each AMSV included in the group of AMSVs. The host system may be an AMSV included in the group of AMSVs, or the host system may be a mobile control system (MCS) servicing the group of AMSVs and wirelessly connected to the group of AMSVs. The group of AMSVs may be communicatively connected via an ad-hoc wireless mesh network, e.g., such as in manners described elsewhere herein, and the SSA module may include computer-executable instructions stored on one or more memories of the host system and executable by one or more processors of the host system, e.g., such as in manners described elsewhere herein. The SSA module may be an active SSA module servicing the group of AMSVs, for example. Additionally, an indication of respective geospatial locations and respective headings of one or more specific AMSVs may be received by the SSA module via a respective, direct wireless connection between the host system and the one or more specific AMSVs to which the geospatial locations and headings pertain, or may be received by the SSA module indirectly via one or more intermediate AMSVs that are disposed, within the wireless mesh network, between the host system and the one or more specific AMSVs.

In embodiments, at the block 962 the SSA module may receive an indication of a respective local track of at least one AMSV, where the respective local track is indicative of the respective geospatial location and/the respective heading of the at least one AMSV. Additionally or alternatively, at the block 942 the SSA module may receive an indication of respective data or information generated by respective passive remote sensing systems of one or more AMSVs, and the SSA module may generate a respective local track of each of the one or more AMSVs based on the received indication of the respective data or information, where the respective local track is indicative of the respective geospatial location and/the respective heading of the each of the one or more AMSVs.

At a block 965, the method 960 may include determining, by the SSA module and based on the respective geospatial location, the respective heading, and a respective FoV of the each AMSV of the group of AMSVs, a gap in a coverage of a group FoV, the respective FoV of the each AMSV being a respective AMSV FoV of the each AMSV. The respective FoV of each AMSV may be received, for example, in conjunction with the information received at the block 962, and/or the respective FoV of the each AMSV may be stored in local data storage, such as in on-board data storage 250 or other co-located data storage.

The group FOV may comprise the respective AMSV FoVs of the group of AMSVs. For example, the group FoV may include a (possibly overlapping) union of the AMSV FoVs of the group of AMSVs. The gap may be indicative of a desired segment or area of the group FoV that corresponds to the mission of the group of AMSVs and that is not covered by any of the AMSV FoVs of which the group FoV comprises. For example, if the mission of the group of AMSVs is to provides surveillance of a segment of coastline, the gap may correspond to a sub-segment of the coastline which is not within the AMSV FoV of any AMSV of the group. In another example, if the mission of the group includes tracking the movements of a detected object and the passive remote sensing system of a particular AMSV having the tracked object within its FoV becomes occluded or fails, the gap may correspond to the FoV extent provided by the particular AMSV. In yet another example, if the mission of the group includes having a 360 degree FoV of the group as a whole, the gap may correspond to a sector of the 360 degree FoV which is not within the AMSV FoV of any AMSV of the group.

At a block 968, the method 960 may include determining, by the SSA module and based on the determined gap, a respective control instruction for each AMSV included in at least a subset of the group of AMSVs. The respective control instruction may indicate a respective change to at least one of the respective geospatial location or the respective heading of the each AMSV of the at least the subset of the group of AMSVs, for example.

At a block 970, the method 960 may include causing, by the SSA module, the host system to transmit the respective control instruction to the each AMSV of the at least the subset, thereby optimizing the coverage of the group FoV. For example, the host system may transmit the respective control instructions via the wireless mesh network.

In some scenarios in which the mission of the group of AMSVs corresponds to tracking an object which has been detected by at least one AMSV of the group (which may be referred to herein as a “detected object” or a “target object”), the method 960 may further include receiving, by the SSA module and via the wireless mesh network, an indication of a first local track of the target object (not shown in FIG. 9D). The first local track may correspond to a detection of the target object via a passive remote sensing system included in a first detecting AMSV included in the group of AMSVs, and in these scenarios, the determining 965 of the gap in the coverage of the group FoV may be further based on the first local track of the target object. The first local track of the detected target object may have been generated by the first detecting AMSV, and the indication thereof may be received at the SSA module. Additionally or alternatively, the SSA module may receive an indication of respective data or information generated by the passive remote sensing system of the first detecting AMSV, and the SSA module may generate the first local track of the detected target object based on the received indication of the respective data or information.

In some embodiments (not shown), the method 960 may further comprise, after the transmission 970 of the respective control instruction to the each AMSV of the at least the subset of group of AMSVs, receiving, by the SSA module and via the wireless mesh network, an indication of an update to the first local track of the target object corresponding to the first detecting AMSV, and determining, based on the update to the first local track of the target object, whether the gap or a different gap in the coverage of the group FoV exists. When the gap or the different gap in the coverage of the group FOV exists, the method 960 may further include determining, based on the existence of the gap or the different gap, an additional control instruction indicating a change to at least one of the respective geospatial location or the respective heading of a particular AMSV included in the group of AMSVs, and causing the additional control instruction to be transmitted to the particular AMSV.

In some situations, the group of AMSVs may detect the presence of a second object within the group FoV. The second object may be newly detected by one or more AMSVs included in the group, or may be an existing or previously tracked object. In these situations, the method 960 may include maintaining the presence of the second detected object within the group FoV. As such, the method 960 may include receiving, via the wireless mesh network, an indication of a local track of the second object, where a presence of the second object has been detected by the first detecting AMSV or by at least one other detecting AMSV. Similar to manners described elsewhere herein, the local track may have been generated by an AMSV that has detected the presence of the second object within its AMSV FoV, and the SSA module may receive an indication thereof. Additionally or alternatively, the SSA module may receive an indication of data or information generated by respective passive remote sensing systems of one or more ASMVs that have detected the presence of the second object, and the SSA module may generate the local track of the second object based on the received indication of data or information generated by respective passive remote sensing systems of one or more ASMVs.

Additionally in these situations, the method 960 may further include determining, based on the local track of the second object, whether the first gap (e.g., corresponding to the first detected object) or a second gap (e.g., corresponding to the second detected object), or a third gap (e.g., corresponding to a target area of surveillance) in the coverage of the group FoV exists. When the first, second, and/or third gap in the coverage of the group FoV is determined to exist, the method 960 may include determining, based on the existence of the first, second, and/or third gap, another control instruction indicating a change to at least one of the respective geospatial location or the respective heading of a specific AMSV included in the group of AMSVs, and causing the another control instruction to be transmitted to the specific AMSV. In this manner, the group of AMSVs may maintain group FoV coverage of multiple detected objects as well as a target area of surveillance, if desired.

### ADDITIONAL CONSIDERATIONS

Further, although certain autonomous maritime surface vehicles and related systems, methods, and components have been described herein in accordance with the teachings of the present disclosure, the scope of coverage of this patent is not limited thereto. On the contrary, while the invention has been shown and described in connection with various preferred embodiments, it is apparent that certain changes and modifications, in addition to those mentioned above, may be made. This patent covers all embodiments of the teachings of the disclosure that fairly fall within the scope of permissible equivalents. Accordingly, it is the intention to protect all variations and modifications that may occur to one of ordinary skill in the art.

Still further, when implemented, any of the methods and techniques described herein or portions thereof may be performed by executing software one or more non-transitory, tangible, computer readable storage media or memories such as magnetic disks, laser disks, optical discs, semiconductor memories, biological memories, other memory devices, or other storage media, in a RAM or ROM of a computer or processor, etc.

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. By way of example, and not limitation, the disclosure herein contemplates at least the following aspects:

Thus, many modifications and variations may be made in the techniques, methods, and structures described and illustrated herein without departing from the spirit and scope of the present claims. Accordingly, it should be understood that the methods and apparatus described herein are illustrative only and are not limiting upon the scope of the claims.

What is claimed is:

1. A system comprising:
a cloud-based server;
an autonomous vehicle in communication with the cloud-based server, the autonomous vehicle comprising:
a locomotion system;
a passive perception system comprising a stereo camera system and a software routine operative at least to detect and classify objects in an environment of the autonomous vehicle and, for each object, continuously determine real-time tracking data comprising a position, a speed, and a heading;
a plurality of radio frequency interfaces configured to:
transmit to the cloud-based server, via one or more of the plurality of radio frequency interfaces, real-time telemetry data of the autonomous vehicle and the real-time tracking data;
receive from the cloud-based server, via one or more of the plurality of radio frequency interfaces, a destination to which the autonomous vehicle is to navigate and/or a series of waypoints through which the autonomous vehicle is to navigate;
a control module configured to control the locomotion system to navigate to the destination and/or through the waypoints;
a computer, remote from the cloud-based server and from the autonomous vehicle, the computer receiving from the server the real-time telemetry data and the real-time tracking data, the computer further executing a graphical user interface (GUI) configured to:
receive the real-time telemetry data and the real-time tracking data;
cause a display device of the computer to display, in a first portion of the display, an interactive, three-dimensional depiction of the environment in which the autonomous vehicle is disposed;
cause the display device to display, in the first portion of the display, an interactive, representative graphical depiction of the autonomous vehicle in the real-world space;
cause the display device to display, in the first portion of the display, an interactive, representative graphical depiction of each of the objects detected in the real-world space;
continuously update the first portion of the display according to the real-time telemetry data and the real-time tracking data;
receive a first user input via the first portion of the display, the first user input comprising selecting the autonomous vehicle;
receive a second user input via the first portion of the display, the second user input comprising selecting a waypoint or destination for the selected autonomous vehicle; and
cause the computer to transmit, to the selected autonomous vehicle, via the cloud-based server, a command to cause the selected autonomous vehicle to navigate autonomously to the selected waypoint or destination.

2. A system according to claim 1, comprising a plurality of the autonomous vehicle.

3. A system according to claim 2, wherein the cloud-based server comprises a track fuser routine operable to receive real time tracking data from the plurality of autonomous vehicles and to create, for each object detected by more than one of the autonomous vehicles, a fused track.

4. A system according to claim 1, wherein the real-time telemetry data comprise a live camera feed from one or more cameras on the autonomous vehicle.

5. A system according to claim 1, wherein the real-time telemetry data comprise data from an inertial measurement unit providing data of the attitude of the autonomous vehicle.

6. A system according to claim 1, wherein the real-time telemetry data comprise sea-state data, and wherein causing the display device to display the interactive, representative graphical depiction of the autonomous vehicle comprises causing the graphical depiction of the autonomous vehicle to accurately portray the sea state data received from the autonomous vehicle.

7. A system according to claim 1, wherein the GUI is further configured to cause the first portion of the display to depict, for the autonomous vehicle, a field of view of a camera on the remote autonomous vehicle.

8. A system according to claim 7, wherein the GUI is further configured to cause the first portion of the display to depict, overlayed with the depiction of the field of view, an associated live camera feed from the camera on the remote autonomous vehicle.

9. A system according to claim 1, wherein the GUI is further configured to cause the display device to display, in a second portion of the display, telemetry data of the selected autonomous vehicle.

10. A system according to claim 1, wherein the GUI is further configured to, after transmitting to the selected remote autonomous vehicle the command to navigate autonomously:
receive from the selected autonomous vehicle a set of waypoints representing a path from a current location of the selected autonomous vehicle to the selected waypoint or destination; and
cause the display to display in the first portion of the display the set of waypoints.

11. A system according to claim 1, wherein the GUI is further configured to:
receive a third user input, via the first portion of the display, the third user input comprising selecting a one of the detected objects;
receive a fourth user input, via the first portion of the display, the fourth user input comprising selecting an action for the autonomous vehicle to perform with respect to the selected detected object.

12. A system according to claim 1, wherein the system comprises a plurality of autonomous vehicles and wherein receiving a first user input via the first portion of the display comprises receiving a drag-selection selecting a plurality of remote autonomous vehicles.

13. A system according to claim 1, further comprising a mission safety director routine operable to:
receive the selected waypoint or destination;
retrieve navigation information from a library stored on a memory;
determine a series of waypoints for the autonomous vehicle to traverse to safely navigate from a current location to the selected waypoint or destination.

14. A tangible, non-transitory storage medium storing machine-readable instructions that, when executed by a processor, cause the processor to:
receive real-time telemetry data from one or more remote autonomous vehicles;
receive real-time data indicative of one or more objects detected by the one or more remote autonomous vehicles;
receive, for each of the one or more objects, real-time tracking data including an estimated position, speed, and direction of the object;
cause a display device coupled to the processor to display, in a first portion of the display, an interactive, three-dimensional depiction of a real-world space;
cause the display device to display, in the first portion of the display, an interactive, representative graphical depiction of each of the one or more remote autonomous vehicles in the real-world space;
cause the display device to display, in the first portion of the display, an interactive, representative graphical depiction of each of the one or more objects detected in the real-world space by the one or more remote autonomous vehicles;
continuously update the first portion of the display according to the real-time telemetry data and the real-time data indicative of the one or more objects;
receive a first user input via the first portion of the display, the first user input comprising selecting at least one of the one or more remote autonomous vehicles;
receive a second user input via the first portion of the display, the second user input comprising selecting a waypoint or destination for the at least one selected remote autonomous vehicles; and
transmit to the at least one selected remote autonomous vehicles a command to cause the at least one selected remote autonomous vehicles to navigate autonomously to the selected waypoint or destination.

15. A tangible, non-transitory storage medium according to claim 14, wherein the one or more remote autonomous vehicles comprise marine surface vehicles.

16. A tangible, non-transitory storage medium according to claim 14, wherein the real-time telemetry data comprise a live camera feed from each of one or more cameras on the one or more remote autonomous vehicles.

17. A tangible, non-transitory storage medium according to claim 14, wherein the real-time telemetry data comprise data from an inertial measurement unit providing data of the attitude of the remote autonomous vehicle.

18. A tangible, non-transitory storage medium according to claim 14, wherein the real-time telemetry data comprise sea-state data, and wherein causing the display device to display the interactive, representative graphical depiction of each of the one or more remote autonomous vehicles comprises causing the graphical depiction of each remote autonomous vehicle to accurately portray the sea state data received from the remote autonomous vehicle.

19. A tangible, non-transitory storage medium according to claim 14, wherein the machine-readable instructions are further operable to cause the first portion of the display to receive user inputs manipulating the interactive, three-dimensional depiction of a real-world space to zoom in or out, to pan, to tilt, to change elevation, and/or to change position.

20. A tangible, non-transitory storage medium according to claim 14, wherein the machine-readable instructions are further operable to cause the first portion of the display to depict, for each of the one or more remote autonomous vehicles, a field of view of a camera on the remote autonomous vehicle.

21. A tangible, non-transitory storage medium according to claim 20, wherein the machine-readable instructions are further operable to cause the first portion of the display to depict, overlayed with the depiction of the field of view, an associated live camera feed from the camera on the remote autonomous vehicle.

22. A tangible, non-transitory storage medium according to claim 14, wherein the machine-readable instructions are further operable to cause the display device to display, in a second portion of the display, real-time telemetry data of the selected remote autonomous vehicles.

23. A tangible, non-transitory storage medium according to claim 14, wherein the machine-readable instructions are further operable, after transmitting to the at least one selected remote autonomous vehicles the command to navigate autonomously, to:
receive from the at least one selected remote autonomous vehicles a set of waypoints representing a path from a current location of the at least one selected remote autonomous vehicles to the selected waypoint or destination; and
cause the display to display in the first portion of the display the set of waypoints.

24. A tangible, non-transitory storage medium according to claim 14, wherein the machine-readable instructions are further operable to:
receive a third user input, via the first portion of the display, the third user input comprising selecting a one of the one or more detected objects;
receive a fourth user input, via the first portion of the display, the fourth user input comprising selecting an action for the at least one selected remote autonomous vehicles to perform with respect to the selected one or more detected objects.
